(19) United States
(12) Patent Application Publication
(10) Pub. No.: US 2022/0072475 A1
(43) Pub. Date: Mar. 10, 2022

(54) BATCH AND SEMI-BATCH PRESSURE AND OSMOTICALLY DRIVEN SEPARATION PROCESSES

(71) Applicant: Saravana Perumal Shanmukham, Salem (IN)

(72) Inventor: Saravana Perumal Shanmukham, Salem (IN)

(21) Appl. No.: 17/422,772

(22) PCT Filed: Dec. 12, 2019
(86) PCT No.: PCT/IN2019/050912

§ 371 Date: Jul. 14, 2021

(30) Foreign Application Priority Data
Dec. 12, 2018 (IN) 201841042518

(51) Int. Cl. B01D 61/02

(52) U.S. Cl. CPC B01D 61/022; C02F 1/441; B01D 2315/14; B01D 61/025

(57) ABSTRACT

A method and device for continuous batch separation where batch reset time is eliminated is provided. Separation is achieved in passes employing more than one liquid container or chamber. First pass begins with batch feed solution from a source reservoir, the feed solution flows from the source reservoir, undergoes separation in the separation device and the retentate is returned to a receiving reservoir until the source reservoir is evacuated. On feed switch over sequence, all pass one solution present in the holdup volume of the system is replaced with pass two solution with minimal to no mixing between the two solutions. Separation continues during the switch over sequence. The batch continues with subsequent passes until desired separation or operating conditions are met. Feed solution for the next batch is filled and kept ready during separation of a batch. Similar feed switch over sequence is followed between batches.

### CROSS-REFERENCE TO RELATED APPLICATIONS

This application claims priority from a provisional patent application filed in India bearing no. 201841042518 titled “CONTINUOUS BATCH REVERSE OSMOSIS PROCESS” filed on Dec. 12, 2018.

### FIELD OF THE INVENTION

The present invention generally relates to desalination systems, and in particular to batch and semi-batch desalination apparatus and methods of operation thereof.

### DESCRIPTION OF THE RELATED ART

Batch and semi-batch separations have multiple advantages over continuous separation processes. Major advantages are improved second law efficiency for separation process and significantly lower potential of fouling on equipment surface. In contrast to continuous membrane separations, batch and semi-batch separations operate with continuously varying solution properties and corresponding system operating conditions. State of the art batch separation process suffers from various challenges. Challenges described below corresponds to batch mode of separation.

For state of the art batch separations, it is often required to replace process solution in various system segments with a new process solution external to the circuit. This operation is typically required between consecutive batch separations. A major challenge for batch separations is the batch reset time. Batch reset time is the time required to replace process solution in the system's hydraulic circuit as described above. In order to overcome this limitation for a given desalination duty (i.e. increase in solute concentration, osmotic pressure and recovery) compared to a continuous separation (e.g. continuous reverse osmosis), additional equipment capacity (e.g. membrane area) needs to be provided or the system needs to be operated at higher flux (e.g. permeate flux). Both of these result in higher capital and/or operating costs.

One option to mitigate the limitations of batch reset time is to increase the batch volume. This increases the liquid container or reservoir volume that in turn increases the proportion of active separation duration of the batch. On the downside, this also leads to difference in salinity between process solution in the liquid container and concentrate returned from the separation unit. This causes entropy generation and lowers process efficiency. Further in large volume liquid containers it is difficult to maintain homogenous or well mixed solution. This will lead to spatially varying solution properties (e.g. concentration, osmotic pressure) of process solution in the liquid container. On the other hand, in small batch volumes the mixing of retentate with feed is minimized and it is practical to maintain a well-mixed solution in the liquid container. However with small batch volumes the batch reset time constitutes a major portion of total batch time thereby increasing the proportion of non-active duration of the batch. To realise optimal operations the batch-reset time must be minimized or eliminated completely.

Another problem with state of the art batch separation is the significant mixing of solutions during operation and solution change over. The retentate mixes with feed continuously during the batch separation. This increases salinity of the feed that causes the system to operate at higher than required osmotic pressures. Such mixing also occurs during replacement of final batch retentate solution from the fluid hold up volume of system using feed solution for next batch. Significant mixing leads to increased salinity of feed solution for next batch and associated efficiency loss.

An example state of the art system described in the patent application WO 2017132301A1 to Warsinger et al. describing a liquid-separation module including a membrane that passes at least partially purified solvent as filtrate while diverting the impurity in a retentate. The substantially pure water is extracted from the permeate side of the liquid-separation module, while the feed is passed from the upstream side of the liquid-separation module through the pressure exchanger, where pressure is recovered from the downstream retentate. The retentate is then passed from the pressure exchanger to the reservoir and recirculated as a component of the feed via the above steps. This method and other existing solutions do not minimize or eliminate non-permeation period between batches or address the detrimental effects of mixing.

Systems using multiple liquid containers attempt to reduce the non-permeation duration by using two service liquid containers. One liquid container provides feed solution and also collects the retentate solution. While simultaneously another liquid container, disconnected from the system, fills up with feed solution for the subsequent batch in parallel. This system still has non-permeation duration during flushing of residual brine with feed solution for next batch. Further it does not address the mixing of retentate and feed solutions in the liquid container or between retetante of a batch and feed of next batch during switchover of liquid containers.

### SUMMARY OF THE INVENTION

The present invention discloses pressure- and osmotically-driven batch and semi-batch desalination apparatus and methods of operation thereof. The method and device eliminates batch reset time.

In one aspect, the invention relates to a method of performing batch and semi batch separations in a separation system. A system level feed solution is received from by at least one reservoir from an external source to initiate a first pass of a batch separation. The batch separation may include one or more pass level separations. A pass level feed solution is supplied by the at least one reservoir with at least one of the system level feed solution and a pass level retentate solution to a first side of a semi-permeable membrane of a separation unit. Pressure is exerted by the pressurizing unit in the pass level feed solution in fluid communication with the first side of the semipermeable membrane such that a pass level permeate solution from the pass level feed solution passes from the first side of the semipermeable membrane to a second side of the semipermeable membrane of the separation unit. The pressurizing unit includes at least one of an energy recovery device (ERD) device, a high-pressure pump, a booster pump, a piston, an hydraulic fluid and pneumatic fluid. A pass level retentate solution is discharged on passing the pass level permeate solution from the first side of the semipermeable membrane to the second side of the semipermeable membrane by the separation unit from the first side of the semi-permeable membrane. The discharged pass level retentate solution is stored in one of the at least one reservoir and supplied as the pass level feed solution to any of its subsequent pass until a system level retentate solution is generated. The pass level permeate solution is removed as a system level permeate solution from the separation system. The generated system level retentate solution from the separation system is removed by the separation unit in fluid communication with the at least one reservoir and the pressurizing unit.

In some aspects, the method further includes repeating, by the separation system, the described steps to continue with one or more subsequent batch separations and semi batch separations. In one aspect, the method further includes mixing a system level process solution with a pass level process solution thereby achieving the semi-batch separations. The system level process solution includes a system level feed solution, a system level permeate solution and a system level retentate solution. The pass level process solution includes a pass level feed solution, a pass level permeate solution and a pass level retentate solution. In one aspect, the method further includes filling in parallel one of the at least one reservoir with a system level feed solution for the one or more subsequent separation cycles to achieve at least one of the batch separation and the semi batch separation. In one aspect, a reservoir switchover sequence is used to enable the separation system to switch connections to supply at least one of the pass level retentate solution and the pass level permeate solution stored in one of the at least one reservoir as the pass level feed solution to any of its subsequent pass. The reservoir switchover sequence includes enabling different hydraulic segments of the separation system to replace the pass level feed solution, the pass level permeate solution and the pass level retentate solution corresponding to an earlier pass with a pass level feed solution, a pass level permeate solution and a pass level retentate solution of a next pass. In one aspect, the method further includes collecting the pass level permeate solution in one of the at least one reservoir and supplying as a pass level feed solution to any of its subsequent pass until a system level permeate solution is generated. In one aspect, the pressure exerted on the pass level feed solution in fluid communication with the first side of the semipermeable membrane is maintained by at least one of a) varying pressurized boundaries of a liquid container enclosing the at least one reservoir, b) displacing a hydraulic fluid between the at least one reservoir, c) adding hydraulic fluid to the at least one reservoir, d) transporting the pass level retentate solution and the pass level feed solution through the pressurizing unit to recover a portion of energy released by reducing the pressure of the pass level retentate solution and e) utilizing the recovered energy to pressurize the pass level feed solution. In one aspect, a process solution acts as the hydraulic fluid to maintain the pressure exerted on the pass level feed solution in fluid communication with first side of the semipermeable membrane, wherein the process solution includes at least one of the system level feed solution, the system level permeate solution, the system level retentate solution, the pass level feed solution, the pass level permeate solution and the pass level retentate solution. In another aspect, the generated system level retentate solution is removed by the separation by discharging the system level retentate solution to one of the at least one reservoir; isolating one of the at least one reservoir from the separation unit; depressurizing one of the at least one reservoir to an ambient pressure; and removing the generated system level retentate solution from and filling the system level feed solution in one of the at least one reservoir by at least one of a sequential process or by a simultaneous process. In one aspect, the generated system level retentate solution removed by separation system includes: passing the generated system level retentate solution and the system level feed solution partially or completely of the subsequent batch separations and the semi batch separations through the ERD to recover a portion of energy released upon reducing a pressure in the generated system level retentate solution and utilizing the recovered energy to pressurize the system level feed solution, wherein the pressurized system level feed solution from the ERD is collected in one of the at least one reservoir; and removing the system level retentate solution from the ERD on transferring the recovered energy to the system level feed solution. In one aspect, the pass level retentate solution is discharged from the first side of the semi-permeable membrane by: exerting, by the pressurizing unit, the pressure on the pass level feed solution on the first side of the semipermeable membrane to discharge the pass level retentate solution from the first side of the semi-permeable membrane and the pass level permeate solution from the second side of the semipermeable membrane; and recovering, by the pressurizing unit, a portion of energy released upon depressurising the pass level retentate solution and utilizing the recovered energy to pressurize the pass level feed solution.

In one aspect, the at least one reservoir comprises at least one of: an unpressurized liquid container, a piston pressurized liquid container, a piston pressurized liquid container with at least two chambers separated by at least one movable partition, wherein the at least two chambers acts as two different reservoirs; an indirect hydraulically pressurized liquid container with at least two chambers separated by at least one movable partition, wherein the at least two chambers acts as two different reservoirs; a direct hydraulically pressurized liquid container with the hydraulic fluid, wherein the hydraulic fluid is in direct fluid communication with the process solution in the reservoir; a direct feed pressurized reservoir; an unpressurized liquid container with at least two chambers separated by at least one movable partition, wherein the at least two chambers acts as two different reservoirs; an unpressurized liquid container with at least one chamber enclosed by a bladder, wherein the at least one chamber acts as a reservoir and includes one or more connections for supplying and receiving the process solutions and a pressurized liquid container with at least one chamber enclosed by a bladder. wherein the at least one chamber acts as a reservoir and includes one or more connections for supplying and receiving the process solutions. In one aspect, the at least one of the generated system level retentate solution from a batch separation is used as the system level feed solution to another batch separation and the generated system level permeate solution from the batch separation is used as the system level feed solution to another batch separation. In one aspect, the semipermeable membrane used is at least one of a reverse osmosis membrane, a nanofiltration membrane and an ultrafiltration membrane.

In one aspect, a method of performing batch and semi batch separations in a separation system is provided. The method includes a) receiving, by the separation system, a system level feed solution to at least one feed side reservoir and a system level draw solution to at least one draw side reservoir to initiate a first pass of a batch separation, wherein the batch separation includes one or more pass level separations, wherein the system level draw solution having a higher osmotic pressure than an osmotic pressure of the system level feed solution; b) supplying, by the at least one feed side reservoir, one of the system level feed solution and a pass level retentate solution as a pass level feed solution to a first side of a semi-permeable membrane of a separation unit; c) supplying, by the at least one draw side reservoir, one of the system level draw solution and a pass level diluate draw solution as a pass level draw solution to a second side of a semi-permeable membrane of the separation unit, wherein the pass level draw solution having a higher osmotic pressure than an osmotic pressure of the pass level feed solution; d) discharging, by the separation unit, a pass level retentate solution from the first side of the semi-permeable membrane and a pass level diluate draw solution from the second side of the semi permeable membrane, on extracting a pass level permeate solution having a lower osmotic pressure than the osmotic pressure of pass level draw solution by the pass level draw solution to the second side of the semipermeable membrane, wherein the discharged pass level retentate solution is stored in one of the at least one feed side reservoir and supplied as the pass level feed solution to any of its subsequent pass until a system level retentate solution is generated, wherein the discharged pass level diluate draw solution is stored in one of the at least one draw side reservoir and supplied as the pass level draw solution to any of its subsequent pass until a system level diluate draw solution is generated; and e) removing, by the separation unit in fluid communication with the at least one reservoir, the generated system level retentate solution and the system level diluate draw solution from the separation system.

In one aspect, the method further comprises repeating, by the separation system, the described steps (a-e) to continue with one or more subsequent batch separations and semi batch separations. In one aspect, the method further comprises mixing a system level process solution with a pass level process solution thereby achieving the semi-batch separations, wherein the system level process solution includes a system level feed solution, a system level draw solution and a system level retentate solution and system level diluate draw solution, wherein the pass level process solution includes a pass level feed solution, a pass level draw solution and a pass level retentate solution and a pass level diluate draw solution. In one aspect, the method further comprises parallel filling of the one of the at least one feed side reservoir and one of the at least one draw side reservoir with the system level feed solution and the system level draw solution respectively for the one or more subsequent separation cycles to achieve at least one of the batch separation and the semi batch separation. In one aspect, a reservoir switchover sequence is used to enable the separation system to switch connections to supply one of the system level feed solution and the pass level retentate solution stored in one of the at least one feed side reservoir as the pass level feed solution and to supply one of the system level draw solution and the pass level diluate draw solution stored in one of the at least one draw side reservoir as the pass level draw solution to any of its subsequent pass, the reservoir switchover sequence comprises: enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass. In one aspect, the separation system is an osmotically driven separation system. In one aspect, a flow of the feed solution on the first side of the membrane and a flow of the draw solution on the second side of the membrane are one of a counter current, a co-current and a cross-current to each other. In one aspect, one of the generated system level retentate solution from one batch separation or semi batch separation is used as system level feed solution to another batch separation or semi batch separation and the generated system level diluate draw solution from one batch separation or semi batch separation is used as a system level draw solution to another batch separation or semi batch separation.

In one aspect, a separation system for performing batch and semi batch separations is provided. The separation system includes at least one reservoir configured to: receive a system level feed solution from an external source to initiate a first pass of a batch separation, wherein the batch separation includes one or more pass level separations; supply at least one of the system level feed solution and a pass level retentate solution as a pass level feed solution to a first side of a semi-permeable membrane of a separation unit; a pressurizing unit configured to: exert a pressure on the pass level feed solution in fluid communication with the first side of the semipermeable membrane such that a pass level permeate solution from the pass level feed solution passes from the first side of the semipermeable membrane to a second side of the semipermeable membrane of the separation unit, wherein the pressurizing unit includes at least one of an energy recovery device (ERD) device, an high pressure pump, a booster pump, a piston, an hydraulic fluid and pneumatic fluid; the separation unit configured to: discharge a pass level retentate solution from the first side of the semi-permeable membrane, on passing the pass level permeate solution to the second side of the semipermeable membrane, wherein the discharged pass level retentate solution is stored in one of the at least one reservoir and supplied as the pass level feed solution to any of its subsequent pass until a system level retentate solution is generated, wherein the pass level permeate solution is removed as a system level permeate solution; and the separation unit in fluid communication with the at least one reservoir and the pressurizing unit configured to remove the generated system level retentate solution.

In one aspect, the separation system configured to repeat the described steps (a-e) to continue with one or more subsequent batch separations and semi batch separations. In one aspect, the separation system is configured to mix a system level process solution with a pass level process solution thereby achieving the semi-batch separations, wherein the system level process solution includes a system level feed solution, a system level permeate solution and a system level retentate solution, wherein the pass level process solution includes a pass level feed solution, a pass level permeate solution and a pass level retentate solution.

In one aspect, the separation system configured to fill in parallel one of the at least one reservoir with a system level feed solution for the one or more subsequent separation cycles to achieve at least one of the batch separation and the semi batch separation. In one aspect, the separation system configured to enable a reservoir switchover sequence to switch connections to supply at least one of the pass level retentate solution and the pass level permeate solution stored in one of the at least one reservoir as the pass level feed solution to any of its subsequent pass by: enabling different hydraulic segments of the separation system to replace the pass level feed solution, the pass level permeate solution and the pass level retentate solution corresponding to an earlier pass with a pass level feed solution, a pass level permeate solution and a pass level retentate solution of a next pass. In one aspect, the separation system is configured to collect the pass level permeate solution in one of the at least one reservoir and supply as the pass level feed solution to any of its subsequent pass until a system level permeate solution is generated. In one aspect, the pressure exerted on the pass level feed solution in fluid communication with the first side of the semipermeable membrane is maintained by at least one of varying pressurized boundaries of a liquid container enclosing the at least one reservoir, displacing a hydraulic fluid between the at least one reservoir, adding hydraulic fluid to the at least one reservoir, transporting the pass level retentate solution and the pass level feed solution through the pressurizing unit to recover a portion of energy released by reducing the pressure of the pass level retentate solution and utilizing the recovered energy to pressurize the pass level feed solution. In one aspect, a process solution acts as the hydraulic fluid to maintain the pressure exerted on the pass level feed solution in fluid communication with first side of the semipermeable membrane, wherein the process solution includes at least one of the system level feed solution, the system level permeate solution, the system level retentate solution, the pass level feed solution, the pass level permeate solution and the pass level retentate solution. In one aspect, the separation system is configured to remove the generated system level retentate solution by: discharging the system level retentate solution to one of the at least one reservoir; isolating the at least one reservoir from the separation unit; depressurizing one of the at least one reservoir to an ambient pressure; and removing the generated system level retentate solution from and filling the system level feed solution in one of the at least one reservoir by at least one of a sequential process or by a simultaneous process.

In one embodiment, the separation system is configured to remove the generated system level retentate solution by: passing the generated system level retentate solution and the system level feed solution partially or completely of the subsequent batch separations and the semi batch separations through the ERD to recover a portion of energy released upon reducing a pressure in the generated system level retentate solution and utilizing the recovered energy to pressurize the system level feed solution, wherein the pressurized system level feed solution from the ERD is collected in one of the at least one reservoir; and removing the system level retentate solution from the ERD on transferring the recovered energy to the system level feed solution. In one embodiment, the separation unit is configured to discharge a pass level retentate solution from the first side of the semi-permeable membrane by: configuring the pressurizing unit to exert a pressure on the pass level feed solution on the first side of the semipermeable membrane to discharge the pass level retentate solution from the first side of the semi-permeable membrane and a pass level permeate solution from the second side of the semipermeable membrane; and configuring the pressurizing unit to recover a portion of energy released upon depressurising the pass level retentate solution and utilizing the recovered energy to pressurize the pass level feed solution. In one embodiment, the at least one reservoir comprises at least one of: an unpressurized liquid container; a piston pressurized liquid container; a piston pressurized liquid container with at least two chambers separated by at least one movable partition, wherein the at least two chambers acts as two different reservoirs; an indirect hydraulically pressurized liquid container with at least two chambers separated by at least one movable partition; a direct hydraulically pressurized liquid container with the hydraulic fluid in direct fluid communication with the process solution in the reservoir, a direct feed pressurized reservoir, an unpressurized liquid container with at least two chambers separated by at least one movable partition, wherein the at least two chambers acts as two different reservoirs; an unpressurized liquid container with at least one chamber enclosed by a bladder, wherein the at least one chamber acts as a reservoir and includes one or more connections for supplying and receiving the process solutions; and a pressurized liquid container with at least one chamber enclosed by a bladder, wherein the at least one chamber acts as a reservoir and includes one or more connections for supplying and receiving the process solutions. In one aspect, at least one of the generated system level retentate solution from a batch separation is used as the system level feed solution to another batch separation and the generated system level permeate solution from the batch separation is used as the system level feed solution to the another batch separation. In one aspect, the semipermeable membrane used is at least one of a reverse osmosis membrane, a nanofiltration membrane and an ultrafiltration membrane.

In one aspect, a separation system for performing batch and semi batch separations. The separation system includes at least one feed side reservoir configured to: receive a system level feed solution to the at least one feed side reservoir and supply one of the system level feed solution and a pass level retentate solution as a pass level feed solution to a first side of a semi-permeable membrane of a separation unit for a batch separation, wherein the batch separation includes one or more pass level separations, wherein the system level draw solution having a higher osmotic pressure than an osmotic pressure of the system level feed solution; at least one draw side reservoir configured to: receive a system level draw solution to at least one draw side reservoir for the batch separation and supply one of the system level draw solution and a pass level diluate draw solution as a pass level draw solution to a second side of a semi-permeable membrane of the separation unit, wherein the system level draw solution having a higher osmotic pressure than an osmotic pressure of the system level feed solution; the separation unit configured to: discharge a pass level retentate solution from the first side of the semi-permeable membrane and a pass level diluate draw solution from the second side of the semi permeable membrane, on extracting a pass level permeate solution having a lower osmotic pressure than the osmotic pressure of pass level draw solution by the pass level draw solution to the second side of the semipermeable membrane, wherein the discharged pass level retentate solution is stored in one of the at least one feed side reservoir and supplied as the pass level feed solution to any of its subsequent pass until a system level retentate solution is generated, wherein the discharged pass level diluate draw solution is stored in one of the at least one draw side reservoir and supplied as the pass level draw solution to any of its subsequent pass until a system level diluate draw solution is generated; and the separation unit in fluid communication with the at least one reservoir, configured to: remove the generated system level retentate solution and the system level diluate draw solution from the separation system. In one aspect, the separation system is further configured to repeat the described steps to continue with one or more subsequent batch separations and semi batch separations. In one aspect, the separation system is configured to mix a system level process solution with a pass level process solution thereby achieving the semi-batch separations, the system level process solution includes a system level feed solution, a system level draw solution and a system level retentate solution and system level diluate draw solution, wherein the pass level process solution includes a pass level feed solution, a pass level draw solution and a pass level retentate solution and a pass level diluate draw solution. In one aspect, the separation system is configured to fill in parallel one of the at least one feed side reservoir and one of the at least one draw side reservoir with a system level feed solution and the system level draw solution for the one or more subsequent separation cycles to achieve at least one of the batch separation and the semi batch separation. In one aspect, the separation system is configured to enable a reservoir switchover to switch connections to supply one of the system level feed solution and the pass level retentate solution stored in one of the at least one feed side reservoir as the pass level feed solution and to supply one of the system level draw solution and the pass level diluate draw solution stored in one of the at least one draw side reservoir as the pass level draw solution to any of its subsequent pass by: enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass. In one aspect, the separation system is an osmotically driven separation system. In one aspect, a flow of the feed solution on the first side of the membrane and a flow of the draw solution on the second side of the membrane are one of a counter current, a co-current and a cross-current to each other. In one aspect, one of the generated system level retentate solution from one batch separation or semi batch separation is used as system level feed solution to another batch separation or semi batch separation and the generated system level diluate draw solution from one batch separation or semi batch separation is used as a system level draw solution to another batch separation or semi batch separation.

In one aspect, a method of performing batch and semi batch separations in a separation system is provided. The method includes a) receiving, by at least one feed side reservoir, a system level feed solution and supplying as a pass level feed solution to the first side of the semi permeable membrane for a first pass of a first batch; b) supplying, by the at least one draw side reservoir, a pass level draw solution having a higher osmotic pressure than an osmotic pressure of the pass level feed solution corresponding to the first pass to the second side of the semi permeable membrane; c) discharging, by the separation unit, a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as the pass level feed solution to any of its subsequent pass, wherein the discharged pass level diluate draw solution is removed as a system level diluate draw solution; d) supplying, by the at least one feed side reservoir, a pass level retentate produced in the first pass as a pass level feed solution to the first side of the semi permeable membrane for a second pass; e) supplying by the at least one draw side reservoir, a pass level draw solution corresponding to the second pass, to the second side of the semi permeable membrane, wherein the pass level draw solution having a higher osmotic pressure than an osmotic pressure of the pass level feed solution; f) discharging, by the separation unit, a pass level retentate solution from the first side of the semi-permeable membrane and the pass level diluate draw solution from the second side of the semi permeable membrane corresponding to the second pass, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as the pass level feed solution to a third pass, wherein the discharged pass level diluate draw solution is stored in one of the at least one draw side reservoir and supplied as the pass level draw solution to a first pass of a second batch; g) repeating steps (d-f) for further passes till pass n-1 of the first batch to produce a pass level retentate of pass n-1, wherein the discharged pass level diluate draw solution of every pass of the first batch is stored in one of the at least one draw side reservoir and supplied as the pass level draw solution to an earlier pass of a second batch; h) supplying the pass level retentate of pass n-1 as a pass level feed solution to the first side of the semi permeable membrane for a pass n; and i) receiving and supplying, by the at least one draw side reservoir, a system level draw solution having a higher osmotic pressure than the osmotic pressure of the pass level feed solution of the pass n in step h as a pass level draw solution to the second side of the semi permeable membrane; j) discharging, by the separation unit, a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is removed as system level retentate solution, wherein the discharged pass level diluate draw solution is stored in one of the at least one draw side reservoir and supplied as pass level draw solution to n−1 pass of the second batch; k) repeating the steps, a-j for further batches, wherein the system level feed solution and system level draw solution are converted to corresponding system level retentate solution and a system level diluate draw solution.

In one aspect, the method includes receiving and supplying by the at least one draw side reservoir a system level draw solution as a pass level draw solution corresponding to the second pass, to the to second side of the semi permeable membrane and removing the discharged pass level retentate solution corresponding to the second pass, from the first side of the semi-permeable membrane as a system level retentate when a batch consists of maximum of two passes, wherein the pass level draw solution having a higher osmotic pressure than an osmotic pressure of the pass level feed solution. In one aspect, the method includes mixing a system level process solution with a pass level process solution thereby achieving a semi-batch separation, wherein the system level process solution includes a system level feed solution, a system level draw solution, a system level retentate solution and a system level diluate draw solution, wherein the pass level process solution includes a pass level feed solution, a pass level draw solution, a pass level retentate solution and a pass level diluate draw solution.

In one aspect, the method further comprises filling in parallel the at least one feed side reservoir with a system level feed solution and the at least one draw side reservoir with a system level draw solution for the one or more subsequent separation cycles to achieve at least one of the batch separation and the semi batch separation. In one aspect, a reservoir switchover sequence is used to enable the separation system to switch connections to supply one of the system level feed solution and the pass level retentate solution stored in one of the at least one feed side reservoir and one of the system level draw solution and the pass level diluate draw solution stored in one of the at least one draw side reservoir as the pass level feed solution and the pass level draw solution respectively having a higher osmotic pressure than an osmotic pressure of pass level feed solution to any of its subsequent pass, the reservoir switchover sequence comprises: enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass. In one aspect, the flow of feed solution on the first side of the semipermeable membrane and the flow of draw solution on the second side of the semipermeable membrane are one of counter current, co-current and cross-current to each other. In one aspect, at least one of the generated system level retentate solution from one batch separation or semi batch separation is used as system level feed solution to another batch separation or semi batch separation and the generated system level diluate draw solution from one batch separation or semi batch separation is used as system level draw solution to another batch separation or semi batch separation.

In one aspect, a separation system for performing batch and semi batch separations, the separation system comprising: at least one feed side reservoir configured to: receive a system level feed solution and supplying as a pass level feed solution to the first side of the semi-permeable membrane for a first pass of a first batch; and at least one draw side reservoir configured to: supply a pass level draw solution having a higher osmotic pressure than an osmotic pressure of pass level feed solution corresponding to the first pass to the second side of the semi-permeable membrane; a separation unit configured to: discharge a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as the pass level feed solution to any of its subsequent pass, wherein the discharged pass level diluate draw solution is removed as a system level diluate draw solution; the at least one feed side reservoir configured to: supply a pass level retentate produced in the first pass as a pass level feed solution to the first side of the semi-permeable membrane for a second pass; the at least one draw side reservoir configured to: supply a pass level draw solution corresponding to the second pass, to the second side of the semi permeable membrane, wherein the pass level draw solution having a higher osmotic pressure than an osmotic pressure of pass level feed solution; the separation unit configured to: discharge a pass level retentate solution from the first side of the semi-permeable membrane and the pass level diluate draw solution from the second side of the semi permeable membrane corresponding to the second pass, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as the pass level feed solution to a third pass, wherein the discharged pass level diluate draw solution is stored in one of the at least one draw side reservoir and supplied as the pass level draw solution to a first pass of a second batch; repeating steps (d-f) for further passes till pass n-1 of the first batch to produce a pass level retentate of pass n-1, wherein the discharged pass level diluate draw solution of every pass of the first batch is stored in one of the at least one draw side reservoir and supplied as the pass level draw solution to an earlier pass of a second batch; the at least one feed side reservoir configured to: supply the pass level retentate of pass n-1 as a pass level feed solution to the first side of the semi permeable membrane for a pass n; and the at least one draw side reservoir configured to: receive and supply a system level draw solution as a pass level draw solution having a higher osmotic pressure than an osmotic pressure of pass level feed solution of the pass n in step h as a pass level draw solution to the second side of the semi permeable membrane; the separation unit configured to: discharge a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is removed as system level retentate solution, wherein the discharged pass level diluate draw solution is stored in one of the at least one draw side reservoir and supplied as pass level draw solution to n−1 pass of the second batch; repeat the steps a-j for further batches, wherein the system level feed solution and system level draw solution are converted to corresponding system level retentate solution and a system level diluate draw solution.

In one aspect, the at least one draw side reservoir is configured to receive and supply a system level draw solution as a pass level draw solution corresponding to the second pass, to the second side of the semi permeable membrane and removing the discharged pass level retentate solution corresponding to the second pass, from the first side of the semi-permeable membrane as a system level retentate when a batch consists of maximum of two passes, wherein the pass level draw solution having a higher osmotic pressure than an osmotic pressure of the pass level feed solution. In one aspect, the separation system further configured to mix a system level process solution with a pass level process solution thereby achieving a semi-batch separation, wherein the system level process solution includes a system level feed solution, a system level draw solution, a system level retentate solution and a system level diluate draw solution, wherein the pass level process solution includes a pass level feed solution, a pass level draw solution, a pass level retentate solution and a pass level diluate draw solution. In one aspect, the separation system further configured to fill in parallel the at least one feed side reservoir with a system level feed solution and the at least one draw side reservoir with a system level draw solution for the one or more subsequent separation cycles to achieve at least one of the batch separation and the semi batch separation. In one aspect, the separation system further configured to enable a reservoir switchover sequence to switch connections to supply one of the system level feed solution and the pass level retentate solution stored in one of the at least one feed side reservoir and one of the system level draw solution and the pass level diluate draw solution stored in one of the at least one draw side reservoir as the pass level feed solution and the pass level draw solution having a higher osmotic pressure than an osmotic pressure of pass level feed solution to any of its subsequent pass by: enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass. In one aspect, the flow of feed solution on the first side of the semipermeable membrane and the flow of draw solution on the second side of the semipermeable membrane are one of counter current, co-current and cross-current to each other. In one aspect, at least one of the generated system level retentate solution from one batch separation or semi batch separation is used as system level feed solution to another batch separation or semi batch separation and the generated system level diluate draw solution from one batch separation or semi batch separation is used as system level draw solution to another batch separation or semi batch separation.

In one aspect, a method of performing batch and semi batch separations in a separation system, the method comprising: a) receiving, by a at least one draw side reservoir, a system level draw solution and supplying as a pass level draw solution to the second side of the semi permeable membrane for a first pass of a first batch; b) supplying, by the at least one feed side reservoir, a pass level feed solution having a lower osmotic pressure than an osmotic pressure of the pass level draw solution corresponding to the first pass to the first side of the semi permeable membrane; c) discharging, by the separation unit, a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is removed as a system level retentate solution, wherein the discharged pass level diluate draw solution is stored in one of the at least one draw side reservoir and supplied as the pass level draw solution to any of its subsequent pass; d) supplying, by the at least one draw side reservoir, a pass level diluate draw solution produced in the first pass as a pass level draw solution to the second side of the semi permeable membrane for a second pass; e) supplying by the at least one feed side reservoir, a pass level feed solution corresponding to the second pass, to the first side of the semi permeable membrane, wherein the pass level feed solution having a lower osmotic pressure than an osmotic pressure of the pass level draw solution; f) discharging, by the separation unit, a pass level retentate solution from the first side of the semi-permeable membrane and the pass level diluate draw solution from the second side of the semi permeable membrane corresponding to the second pass, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as the pass level feed solution to a first pass of a second batch, wherein the discharged pass level diluate draw solution is stored in one of the at least one draw side reservoir and supplied as the pass level draw solution to a third pass; g) repeating steps (d-f) for further passes till pass n−1 of the first batch to produce a pass level diluate draw of pass n−1, wherein the discharged pass level retentate solution of every pass of the first batch is stored in one of the at least one feed side reservoir and supplied as the pass level feed solution to an earlier pass of a second batch; h) supplying the pass level diluate draw of pass n−1 as a pass level draw solution to the second side of the semi permeable membrane for a pass n; i) receiving and supplying, by the at least one feed side reservoir, a system level feed solution having a lower osmotic pressure than the osmotic pressure of the pass level draw solution of the pass n in step h as a pass level feed solution to the first side of the semi permeable membrane; j) discharging, by the separation unit, a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as pass level feed solution to n−1 pass of the second batch, wherein the discharged pass level diluate draw solution is removed as system level diluate draw solution; k) repeating the steps, a-j for further batches, wherein the system level feed solution and system level draw solution are converted to corresponding system level retentate solution and a system level diluate draw solution.

In one aspect, the method comprises receiving and supplying by the at least one feed side reservoir a system level feed solution as a pass level feed solution corresponding to the second pass, to the to first side of the semi permeable membrane and removing the discharged pass level diluate draw solution corresponding to the second pass, from the second side of the semi permeable membrane as a system level diluate draw solution when a batch consists of maximum of two passes, wherein the pass level draw solution having a higher osmotic pressure than an osmotic pressure of the pass level feed solution. In one aspect, the method further comprises mixing a system level process solution with a pass level process solution thereby achieving a semi-batch separation, wherein the system level process solution includes a system level feed solution, a system level draw solution, a system level retentate solution and a system level diluate draw solution, wherein the pass level process solution includes a pass level feed solution, a pass level draw solution, a pass level retentate solution and a pass level diluate draw solution. In one aspect, the method further comprises filling in parallel the at least one feed side reservoir with a system level feed solution and the at least one draw side reservoir with a system level draw solution for the one or more subsequent separation cycles to achieve at least one of the batch separation and the semi batch separation. In one aspect, a reservoir switchover sequence is used to enable the separation system to switch connections to supply one of the system level feed solution and the pass level retentate solution stored in one of the at least one feed side reservoir and one of the system level draw solution and the pass level diluate draw solution stored in one of the at least one draw side reservoir as the pass level feed solution and the pass level draw solution respectively having a higher osmotic pressure than an osmotic pressure of pass level feed solution to any of its subsequent pass, the reservoir switchover sequence comprises: enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass. In one aspect, the flow of feed solution on the first side of the semipermeable membrane and the flow of draw solution on the second side of the semipermeable membrane are one of counter current, co-current and cross-current to each other. In one aspect, at least one of the generated system level retentate solution from one batch separation or semi batch separation is used as system level feed solution to another batch separation or semi batch separation and the generated system level diluate draw solution from one batch separation or semi batch separation is used as system level draw solution to another batch separation or semi batch separation.

In one aspect, a separation system for performing batch and semi batch separation is provided. The separation system includes at least one draw side reservoir configured to: a) receive a system level draw solution and supplying as a pass level draw solution to the second side of the semi-permeable membrane for a first pass of a first batch; and at least one feed side reservoir configured to: b) supply a pass level feed solution having a lower osmotic pressure than an osmotic pressure of pass level draw solution corresponding to the first pass to the first side of the semi-permeable membrane; a separation unit configured to: c) discharge a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is removed as a system level retentate solution, wherein the discharged pass level diluate draw solution is stored in one of the at least one draw side reservoir and supplied as the pass level draw solution to any of its subsequent pass; the at least one draw side reservoir configured to: d) supply a pass level diluate draw solution produced in the first pass as a pass level draw solution to the second side of the semi-permeable membrane for a second pass; the at least one feed side reservoir configured to: e) supply a pass level feed solution corresponding to the second pass, to the first side of the semi permeable membrane, wherein the pass level feed solution having a lower osmotic pressure than an osmotic pressure of pass level draw solution; the separation unit configured to: f) discharge a pass level retentate solution from the first side of the semi-permeable membrane and the pass level diluate draw solution from the second side of the semi permeable membrane corresponding to the second pass, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as the pass level feed solution to a first pass of a second batch, wherein the discharged pass level diluate draw solution is stored in one of the at least one draw side reservoir and supplied as the pass level draw solution to a third pass; g) repeating steps (d-f) for further passes till pass n−1 of the first batch to produce a pass level diluate draw of pass n−1, wherein the discharged pass level retentate solution of every pass of the first batch is stored in one of the at least one feed side reservoir and supplied as the pass level feed solution to an earlier pass of a second batch; the at least one draw side reservoir configured to: h) supply the pass level diluate draw of pass n−1 as a pass level draw solution to the second side of the semi permeable membrane for a pass n; and the at least one feed side reservoir configured to: i) receive and supply a system level feed solution having a lower osmotic pressure than an osmotic pressure of pass level draw solution of the pass n in step h as a pass level feed solution to the second side of the semi permeable membrane; the separation unit configured to: j) discharge a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane, wherein the discharged pass level retentate solution is stored in one of the at least one feed side reservoir and supplied as pass level feed solution to n−1 pass of the second batch, wherein the discharged pass level diluate draw solution is removed as system level diluate draw solution; k) repeat the steps a-j for further batches, wherein the system level feed solution and system level draw solution are converted to corresponding system level retentate solution and a system level diluate draw solution.

In one aspect, the at least one feed side reservoir configured to receive and supply a system level feed solution as a pass level feed solution corresponding to the second pass, to the first side of the semi permeable membrane and removing the discharged pass level diluate draw solution corresponding to the second pass, from the second side of the semi permeable membrane as a system level diluate draw solution when a batch consists of maximum of two passes, wherein the pass level draw solution having a higher osmotic pressure than an osmotic pressure of the pass level feed solution. In one aspect, the separation system further configured to mix a system level process solution with a pass level process solution thereby achieving a semi-batch separation, wherein the system level process solution includes a system level feed solution, a system level draw solution, a system level retentate solution and a system level diluate draw solution, wherein the pass level process solution includes a pass level feed solution, a pass level draw solution, a pass level retentate solution and a pass level diluate draw solution. In one aspect, the separation system further configured to fill in parallel the at least one feed side reservoir with a system level feed solution and the at least one draw side reservoir with a system level draw solution for the one or more subsequent separation cycles to achieve at least one of the batch separation and the semi batch separation. In one aspect, the separation system further configured to enable a reservoir switchover sequence to switch connections to supply one of the system level feed solution and the pass level retentate solution stored in one of the at least one feed side reservoir and one of the system level draw solution and the pass level diluate draw solution stored in one of the at least one draw side reservoir as the pass level feed solution and the pass level draw solution respectively having a higher osmotic pressure than an osmotic pressure of pass level feed solution to any of its subsequent pass by: enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass. In one aspect, the flow of feed solution on the first side of the semipermeable membrane and the flow of draw solution on the second side of the semipermeable membrane are one of counter current, co-current and cross-current to each other. In one aspect, the at least one of the generated system level retentate solution from one batch separation or semi batch separation is used as system level feed solution to another batch separation or semi batch separation and the generated system level diluate draw solution from one batch separation or semi batch separation is used as system level draw solution to another batch separation or semi batch separation.

This and other aspects are disclosed herein.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A depicts an exemplary semi-permeable membrane.

FIG. 1B depicts a separation unit with process solution circulation across single side of semi-permeable membrane.

FIG. 1C depicts a separation unit with process solution circulation across two sides of semi-permeable membrane.

FIG. 1D illustrates a multiple pass batch separation with flow on a single side of semi-permeable membrane.

FIG. 1E illustrates a multiple pass batch separation with flow on both sides of a semi-permeable membrane.

FIG. 1F illustrates a cascading batch level solutions for separations with flow on a single side of semi-permeable membrane.

FIG. 1G illustrates a linear and transverse cascading of process solutions between separation processes with progress of process time for a pass, a batch or a semi-batch separation. The exemplary system refers to a pressure driven separation (e.g. RO) with process solution flow on single side of membrane.

FIG. 1H illustrates volume compensation, parallel removal and filling for multiple batches (with odd passes in each batch) for a piston pressurized liquid containers with movable partition and hydraulic fluid assistance.

FIG. 1E illustrates volume compensation, parallel removal and filling for multiple batches (with odd passes in each batch) for indirect hydraulic fluid pressurized liquid containers with movable partition.

FIG. 2A illustrates a liquid container and reservoir.

FIG. 2B illustrates a liquid container and reservoir.

FIG. 2C illustrates a liquid container and reservoir.

FIG. 2D illustrates a liquid container and reservoir.

FIG. 2E illustrates a liquid container and reservoir.

FIG. 2F illustrates a liquid container and reservoir.

FIG. 2G illustrates a liquid container and reservoir.

FIG. 2H illustrates a liquid container and reservoir.

FIG. 21 illustrates a liquid container and reservoir.

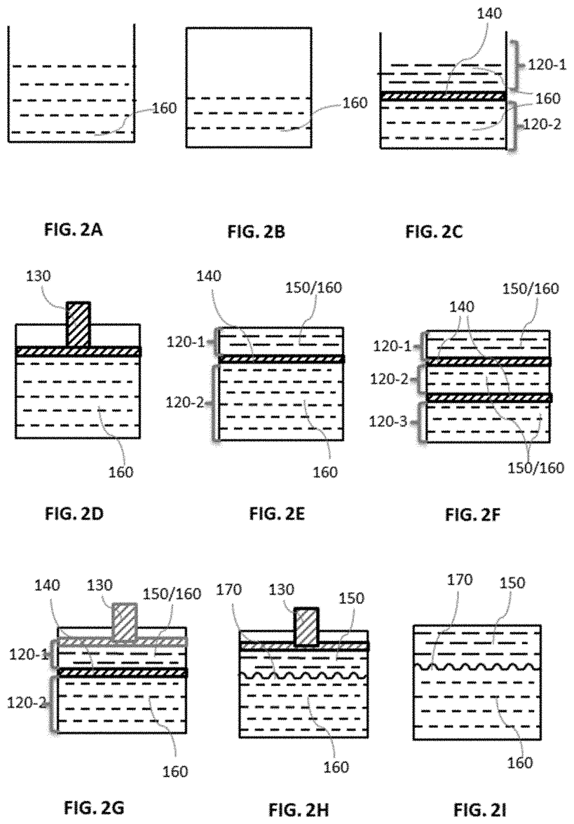

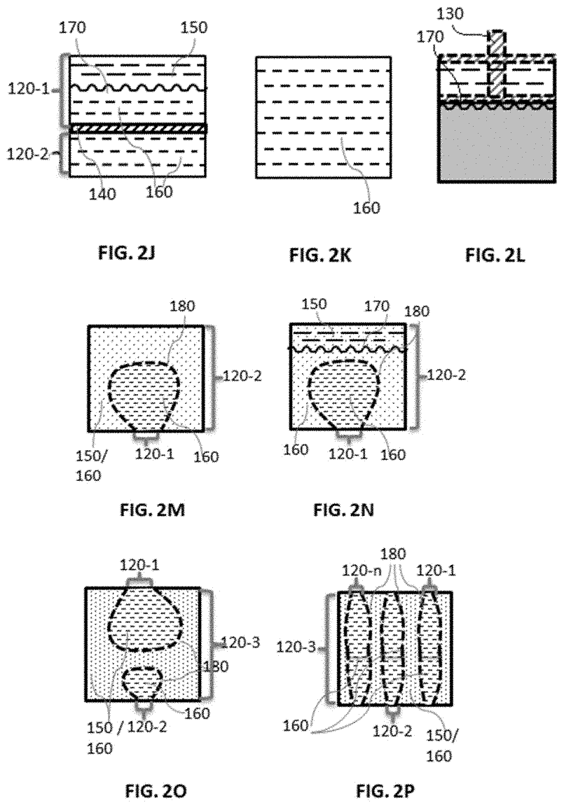

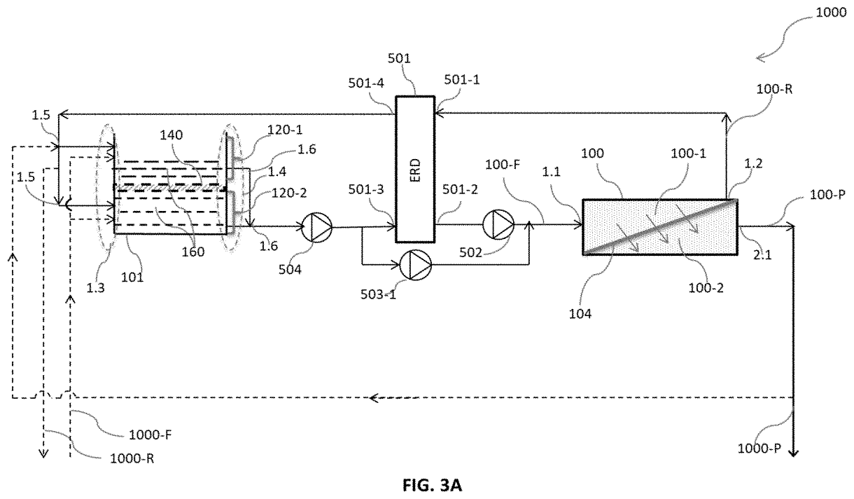

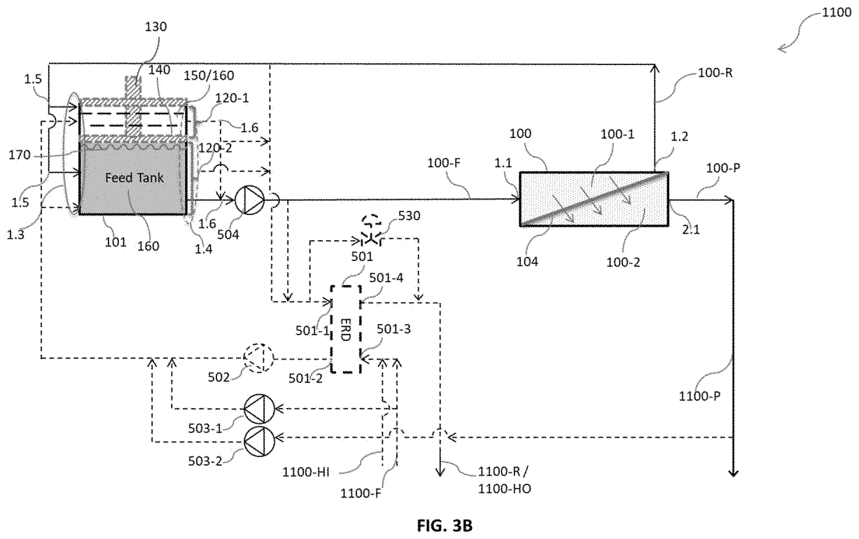

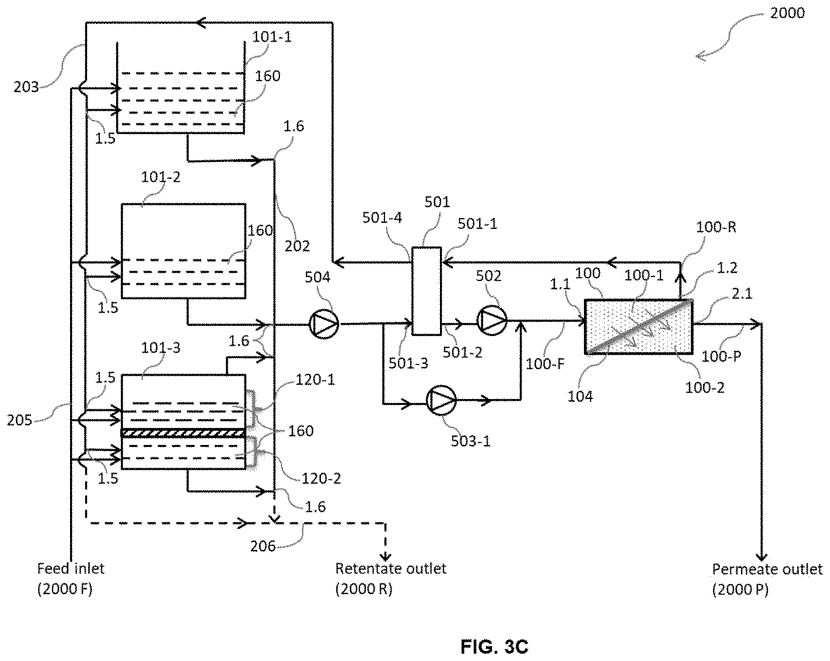

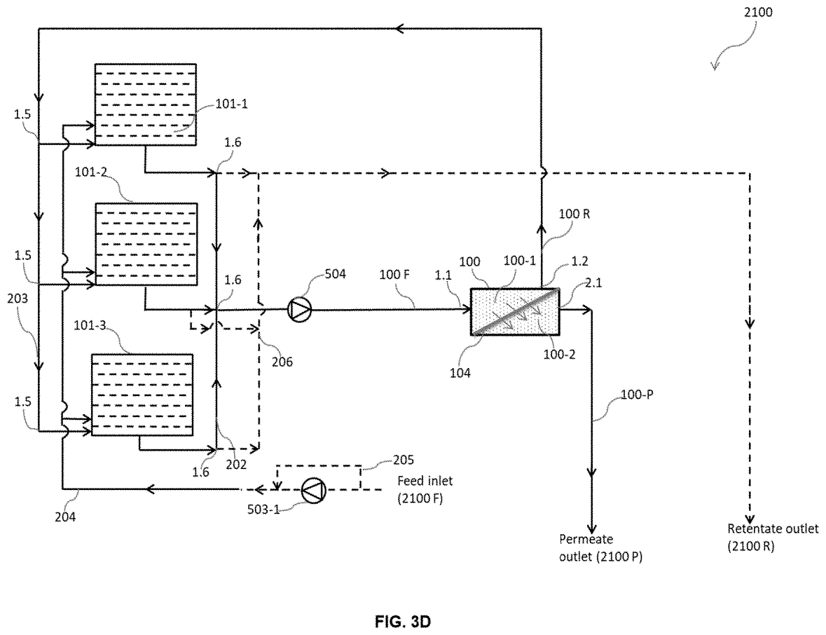

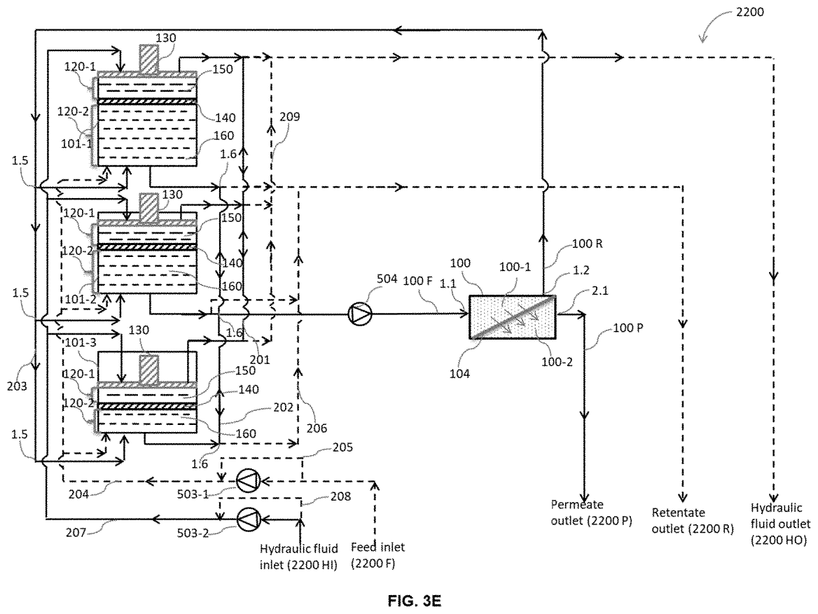

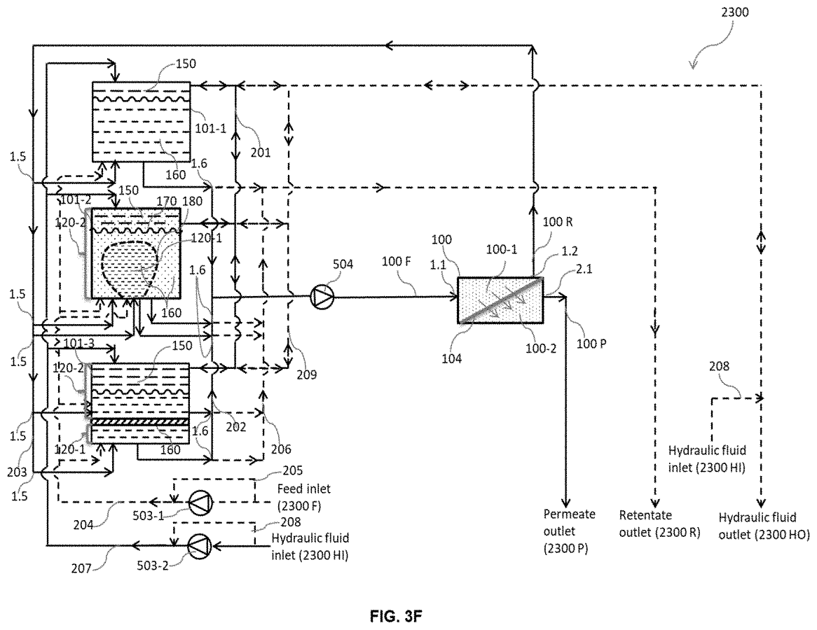

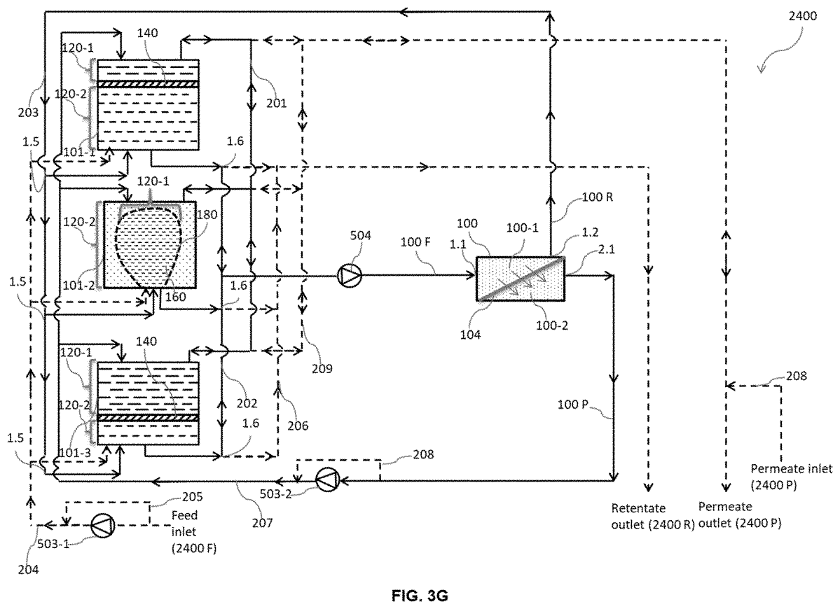

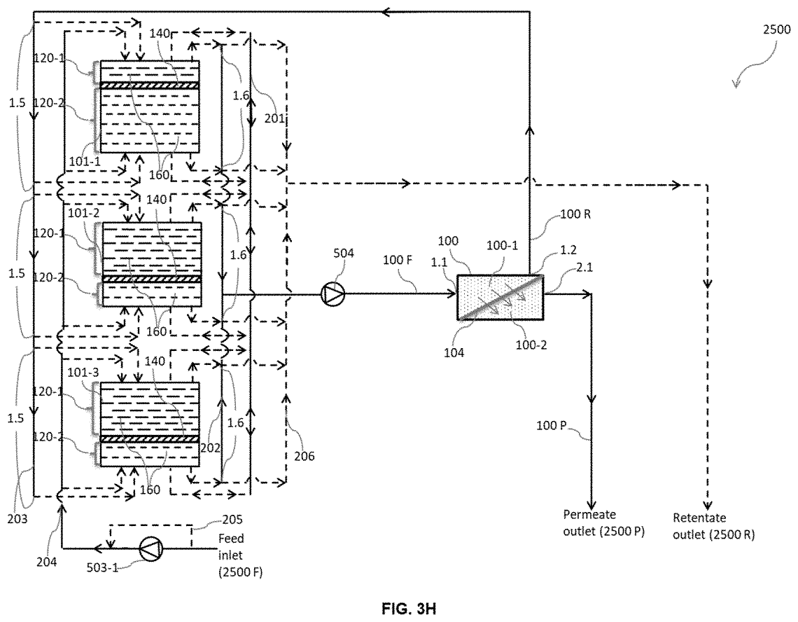

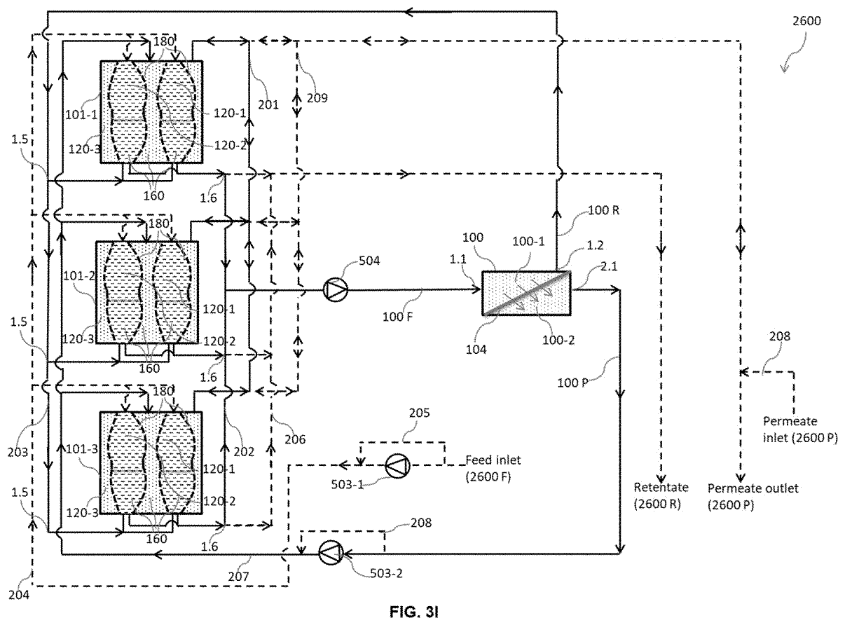

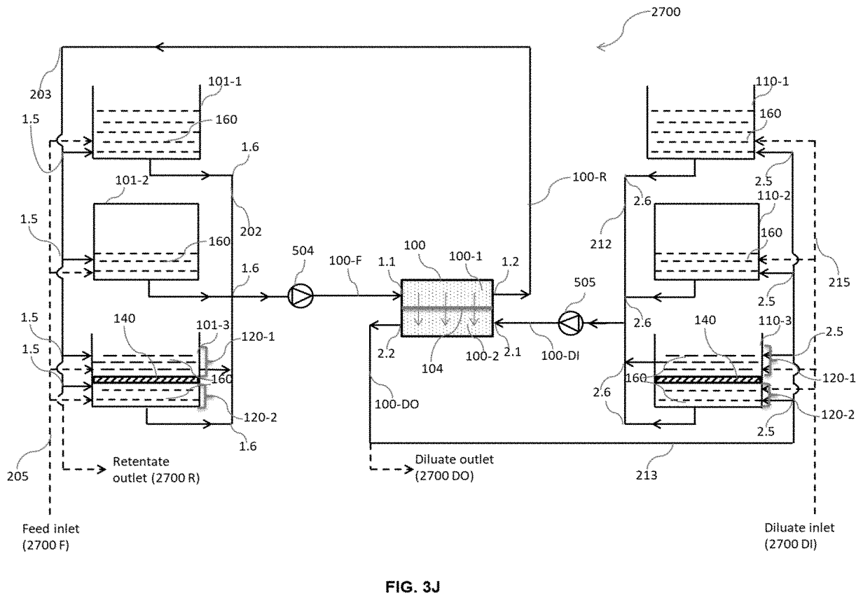

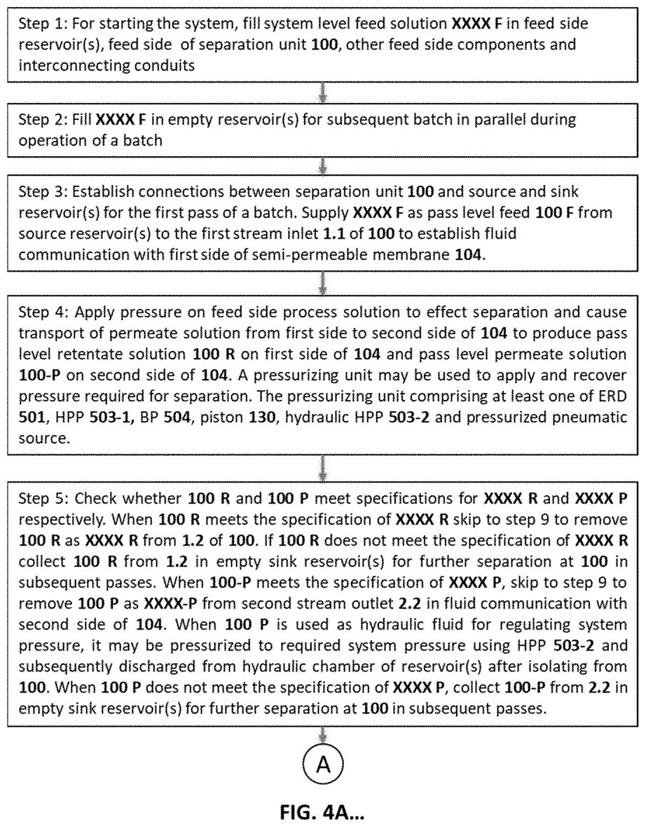

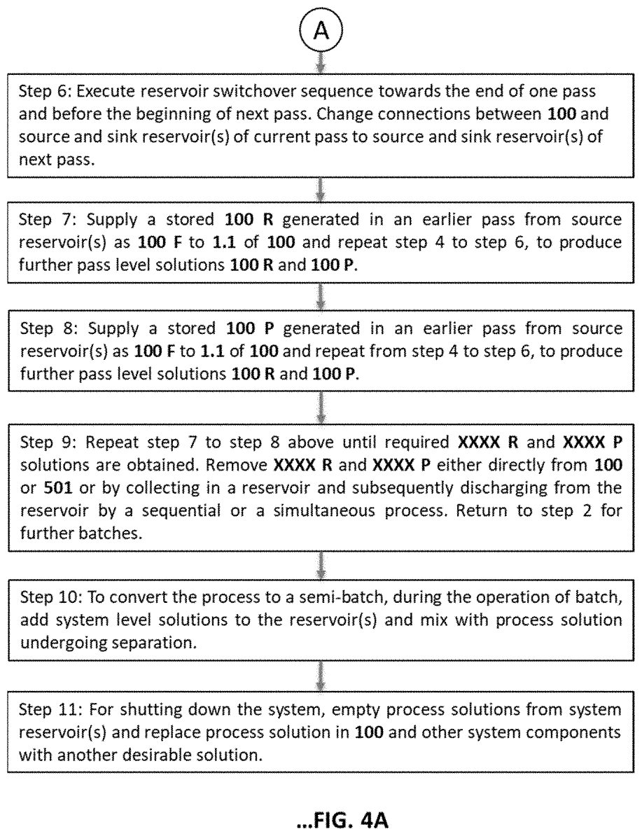

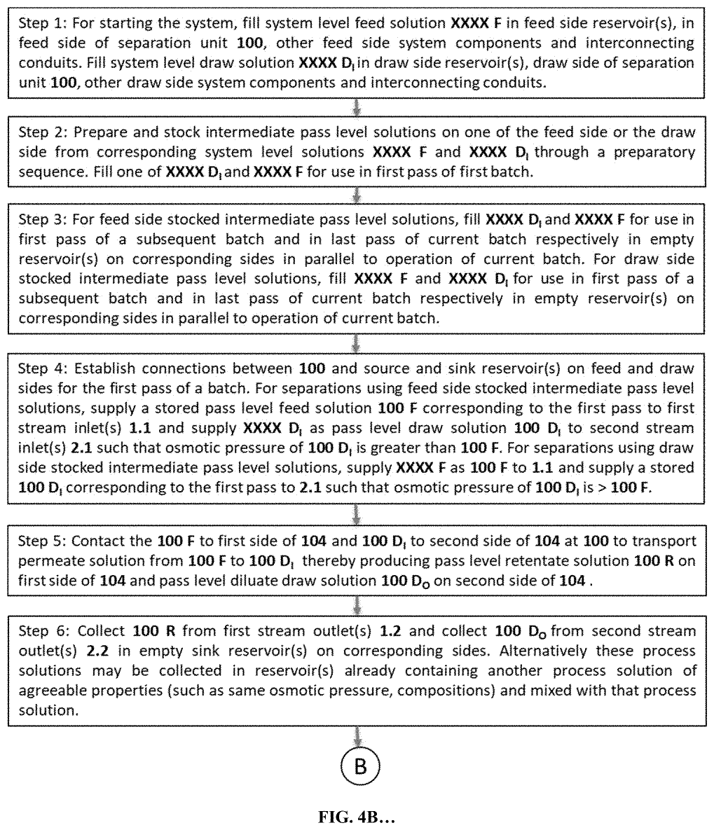

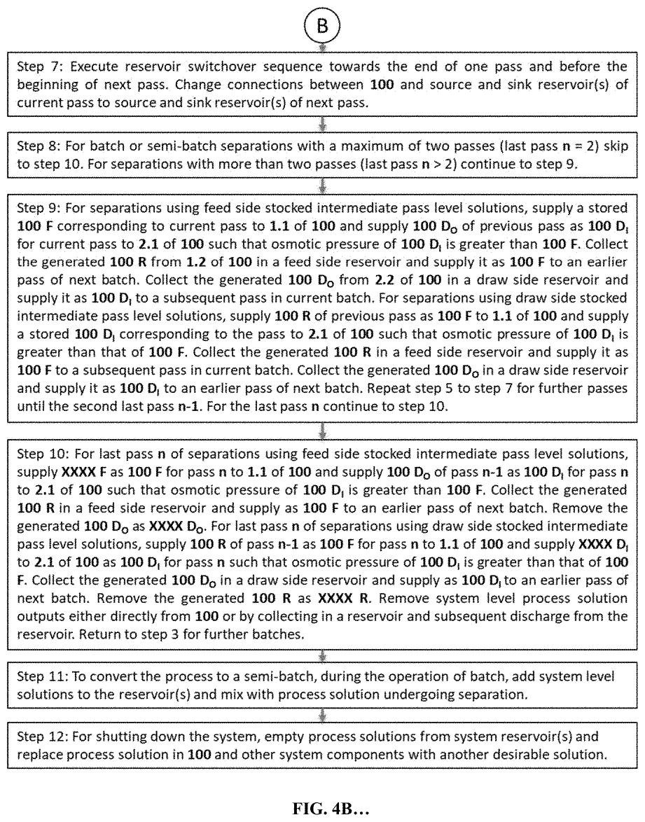

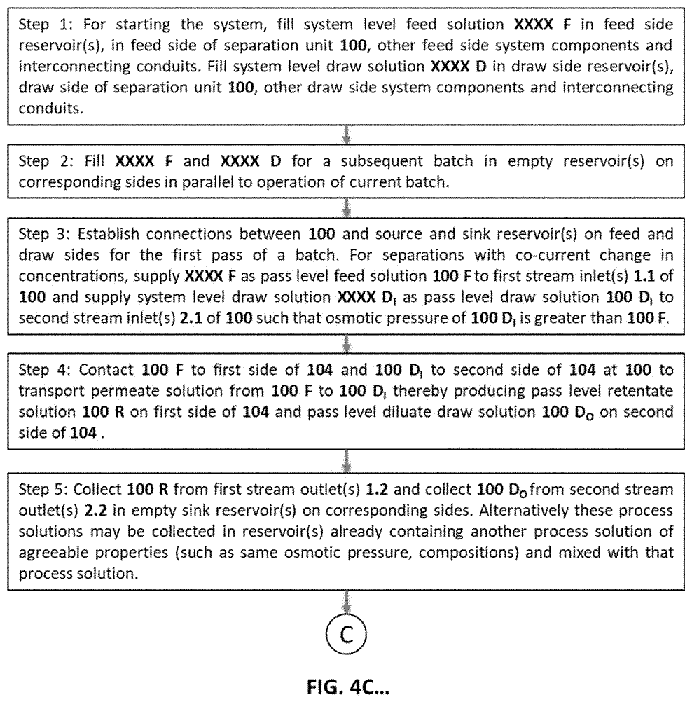

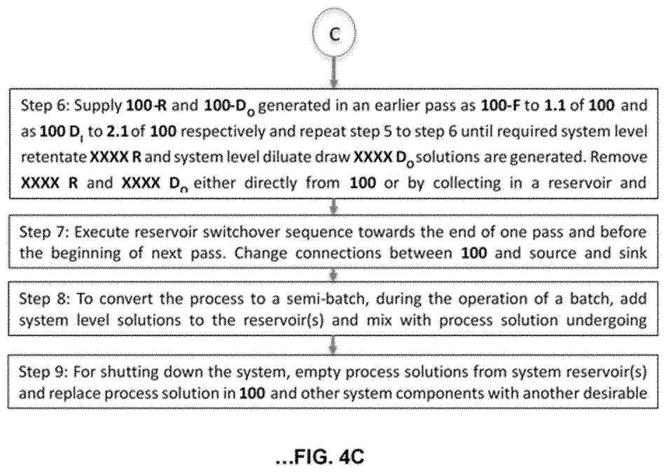

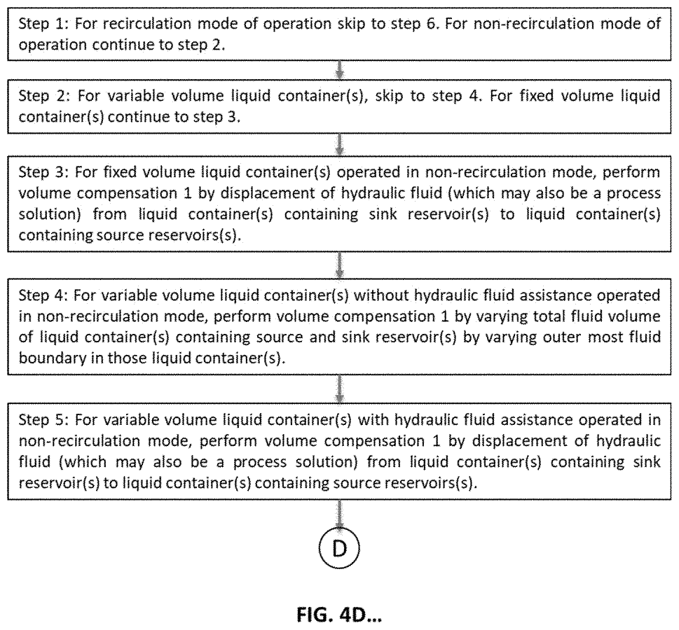

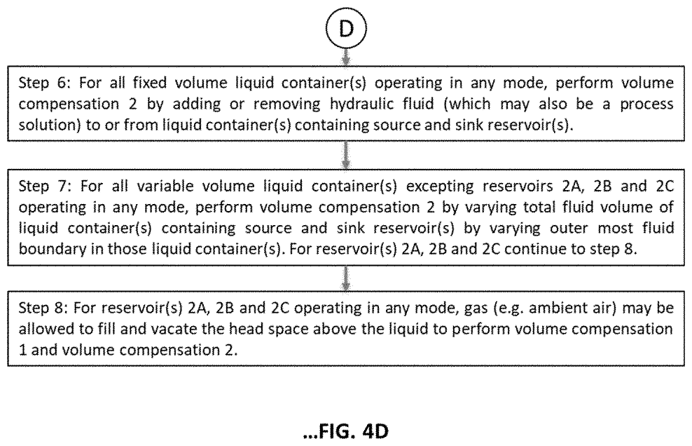

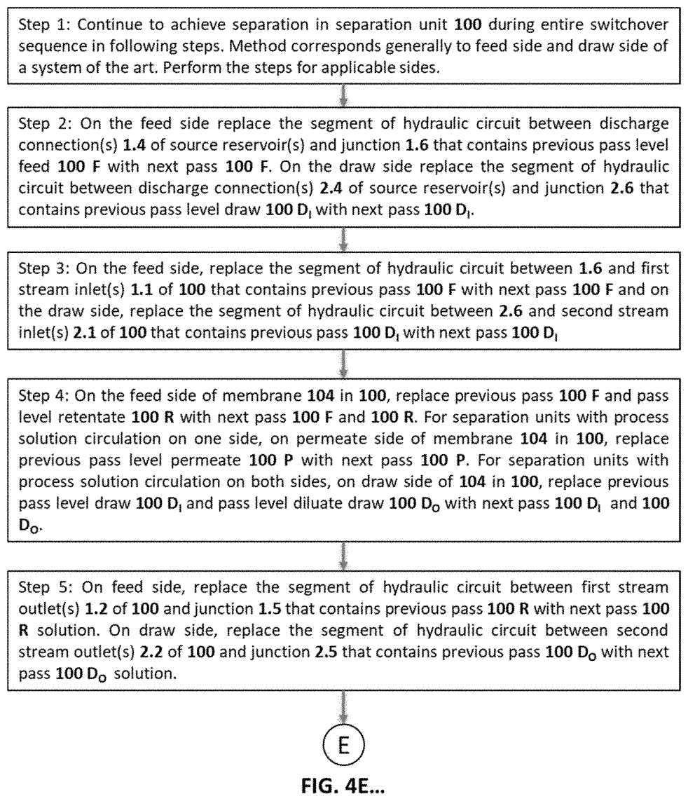

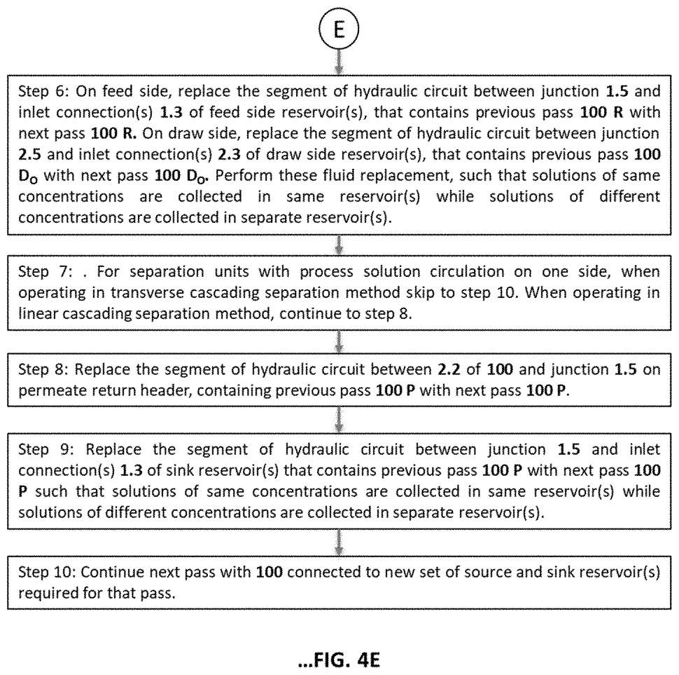

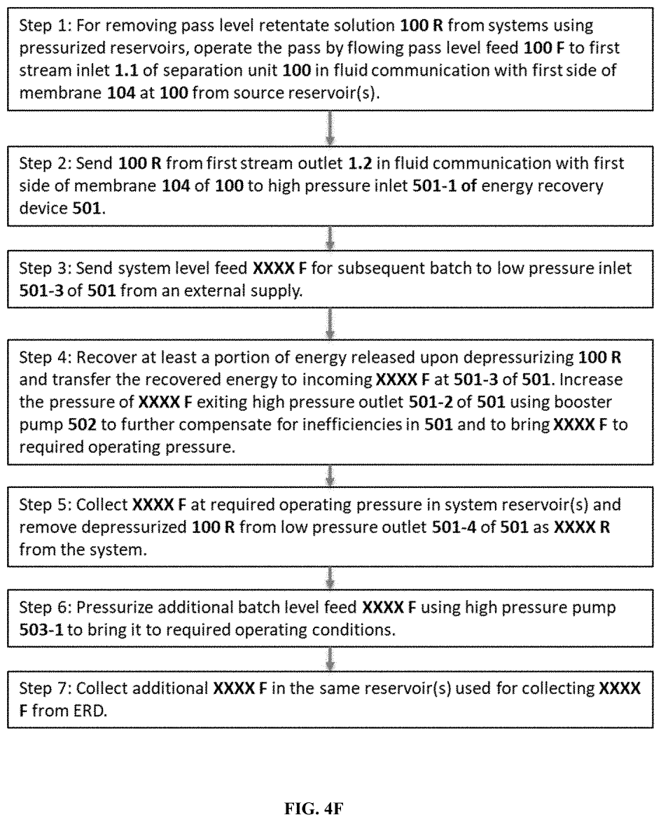

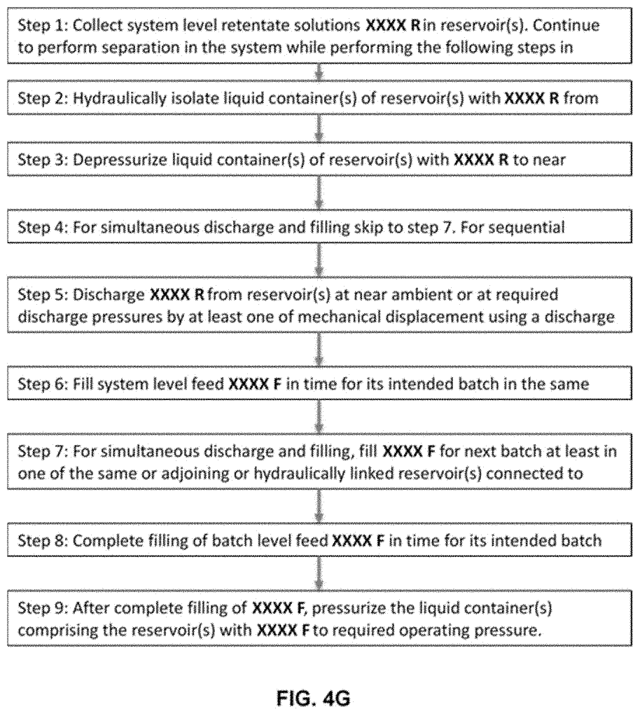

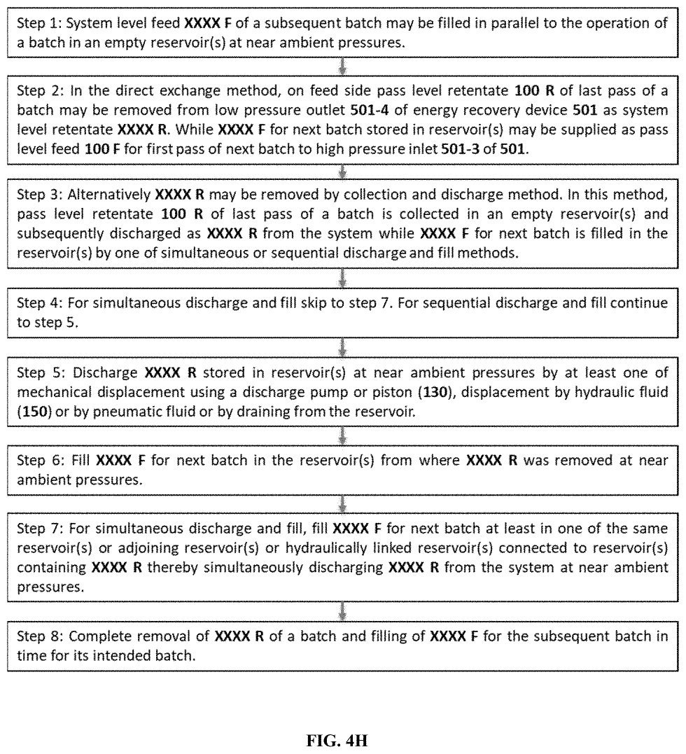

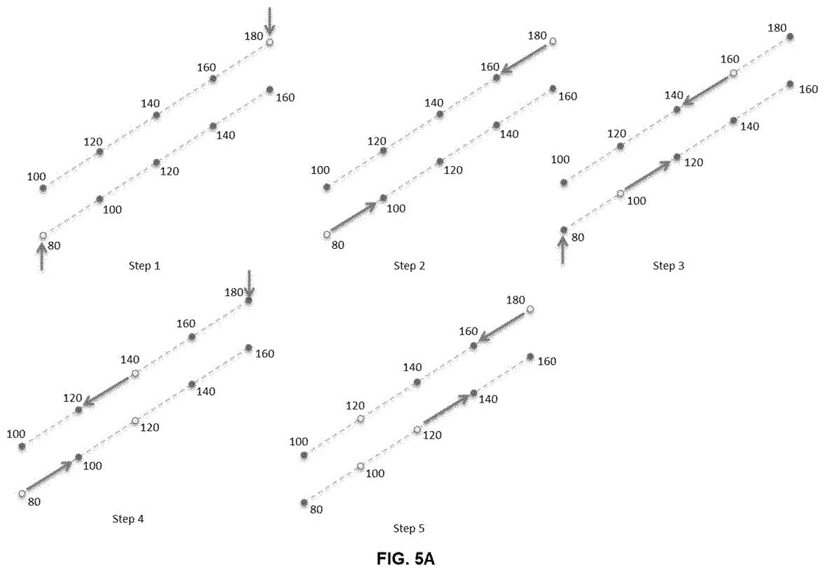

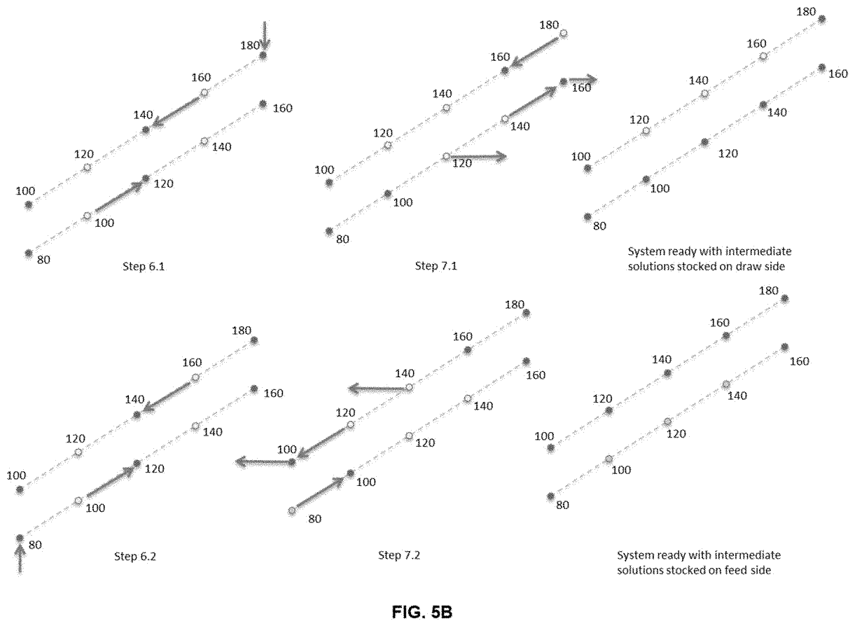

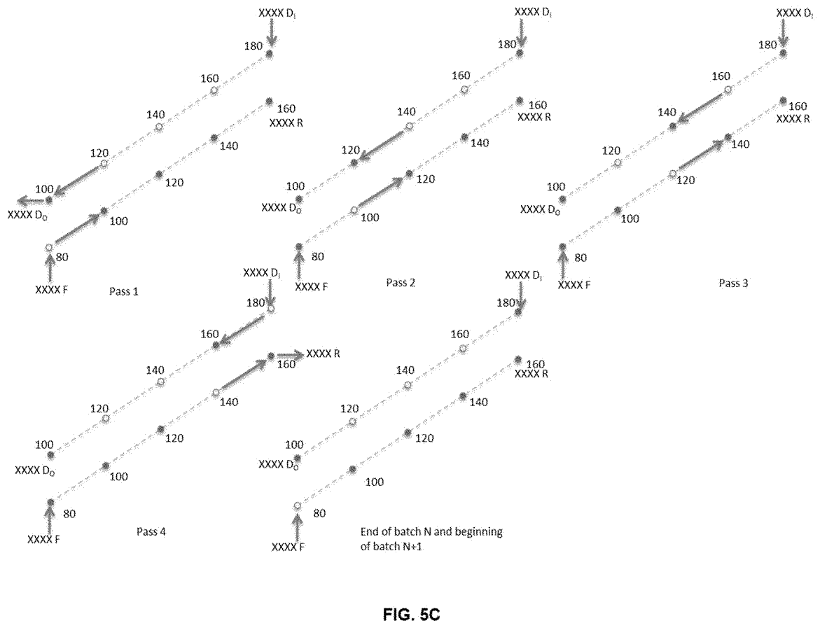

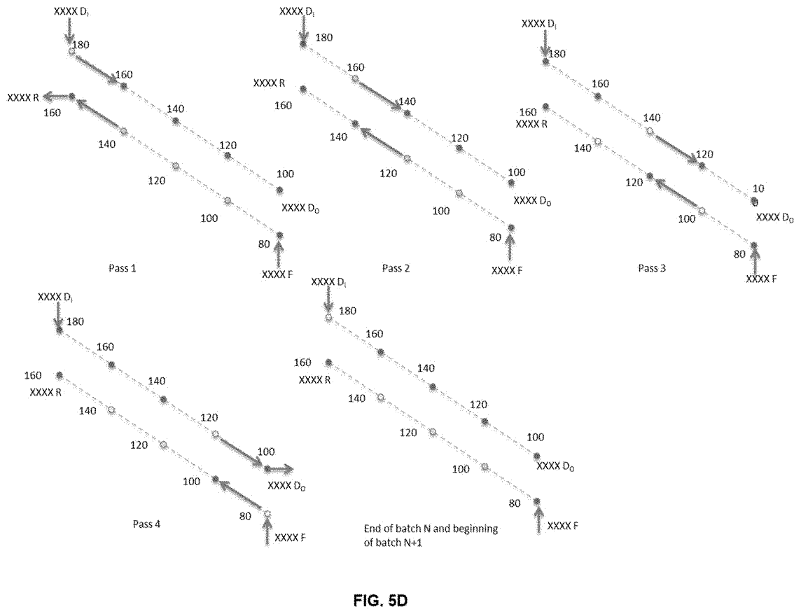

FIG. 2J illustrates a liquid container and reservoir.

FIG. 2K illustrates a liquid container and reservoir.

FIG. 2L illustrates a liquid container and reservoir.

FIG. 2M illustrates a liquid container and reservoir.

FIG. 2N illustrates a liquid container and reservoir.

FIG. 20 illustrates a liquid container and reservoir.

FIG. 2P illustrates a liquid container and reservoir.

FIG. 3A shows a batch and semi-batch pressure driven separation using unpressurised feed tanks.

FIG. 3B shows a batch and semi-batch pressure driven separation using pressurized feed tanks.

FIG. 3C shows a batch and semi-batch pressure driven separation using unpressurized feed tanks.

FIG. 3D shows a semi-batch pressure driven separation using direct feed pressurized fixed total volume feed tanks.

FIG. 3E shows a batch and semi-batch pressure driven separation using indirect hydraulically pressurized variable total volume feed tanks.

FIG. 3F shows a batch and semi-batch pressure driven separation using direct hydraulically pressurized fixed total volume feed tanks.

FIG. 3G shows a batch and semi-batch pressure driven separation using indirect filtrate pressurized fixed total volume feed tanks.

FIG. 3H shows a batch and semi-batch pressure driven separation using indirect filtrate pressurized fixed total volume feed tanks.

FIG. 3I shows a batch and semi-batch pressure driven separation using indirect filtrate pressurized fixed total volume feed tanks.

FIG. 3J shows a batch and semi-batch electrically driven and chemically driven separations using unpressurized tanks on two fluid circuits.

FIG. 4A depicts a method of performing pressure driven osmotic and non-osmotic separation (e.g. RO, filtration) wherein process solution is transported across a first side of semi-permeable membrane.

FIG. 4B depicts a method of performing osmotically driven separations (e.g. FO) wherein process solution is transported across a first side and across a second side of semi-permeable membrane and counter current change in concentrations process solutions is accomplished.

FIG. 4C depicts a method of performing osmotically driven separations (e.g. FO) wherein process solution is transported across a first side and across a second side of semi-permeable membrane and co-current change in concentrations process solutions is accomplished.

FIG. 4D depicts a method of performing volume compensation for pressurized and unpressurized reservoirs for all separations.

FIG. 4E depicts a method of performing reservoir switchover sequence.

FIG. 4F depicts a direct exchange method of removing system level retentate and filling system level feed for systems with process solution flow across the first side of operating with pressurized reservoirs.

FIG. 4G depicts a collection and exchange method of removing system level retentate and filling system level feed for systems with process solution flow across the first side of operating with pressurized reservoirs.

FIG. 4H depicts a direct exchange method and collection and exchange method of removing system level retentate and filling system level feed for systems with process solution flow across the first side of operating with unpressurized reservoirs.

FIG. 5A illustrates a method of preparing stocked intermediate pass level solutions for an osmotically driven separation (e.g. FO) with counter current change in salinities. The system consists of process solution flow on both sides of membrane in counter current flow arrangement. Exemplary solution concentrations in grams per liter are used.

FIG. 5B illustrates a method of preparing stocked intermediate pass level solutions for an osmotically driven separation (e.g. FO) with counter current change in salinities. The system consists of process solution flow on both sides of membrane in counter current flow arrangement. Exemplary solution concentrations in grams per liter are used.

FIG. 5C illustrates a method of performing an osmotically driven separation (e.g. FO) with counter current change in salinities using stocked draw side intermediate pass level solutions. The system consists of process solution flow on both sides of membrane in counter current flow arrangement. Exemplary solution concentrations in grams per liter are used.

FIG. 5D illustrates a method of performing an osmotically driven separation (e.g. FO) with counter current change in salinities using stocked feed side intermediate pass level solutions. The system consists of process solution flow on both sides of membrane in counter current flow arrangement. Exemplary solution concentrations in grams per liter are used.

FIG. 5E illustrates a counter current change in concentrations of process solutions, in grams per liter, with progress of passes or process time for an exemplary process. The method using feed side stocked intermediate pass level solution. Overall concentration change on feed and draw sides are also shown. The exemplary system refers to an osmotically driven separation (e.g. FO) with process solution flow on both sides of membrane in counter current flow arrangement.

FIG. 5F illustrates counter current change in concentrations of process solutions, in grams per liter, with progress of passes or process time for an exemplary process. The method using draw side stocked intermediate pass level solutions. Overall concentration change on feed and draw sides corresponding are also shown. The exemplary system refers to an osmotically driven separation (e.g. FO) with process solution flow on both sides of membrane in counter current flow arrangement.

FIG. 5G illustrates co-current change in concentration of process solutions, in grams per liter, with progress of passes or process time for an exemplary process. Overall concentration change on feed and draw are also shown. The exemplary system refers to an osmotically driven separation (e.g. FO) with process solution flow on both sides of membrane in counter current flow arrangement.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

Key inventive features: Without being bound to any particular separation system, benefits of batch and semi-batch (i.e. transient) separations over steady state separations is described below. Transient separation processes are able to achieve higher process efficiency than steady state processes, because time is available as an additional process dimension for distribution of driving force of separation and thus achieve equipartitioning of entropy generation. Equipartitioning of entropy generation is known to improve thermodynamic efficiency of separation processes. For a pressure driven separation this translates to optimal spacial and temporal distribution of net driving pressure while for osmotically driven separation this corresponds to optimal spacial and temporal distribution of gradient in osmotic pressures. The extent of separation achieved (e.g. recovery in RO processes) is limited either by solution osmotic pressures or by precipitation of sparingly soluble salts or deposition of other foulants. Typically at high degrees of separations the tendency for precipitation by sparingly soluble salts is high. In steady state separations, if equipment is operated at this condition, there is sufficient time for precipitation of these salts on the equipment that adversely affects performance. However in transient separations, duration of exposure of the system at this operating condition may be controlled so that the kinetics of salt precipitation (or deposition of any other foulants) is slower than the duration for which precipitation or scaling conditions exist. This allows for simultaneous gains in operational efficiency and equipment life. An additional benefit of operating a transient process is the varying application of separation energy (i.e. pressure or osmotic pressure or both) during separation process. This creates conditions difficult for microbes to survive thereby lowering fouling potential of biofouling agents that may be present in process solutions. Particularly for zero liquid discharge applications the disclosed methods will significantly enhance energy efficiency, reduce operation and investment costs as it significantly simplifies treatment scheme.

For batch systems in prior art, challenges are experienced in achieving continuity between batches, with unintended continuous mixing of solutions at different concentrations during a batch and during change over of reservoirs as described earlier. In various embodiments, the invention enables continuous batch separation where batch reset time is eliminated in all modes of operation and un-intended mixing (semi-batch is an intended mixing) of solutions at different concentrations is either minimized or eliminated. The invention disclosed realizes a true batch process by employing following features,

1) The batch separation is achieved by passing a batch of process solution through the separation unit 100 in multiple passes with each pass performing incremental separation. In each pass the batch of process solution flows from a reservoir through the separation unit 100 where separation is performed on it and a smaller portion is returned to another reservoir. Reservoirs are used to supply process solution to and collect process solution from the separation unit 100.

2) Volume compensation techniques described enable pressurized reservoirs to maintain required operating conditions during changes in volume of pressurized fluids in the system.

3) System level solutions corresponding to batch initial and final solutions are filled or removed in parallel during operation of another batch by direct exchange method and by collection and exchange methods. Such removal and filling of batch solutions occur in reservoirs disconnected from the separation unit while the separation unit operates another batch with other reservoir(s). This allows the removal of batch end solutions and filling of batch initial solutions while continuously achieving separation in separation unit.

4) Precise continuity is maintained between consecutive passes and consecutive batches by following a reservoir switchover sequence. Further, separation is continuously achieved during this reservoir switch over sequence. Thus the process achieves continuous batch separation requiring no redundancy in separation capacity to compensate for non-active duration of process.

5) Careful hydraulic design and system operation minimize or eliminate mixing of solutions at different concentrations.

6) In some system configurations, continuous batch separation is achieved without the use of energy recovery devices (ERD). This improves process efficiency over systems using ERDs.

7) Counter current changes in process solutions for batch and semi-batch osmotic separations is achieved by novel method of stocking of intermediate pass level solutions, by transverse cascading and bleeding techniques. This counter current change is accomplished with change in process time.

Further differences between individual system configurations are explained below.

For the purpose of this invention certain definitions are used to aid with explanation of the concepts and are explained as follows.

Process solutions refer to any solution that undergoes separation in the disclosed system. Process solutions in the simplest case may be composed of a single solvent and single solute solution such as water and sodium chloride. Alternatively process solution may be composed of multiple solvents and multiple solutes such as sodium chloride, calcium acetate, benzoic acid as solutes and water, ethanol as solvents. Process solution may comprise of multiple solvents, solutes and chemical entities, all of them might be collectively referred as solution components. Hydraulic fluid refers to any fluid that is used for transmitting pressure in the systems of this invention. A process solution may also be used as hydraulic fluid. Example of hydraulic fluid that is not a process solution includes hydraulic oil. Semi-permeable membrane refers to a physical barrier that preferentially permits transport of solvent and/or solute molecules such that the composition of permeate solution is different from that of feed solution from which the permeate solution originates. When process solutions contain multiple solvents and multiple solutes, the semi-permeable membrane may exhibit different selectivity towards each solute and each solvent. In many applications of interest to the present invention, the process solutions possess osmotic pressures that result from interaction between solvent and solute molecules. Semi-permeable membrane may also be referred as membrane in the description. Depending on the semi-permeable membrane and process solutions components, two broad types of separations may be performed by the semi-permeable membrane.

Osmotic separations correspond to separations wherein the composition of permeate solution that is transported across the semi-permeable membrane from the first side to the second side is such that its osmotic pressure is different from the osmotic pressure of corresponding feed solution supplied to the separation unit. For osmotic separations, depending on the semi-permeable membrane and process solutions used, osmotic pressure of permeate solution can be greater than or less than the osmotic pressure of feed solution. Osmotic separations described in this invention may be achieved by pressure difference of process solutions (pressure driven), osmotic pressure difference (osmotically driven) or a combination of pressure and osmotic difference (pressure and osmotically driven) of process solutions across the two sides of the semi-permeable membrane. In pressure driven separations, pressure is applied on feed solution to effect separation. An example of pressure driven separation is desalination of seawater by reverse osmosis, wherein incoming saline feed solution is separated by RO membrane to produce a salt lean desalinated permeate solution with substantially reduced osmotic pressure and concentrated retentate solution with increased osmotic pressure. In osmotically driven separation, difference in osmotic pressures of process solutions on the two sides of semi-permeable membrane is used to effect separation. An example is forward osmosis desalination using electrolytic, thermolytic or switchable polarity draw solutions. Pressure assisted osmosis is an example of a combination of pressure driven and osmotically driven separations. Osmotic separation can be achieved using various categories of membranes irrespective of the size or nature of solutes the membrane is capable of rejecting as long as it alters the concentration(s) of solute(s) responsible for at least a portion of solution osmotic pressure in the permeated solution. For separations with process solution circulation on one side, this causes a change in osmotic pressure from feed to permeate and retentate solutions, while for separations with process solution circulation on both sides, this causes a change in osmotic pressure from feed to retentate and from draw to diluate draw solutions.

Non-osmotic separations correspond to separations wherein the composition of permeate solution that is transported across the semi-permeable membrane from the first side to the second side is such that its osmotic pressure is predominantly same as the osmotic pressure of corresponding feed solution supplied to the separation unit and from which the permeate solution originates. An example is separation of water with ions from milk such that ionic components are allowed to pass through the membrane while other components such as colloids and whey are rejected. Separation yields a permeate solution with nearly same ionic strength and osmotic pressure as that of feed solution. All osmotic and non-osmotic separations can be achieved using the systems and methods of this invention. Batch separation refers to separation wherein system level input solutions undergo separation to produce system level output solutions without mixing with system level solutions during separation. Semi-batch separation refers to those separations where system level solutions are mixed with process solution undergoing separations. A separation cycle refers to any separation process executed once.

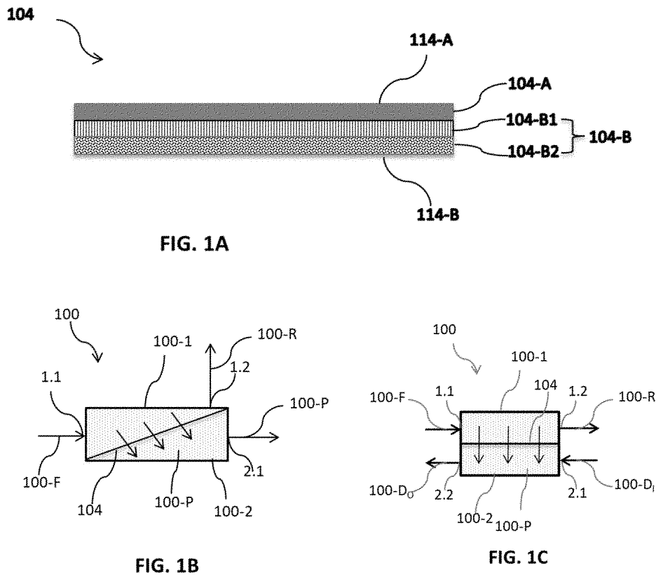

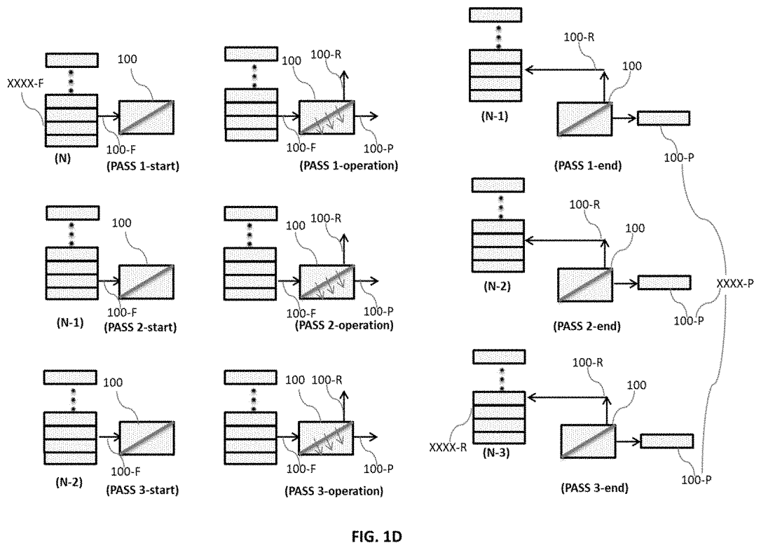

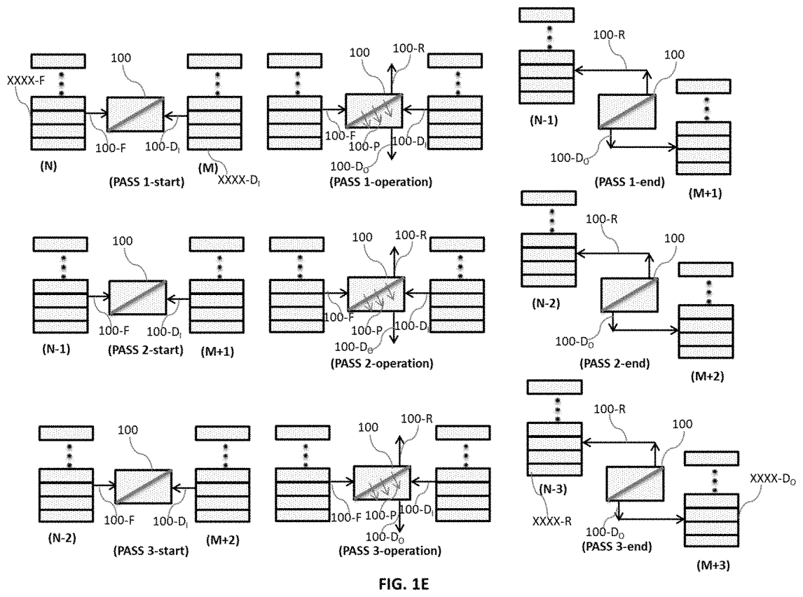

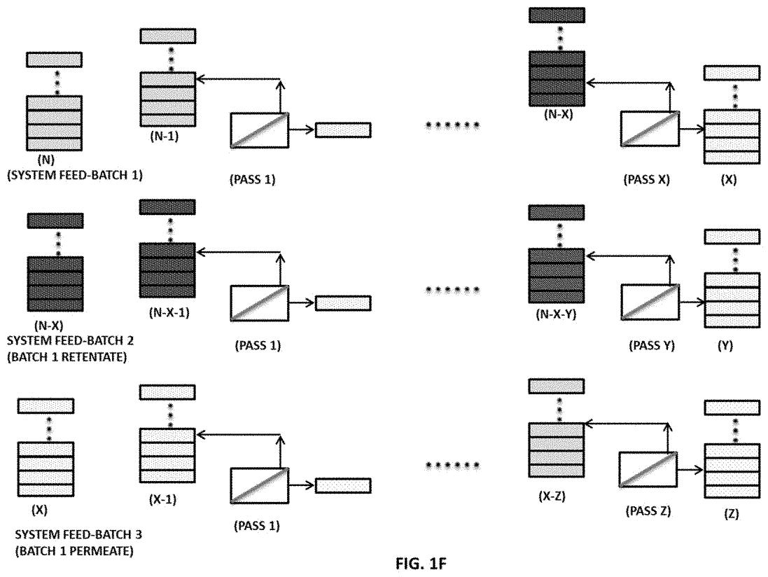

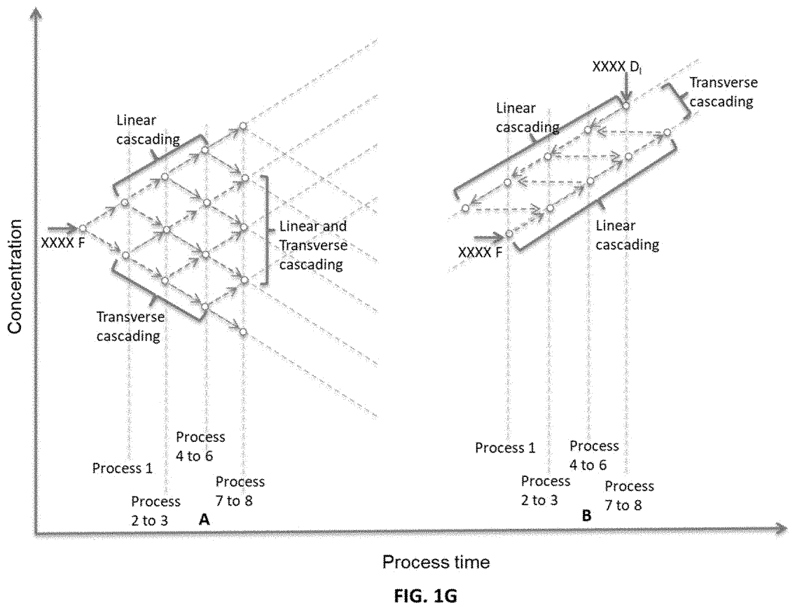

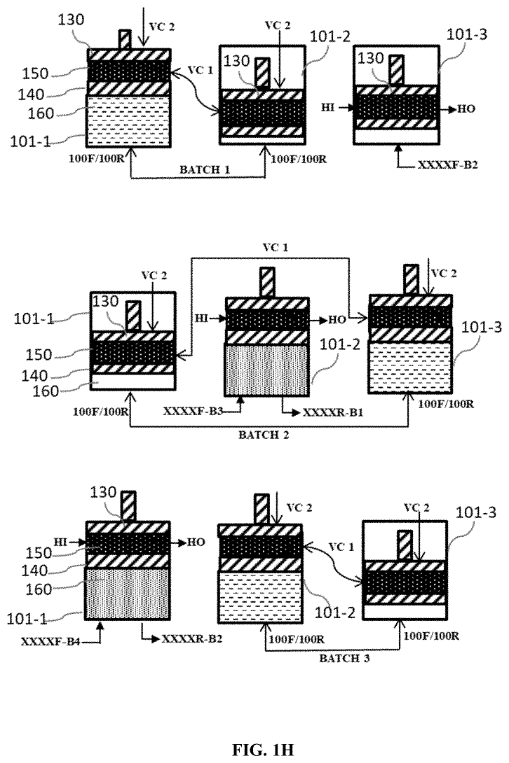

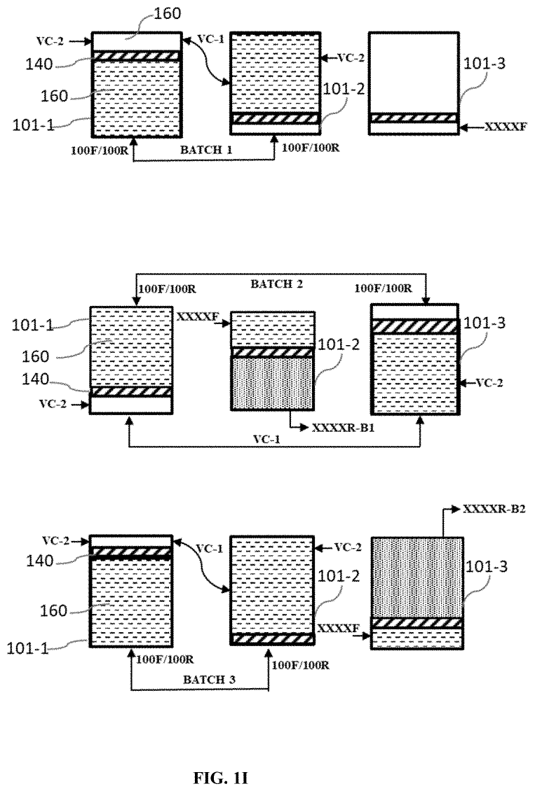

Semi-permeable membranes have two sides with which process solutions are in fluidic communication. FIG. 1A represents the cross-sectional view of a semi-permeable membrane 104 according to an embodiment of the present invention. In some embodiments, the membrane 104 may be composed of single layer 104-A. 104-A exhibits required mechanical strength to withstand process conditions. Such a membrane tends to have low permeability due to the use of a thick selective layer 104-A that exhibits lower flux of solution components through the layer. Permeability of the membrane is transport of solution components across the membrane from one face to the other face per unit facial area per unit driving force per unit time. Alternatively, the function of selectivity and mechanical strength may be divided among multiple layers. In some embodiments, the membrane 104 includes one or more second layer 104-B. In one embodiment, the membrane may be a thin film composite membrane consisting of a macro-porous layer 104-B1 and a fibrous layer 104-B2. These composite membranes offer an improved combination of permeability and mechanical strength. In yet another embodiment, the second layer may use a single support layer 104-B. Selectivity may be provided by the first layer 104-A while mechanical strength can be imparted by at least one additional non-selective support layer(s) 104-B. Two dimensions of the membranes are predominant compared to the third dimension (combined thickness of all layers). The other two dimensions comprise the two faces 114-A and 114-B of 104. 114-A refers to the face of 104 with selective layer accessible to process solution. 114-B refers to the face of support layer accessible to process solution. Any side of 104 may be used as the first side and the other side of 104 as the second side in this invention. Preferably 114-A is used as the first side while 114-B is used as the second side for separations with process solution circulation on one side. For separations with process solution circulation on both sides, any side may be used as the first side and the other side as the second side depending on the application.

The semi-permeable membrane 104 is housed in a separation unit. This separation unit facilitates transport of process solutions to and from the semi-permeable membrane and also facilitates fluidic communication between the process solution and the semi-permeable membrane. Two configurations of separation unit are possible. In the first configuration, process solution is circulated on one side of the semi-permeable membrane (e.g. reverse osmosis separation or non-osmotic separation).

FIG. 1B represents a separation unit 100 according to a first configuration used in an embodiment of the present invention. The separation unit 100 is used for performing separations wherein process solution is transported across a first side of semi-permeable membrane 104. The membrane 104 is housed in the separation unit 100. Separation unit 100 contains a first side 100-1 comprising the first side of 104 and a second side 100-2 comprising the second side of 104. Feed solution 100-F enters first side 100-1 of 100 through first stream inlet 1.1, is transported across the first side of semi-permeable membrane 104 and is in fluidic communication with the first side of 104. Permeate solution 100-P is transported from first side of 104 to second side of 104 through 104, then discharged from second side 100-2 of 100 through second stream outlet 2.2 and is in fluidic communication with the second side of 104. Retentate solution 100-R is produced from 100-F upon removal of 100-P. 100-R is discharged from first side 100-1 of 100 through first stream outlet 1.2 and is in fluidic communication with the first side of 104. Retentate solution and permeate solution are discharged by 100 as process solution outputs.

FIG. 1C represents a separation unit 100 according to a second configuration used in an embodiment of the present invention (e.g. forward osmosis separation). The separation unit 100 may be used for performing separations wherein process solution is transported across a first side and a second side of semi-permeable membrane 104. Separation unit 100 contains a first side 100-1 comprising the first side of 104 and a second side 100-2 comprising the second side of 104. Feed solution 100-F enters first side 100-1 of 100 through first stream inlet 1.1, is transported across the first side of semi-permeable membrane 104 and is in fluidic communication with the first side of 104. Permeate solution 100-P is transported from first side of 104 to second side of 104 through 104 and is in fluidic communication with the second side of 104. Retentate solution 100-R is produced from 100-F upon removal of 100-P. 100-R is discharged from first side 100-1 of 100 through first stream outlet 1.2 and is in fluidic communication with the first side of 104. Draw solution 100-D_{I} enters second side 100-2 of 100 through second stream inlet 2.1, is transported across the second side of semi-permeable membrane 104 and is in fluidic communication with the second side of 104. 100-D_{I} receives the permeate solution 100-P to produce diluate draw solution 100-D_{O}. 100-D_{O} is discharged from second side 100-2 of 100 through second stream outlet 2.2 and is in fluidic communication with the second side of 104. Retentate solution and diluate draw solution are discharged by the separation unit as process solution outputs.

Process solution associations with the separation unit 100 and the system XXXX are distinguished by prefixing these levels of association when referring them. System level process solutions refer to process solutions of the batch or semi-batch. This includes system level feed (XXXXF) and system level draw (XXXXD_{I}) that represent the initial or input solutions of a batch separation, system level retentate (XXXXR), system level permeate (XXXXP) and system level diluate draw (XXXXD_{O}) that represent the final or output solutions of a batch separation. Pass level process solutions refer to process solutions of individual passes. This includes pass level feed (100F) and pass level draw (100D_{I}) that represent the initial or input solutions of a pass separation, pass level retentate (100R), pass level permeate (100P), and pass level diluate draw (100D_{O}) that represent the final or output solutions of a pass separation. Flow of process solution through the separation unit may be referred as streams. First stream refers to the process solution that is in fluidic communication with a first side of the semi-permeable membrane. Second stream refers to the process solution that is in fluidic communication with a second side of the semi-permeable membrane. In many embodiments, process solution on feed side is used as first stream and process solution on draw side is used as second stream. The connections to separation unit 100, housing the semi-permeable membrane 104 are classified based on the connecting stream. First stream inlet 1.1 and first stream outlet 1.2 refer to inlet and outlet connections respectively of first stream with separation unit 100. Second stream inlet 2.1 and second stream outlet 2.2 refer to inlet and outlet connections respectively of second stream with separation unit 100. Fouling refers to the process of material deposition on membrane surface during separation. Process solutions and hydraulic fluids are contained in liquid containers with at least one chamber. The walls of these liquid containers form the outermost boundary surface that separates process solutions and hydraulic fluids inside the containers from the surroundings. In some embodiments, liquid containers may further be partitioned internally to form one or more chambers. Each chamber may be used as a reservoir for any fluid used in this invention. A reservoir is a chamber for holding, supplying and receiving process solutions and hydraulic fluids at required pressures. These pressures may be at or near system operating pressure for pressurized reservoirs and at or near ambient pressures for pressurized and unpressurized reservoirs. Boundary of a reservoir is defined by at least one of the boundary walls of the liquid container and the boundary walls of a chamber. Unpressurised reservoirs may be open to the surroundings and may have an open boundary on one side. A movable partition or a bladder may form the partitions inside liquid containers. These partitions are impervious to solution components and hydraulic fluids that may be present on either side of the partitions. These fluids are fluidically isolated from each other by the partition. In the preferred embodiments, the process operates in passes whereby an entire batch of process solution is transported across one side of a semi-permeable membrane and separation is performed on the batch of process solution in each pass. During a pass, process solution stored in a reservoir is transported across the membrane surface in the separation unit 100 where separation is performed as a result producing a process solution with different composition that is returned to another reservoir. The reservoir from which process solution is supplied to the separation unit is called the source reservoir and the reservoir where process solution is collected from the separation unit is called the sink reservoir. In a pass, plurality of reservoirs may be used as source reservoir(s), as sink reservoirs or for both types of reservoirs on a side. In some embodiments, two fluid regions are formed in a single physical reservoir when employing hydraulic fluids that is immiscible with process solution and in direct contact with it. System components collectively refers to all fluid handling components of the system. This includes all pumps, energy recovery devices, separation unit, membrane, conduits, reservoirs and valves. The valves (not shown in figures) are state of the art flow control devices widely used in the systems of the invention for control of flow paths of all fluids through system components.

In the methods described, separations are preferably performed in non-recirculation mode, wherein output solution of a pass is not mixed with input solution to that pass. This is achieved by using different source and sink reservoirs for pass level input and output solutions thereby keeping the solutions unmixed. In alternative recirculation mode of separation, output solution of a pass is mixed with input solution to that pass. This is achieved by using same reservoir(s) as source and sink reservoir(s) thereby mixing the solutions. Further the methods of the invention may combine both of the above processes as follows. Initially the system may be operated in non-recirculation mode while towards the end of the batch it may be operated in re-circulation mode. Such a combination is useful practically, because at the start of a batch difference between osmotic pressures of pass level input and output solutions could be high when pass recovery is high. Towards end of the batch, pass recovery is usually low and difference between osmotic pressures of input and output solutions is relatively lower. Such mixing of retentate and feed solutions when their difference in osmotic pressures is smaller leads to correspondingly smaller entropy generation, which may be acceptable for operational flexibility. Recovery of a separation process may be defined as the ratio of the quantity of permeate transported through 104 to the quantity of feed solution from which it originates. Recovery of a pass is the ratio of 100 P to 100 F corresponding to that pass. Recovery of a batch or semi-batch separation is the ratio of XXXX P to XXXX F corresponding to that separation.

The multiple pass batch separation with flow on a single side of semi-permeable membrane is illustrated in FIG. 1D by a batch separation comprising of 3 pass level separations. N units of process solution is supplied as system level feed solution for a batch. Pass 1 begins with N units of process solution supplied as pass level feed 100-F to separation unit 100. One unit of process solution is removed as pass level permeate 100-P and remaining N−1 units are collected as pass level retentate 100-R in pass 1. The N−1 units of 100-R from pass 1 are supplied as 100-F in pass 2 to 100 to produce one unit of 100-P and N−2 units of 100-R. Further the N−2 units of 100-R from pass 2 are supplied as 100-F in pass 3 to 100 to produce one unit of 100-P and N−3 units of 100-R. N−3 units of 100-R from pass 3 is removed as system level retentate solution of the batch and 3 units of 100-P from passes 1 to 3 are removed as system level permeate solution of the batch.

The multiple pass batch separation with flow on both sides of a semi-permeable membrane is illustrated in FIG. 1E by a batch separation comprising of 3 pass level separations. N units of process solution is supplied as system level feed solution XXXX-F and M units of process solution is supplied as system level draw solution XXXX-D to a system XXXX for a batch. Pass 1 begins with N units of process solution supplied as pass level feed 100-F to the first side and with M units of process solution supplied as pass level draw 100-D_{O} to the second side of separation unit 100. One unit of process solution is transferred from first side to second side as pass level permeate 100-P, remaining N−1 units on feed side are collected as pass level retentate 100-R and resulting M+1 units on draw side are collected as pass level diluate draw 100-D_{O} in pass 1. The N−1 units of 100-R and M+1 units of 100-D_{O} from pass 1 are supplied as 100-F and 100-D_{I} in pass 2 to 100 to transfer one unit of 100-P from first side to second side to produce N−2 units of 100-R and M+2 units of 100-D_{O}. Further the N−2 units of 100-R and M+2 units of 100-D_{O} from pass 2 are supplied as 100-F and 100-D_{I} in pass 3 to 100 to transfer one unit of 100-P from first side to second side to produce N−3 units of 100-R and M+3 units of 100-D_{O}. N−3 units of 100-R and M+3 units of 100-D_{O} from pass 3 are removed as system level retentate solution XXXX-R and system level diluate draw solution XXXX-D_{O} of the batch respectively.

Although the batch separations illustrated in FIG. 1D and FIG. 1E are performed with three passes, typically a minimum of two passes to a maximum of any number of passes can be performed. Special case of separation with one pass may also be performed with alternating separation duties achieved using a single pass. For example, in industrial zero liquid discharge facilities, effluent streams of different compositions are often treated. If three aqueous saline streams at different compositions are to be desalinated, a common system can be used to desalinate them all in one pass each, by switching the feed stream after every pass. Such a system has the advantage of lowering capital cost by having one combined system rather than dedicated system for each stream.

Separations described in this invention operate on the principle of cascading wherein output process solutions of a pass or a batch or semi-batch separation is used as input process solutions to another pass or another batch or semi-batch separation. In linear method of cascading, process solution output from one side of membrane 104 is used as input process solution on the same side of the same or another membrane 104. In transverse method of cascading, process solution output from one side of membrane 104 is used as input process solution on the other side of the same or another membrane 104.

This concept of cascading process solutions can be extended to batches. Cascading of system level solutions for separations with process solution circulation on a single side of semi-permeable membrane is illustrated in FIG. 1F according to yet another embodiment of the present invention. N units of process solution is supplied as system level feed XXXX-F to batch 1 of system XXXX, to produce, in X passes N-X units of process solution as system level retentate XXXX-R and X units of process solution as system level permeate XXXX-P. In a method of linear cascading of process solution, N-X units of XXXX-R from batch 1 is supplied as system level feed YYYY-F to batch 1 of another system YYYY, to produce in Y passes, N-X-Y units of process solution as system level retentate YYYY-R and Y units of process solution as system level permeate YYYY-P. In a transverse cascading method, X units of XXXX-P from batch 1 and Y units of YYYY-P from batch 2 are combined and supplied as system level feed ZZZZ-F to batch 1 of another system ZZZZ, to produce in Z passes, X-Z units of system level retentate ZZZZ-R and Z units of system level permeate ZZZZ-P. In a variant of the above method, the multiple batches may be carried out in the same physical system. The concept of cascading process solution can be extended to systems with process solution circulation on both sides, wherein XXXX-R from one batch may be used as YYYY-F in another batch by linear cascading and system level diluate draw XXXX-D_{O} from one batch may be used as system level draw ZZZZ-D_{I} in another batch by linear cascading. In FIG. 1F, cascading between passes was also achieved when pass level retentate 100-R from the last pass of a batch 1 of system XXXX was removed as system level retentate (XXXX-R) and supplied as system level feed YYYY-F to batch 1 of system YYYY which was used as pass level feed 100-F for first pass. Thus output process solutions of a pass or a batch may be used as input process solutions to another pass or another batch.

FIG. 1G illustrates the concept of cascading methods for pass level and for batch or semi-batch levels (a process). Y-axis represents concentration of species of interest while X-axis represents process time. For a system with flow across single side of membrane 104 changes in concentration of process solutions is shown in FIG. 1G-A. Each arrow represents change in concentration from input to output process solution for a process. All concentration changes along lines with a positive slope (i.e. at positive angle to x-axis) are achieved by linear cascading while all concentration changes along the lines with a negative slope (i.e. at negative angle to x-axis) are achieved by transverse cascading. This is based on the premise that concentration of species of interest decrease in the permeate and increase in retentate. Opposite can also be true depending on process solution composition and membranes used. For a system with flow across the first and second side of membrane 104, changes in concentration of process solutions is shown in FIG. 1G-B. All concentration changes along both the lines are achieved by linear cascading while all concentration changes across the lines are achieved by transverse cascading. This is based on the premise that concentration of species responsible for osmotic pressure of process solutions are indicated.

FIGS. 1H and 1I illustrate the concept of volume compensation, parallel removal of XXXXR and filling of XXXXF for continuous separations using pressurized reservoirs. Each batch may be performed using three reservoirs as described in Table 1 below. FIG. 1H illustrates 3 batch operations using piston pressurized reservoirs with hydraulic fluid assistance. During each pass from source reservoir(s) to sink reservoir(s), volume compensation 1 is performed by displacement of hydraulic fluid from sink reservoir(s) to source reservoir(s). Volume compensation 2 is performed by movement of piston 130 in the reservoir(s). During batch 1, XXXXF for batch 2 is filled in the bottom reservoir 120-2 of liquid container 101-3 prior to beginning of batch 2. During batch 2, system level retentate XXXXR of batch 1 is removed by addition hydraulic fluid HI to the top chamber. This is followed by addition of XXXXF for batch 3 in the bottom chamber while simultaneously displacing excess hydraulic fluid from top chamber as HO prior to beginning of batch 3. Alternatively, movement of 130 and 140 can accomplish removal of XXXXR and filling of XXXXF. Similarly during operation of batch 3, XXXXR of batch 2 and XXXXF of batch 4 are exchanged. FIG. 11 illustrates 3 batch operations using indirect hydraulically pressurized reservoirs with hydraulic fluid assistance. During each pass from source reservoir(s) to sink reservoir(s), volume compensation 1 is performed by displacement of hydraulic fluid from sink reservoir(s) to source reservoir(s). Volume compensation 2 is performed by addition or removal of hydraulic fluid 150 to reservoir(s). Further XXXXF is used as 150. This has the advantage of filling XXXXF and removing XXXXR simultaneously. Additional it provides operation flexibility as follows. During batch 1, XXXXF is filled in reservoir 120-2 of liquid container 101-3 prior to beginning of batch 2 where it is used as 150. XXXXF in reservoir 120-1 of 101-1, which was used as 150 in batch 1 is used as system level feed in batch 2. During batch 2, XXXXR of batch 1 is removed from 120-2 of 101-2 by addition XXXXF to 120-1 of 101-2. Batch 3 uses XXXXF in 120-2 of 101-1 as system level feed which was used 150 in batch 2. XXXXF is filled in 120-2 of 101-3 to displace XXXXR of batch 2 from 120-1 of 101-3.

FIG. 2A-2C illustrate unpressurized liquid containers according to certain embodiments of the present invention. Pressure of process solution 160 in these reservoirs is equilibrated with ambient or surrounding pressure. Reservoir in FIG. 2A is open on top and may be used for non-critical applications such as industrial wastewater desalination. Reservoir in FIG. 2B is closed and isolated from surrounding environment with the provision to equilibrate pressure inside the liquid container with the surrounding pressure. Such liquid containers may be used for critical applications like potable water, sanitary and pharmaceutical separations. Since the volume of process solution in the reservoir is allowed to vary, no additional techniques are required to perform volume compensations 1 and 2. Reservoir in FIG. 2C comprises of at least one movable partition 140. It is divided into chambers 120-1 and 120-2 separated by movable partition(s). Each chamber in such liquid containers represents one reservoir. Further this liquid container is used to represent all un-pressurized liquid container variants in general embodiments. All liquid containers used for pressurized systems may also be used as unpressurized liquid containers and operated without pressure.

FIG. 2D illustrates a piston pressurized reservoir according to certain embodiments of the present invention. A movable piston 130 is used to apply pressure on process solution 160. The piston may be used for regulating process solution pressure during operation. Further the piston 130 may be moved up or moved down to compensate for volume changes without pressurizing the solution. This includes volume compensations 1 and 2. The outer boundary of liquid container is variable.

FIG. 2E-2F illustrates indirect hydraulically and pneumatically pressurized reservoir according to certain embodiments of the present invention. Liquid container in FIG. 2E comprises two chambers 120-1 and 120-2 separated by a movable partition 140. Each chamber represents one reservoir. One reservoir contains the process solution 160 while the other reservoir contains a hydraulic fluid 150 used to regulate system pressure. The outer boundary of liquid container is fixed and combined volume of fluid in both reservoirs is constant. The hydraulic fluid may fill or empty its reservoir without changing system pressure to compensate for volume changes of process solution. Further the hydraulic fluid may pressurize or depressurize the reservoir, to regulate pressure of process solution in adjoining reservoir. The hydraulic fluid 150 may be a process solution 160 (feed, retentate or permeate), in which case, it may also be processed in the same separation system 100. In such instance, process solution 160 in another chamber may be used as hydraulic fluid. Any liquid may be used as hydraulic fluid. Alternatively a gas or air may also be used. Further the hydraulic fluid and process fluid may be in either of the chambers. Liquid container in FIG. 2F contains three chambers 120-1, 120-2 and 120-3, each chamber separated by movable partition 140. Each chamber represents a reservoir. Hydraulic fluid 150 or process solution 160 may be filled in any of the reservoirs. Of the three reservoirs two may contain process solution and one may contain hydraulic fluid. Thus a single hydraulic fluid pressurized liquid container with three reservoirs may replace at least two pressurized (e.g. piston/hydraulic) liquid containers with a single reservoir containing process solution. Additionally if process solution is used as a hydraulic fluid, then the same liquid container with three reservoirs may replace three pressurized liquid containers with a single reservoir containing process solution. Further variations of this liquid container configuration can include more than three reservoirs.

FIG. 2G-2H illustrates piston pressurized reservoir with hydraulic fluid assistance according to certain embodiments of the present invention. The liquid container in FIG. 2G contains two chambers 120-1 and 120-2 separated by a movable partition 140. Each chamber represents a reservoir with process solution 160 in one reservoir and hydraulic fluid 150 in the other reservoir. In addition a piston 130 is provided on one end of the liquid container. 130 may move during a process to compensate for volume changes and/or to regulate system pressure. The outer boundary of liquid container is variable. As a result combined fluid volume of both reservoirs may be varied. 150 may be used to perform volume compensation 1 during operation to reduce movement of 130. Process solution 160 may be used as hydraulic fluid 150. Here it is possible to achieve batch mode of operation without recirculation using a single liquid container thereby minimizing liquid container requirements. Further variations of this liquid container configuration may include more than two chambers containing process solutions 160, for e.g. three chambers with 160. Liquid container in FIG. 2H, comprises a single physical chamber divided into two regions by the use of a compatible hydraulic fluid 150 in direct contact with process solution 160. The single chamber represents one reservoir. 150 may be used to perform volume compensation 1 during operation. This reduces required piston movement relative to when the piston is used for VC1, VC2 and for regulation of operating pressure.

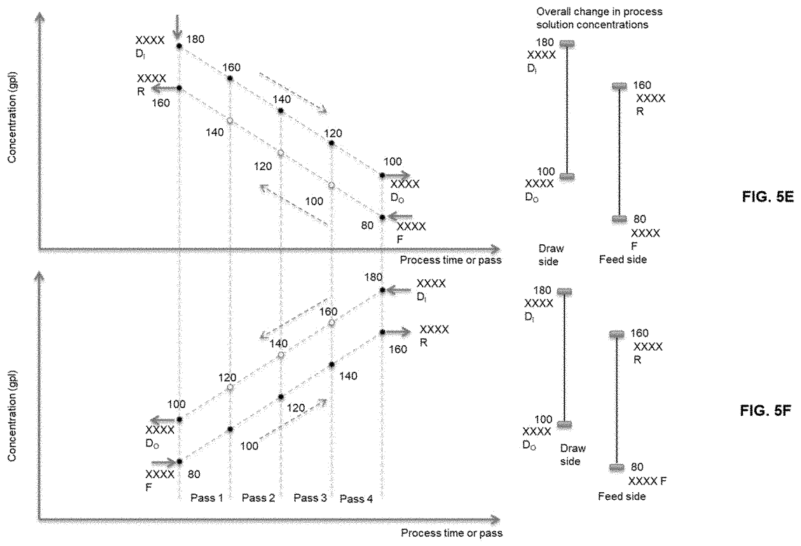

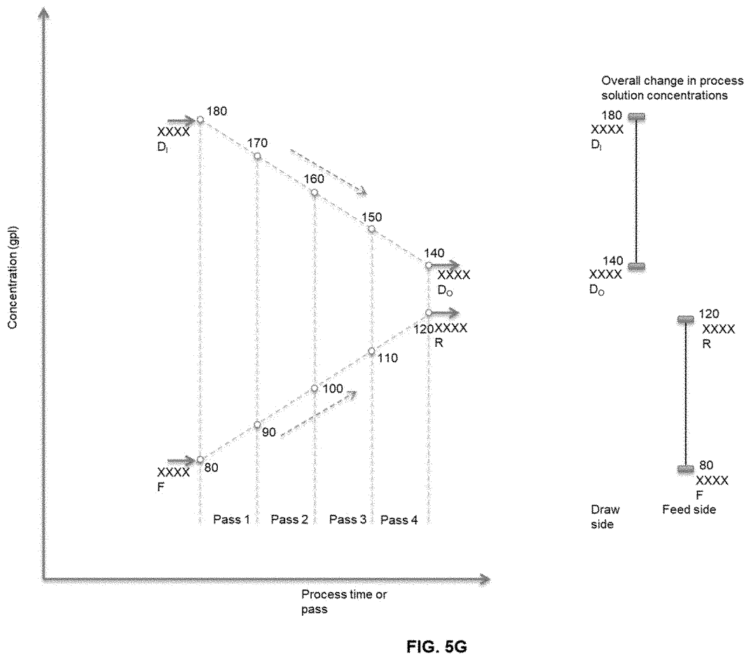

FIG. 21-2J illustrate a direct hydraulically and pneumatically pressurized reservoir according to certain embodiments of the present invention. In FIG. 21 the liquid container contains one chamber. This reservoir is separated into two regions by the volume occupied by process solution 160 and hydraulic fluid 150. Here the hydraulic fluid is immiscible with the process solution. Depending upon the relative density the position of hydraulic fluid and process solution in the liquid containers may be determined. Alternatively a gas or air may be used to pneumatically pressurize the contained process solution. Liquid container in FIG. 2J is similar to FIG. 21 and in addition contains at least one moving partition 140 and at least two chambers each of which represents one reservoir. Hydraulic fluid 150 in both types of liquid containers may be used for volume compensations 1 and 2 and for regulating pressure of process solution 160 during operation.

FIG. 2K illustrates a direct feed pressurized reservoir according to certain embodiments of the present invention. The liquid container is fully occupied by process solution 160 and the system is pressurized directly by feed solution added to the system.

FIG. 2L represents all pressurized feed reservoirs according to certain embodiments of the present invention for describing operation of systems using pressurized reservoirs.

FIG. 2M-2P illustrate unpressurized and hydraulically pressurized reservoirs with bladder(s). These liquid containers comprise flexible bladders 180. The bladder 180 can expand and contract and may also be stretchable. The bladder 180 separates the liquid inside it from the liquid outside. Bladders offer a greater ease of operation compared to movable partition and may be used in unpressurized systems as well. Thus these reservoirs may be operated with or without pressure. Reservoir in FIG. 2M comprises a single bladder inside a liquid container. Either of the fluid inside the bladder or outside it may be used as hydraulic fluid to regulate the system operating pressure. In the preferred configuration, hydraulic fluid 150 is used outside the bladder since it is easier to empty the bladder compared to emptying the chamber outside the bladder. This feature is important to minimize mixing of process solutions at different concentrations. Reservoir in FIG. 2N comprises a single bladder inside a liquid container similar to reservoir in FIG. 2M. However the chamber outside the bladder may contain a hydraulic fluid 150 in direct contact with process solution 160. In this arrangement, hydraulic fluid 150 facilitates with emptying the outside chamber completely thereby permitting the use of process solution 160 on the inside and outside chambers. Liquid container in FIG. 2O comprises multiple bladders (in the configuration shown, two bladders) inside a liquid container. In the configuration with two bladders 180, process solution may be used in both the bladders 180 while hydraulic fluid 150 may be used in the chamber outside the bladders. Process solution 160 (e.g. permeate) may also be used as hydraulic fluid in the outside chamber. Liquid container in FIG. 2P comprises of multiple bladders 180 (in the configuration shown, three bladders are used). Compared to the liquid container in FIG. 2O, which also uses multiple bladders, the bladders 180 in this liquid container have two connections. This makes it easier to replace the process solution at the end of a batch in a single direction flow. Further it also enables higher packing density of bladders in a single liquid container. This means many more chambers can be formed in a single liquid container. This feature is useful when operating with separation processes where multiple concentrations of solutions need to be stored (e.g. forward osmosis). The fluid in the chamber outside the bladders can be hydraulic fluid 150 or process solution 160.

All liquid containers depicted in FIG. 2A-2P are shown to be oriented vertically. The same liquid containers (except for the open unpressurized liquid containers FIGS. 2A and 2C) may be oriented in any other orientation and still perform the described function.

Working systems of the invention integrating various system components are represented in FIG. 3A to FIG. 3I. All systems described in FIG. 3A to FIG. 3I are capable of performing osmotic and non-osmotic pressure driven separations. System in FIG. 3J is capable of performing osmotically driven separations. Any number and combination of liquid containers in FIG. 2A to 2P may be used. Semi-permeable membrane 104 used in these systems may be one of reverse osmosis, nano-filtration, ultrafiltration and micro filtration membranes. Further depending on the solution and the separation of components required, micro filtration membrane may be used for high-pressure osmotic separations and nano-filtration or even reverse osmosis membranes may be used for low-pressure non-osmotic separations. For pressure driven separation, pressure on process solution is applied using one or more system components collectively referred to as pressurizing unit. These components include high pressure pumps 503-1 and 503-2, Energy recovery device (ERD) 501, booster pump 502 and piston 130 of piston pressurized liquid containers. ERD 501 refers to any device for recovering the energy released upon depressurizing a pressurized stream and utilizing the recovered energy to pressurize another stream. These devices include pressure exchanger, Pelton wheel, turbine based ERD, recuperator, turbocharger, reverse running pump. According to the ERD technology used, components of the pressurizing unit may change and modification of conduit connections between system components may be made to accomplish methods described herein. Circulation pumps 504 and 505 are used for transporting process solution across the first and second sides of 104 and other system components.

The invention may have variations in the method of operation different from those described below, while employing at least a part of the key features of the invention. These variations include a different method of cascading separations and different sequence of flow between reservoirs than described. Methods of separation described for the systems typically employ single source reservoir and single sink reservoir for each pass. The same systems and methods may use a plurality of reservoirs as source and/or sink reservoirs in a pass. The system may also be operated in semi-batch mode by addition of system level process solution (e.g. 1000-F) to the reservoirs. All batch separations described in this invention may be converted into semi-batch separations by addition of system level process solution(s) and mixing with process solution(s) undergoing separation in a batch.

FIG. 3A and FIG. 3B represent general embodiments for systems with process solution flow across a single side of membrane 104. The specific embodiments in FIG. 3C to FIG. 3I that follow are derived from these general embodiments. Many more specific embodiments may be derived from the general embodiments. These include embodiments with following variations, different quantity and types of liquid containers, different quantity of reservoirs per liquid container, use of different process solutions as hydraulic fluid, use of different ERD technology with corresponding modifications to pressurizing unit, greater or fewer headers to convey process solutions and hydraulic fluids and different flow paths for process solution through system components. Separation unit 100 shown in these systems may represent a single or a plurality of 100 units, such as an array combined to perform described methods. It shall be understood that these variations are included in all embodiments and methods described.

FIG. 3A, represents a general system 1000 for performing pressure driven batch and semi-batch separation using one or more unpressurized liquid containers 101 comprising one or more reservoirs (120-1, 120-2). During operation of 1000, process solution 160 is supplied from one or more source reservoirs via their discharge connections 1.4. A circulation pump 504 is used to transport 160 from the source reservoir(s) across one side of membrane 104 to sink reservoir(s) via conduit junction 1.5 and inlet connections 1.3 of sink reservoirs and through other system components. During separation, composition of 160 changes from 1.1 to 1.2 of 100. 160 entering first stream inlet 1.1 of separation unit 100 is referred to pass level feed solution 100F and 160 exiting first stream outlet 1.2 of 100 is referred to as pass level retentate solution 100R. A portion of 160 permeated through 104 may be referred to as pass level permeate or filtrate 100-P that exits 100 through connection 2.1. For pressure driven separations operating at high pressures, outlet from 504 may be supplied to low pressure inlet 501-3 of an energy recovery device (ERD) 501. 501 recovers energy from depressurization of pass level retentate 100R and utilizes it to pressurize pass level feed 100F. Pressurized 100F emerges from high pressure outlet 501-2 and is sent to 1.1 of 100. 100R emerges from first stream outlet 1.2 of 100 and is sent to high pressure inlet 501-1 of 501. Depressurized 100R emerges from low pressure outlet 501-4 of 501 and is sent to one or more sink reservoirs via their inlet connections 1.3.

FIG. 3B represents a general system 1100 for performing pressure driven batch and semi-batch separation using pressurized reservoirs. 1100 comprises of at least one feed side liquid container 101 with one or more reservoirs (120-1, 120-2). During operation of 1100, process solution 160 is supplied from one or more source reservoirs via their discharge connections 1.4 and conduit junction 1.6. A circulation pump 504 is used to transport 160 from the source reservoir(s) across one side of membrane 104 to sink reservoir(s) via conduit junction 1.5 and inlet connections 1.3 of sink reservoirs and through other system components. During separation, composition of 160 changes from 1.1 to 1.2 of 100. 160 entering first stream inlet 1.1 of separation unit 100 is referred to pass level feed solution 100F and 160 exiting first stream outlet 1.2 of 100 is referred to as pass level retentate solution 100R. A portion of 160 permeated through 104 may be referred to as pass level permeate or filtrate 100-P that exits 100 through connection 2.1. An energy recovery device 501 may be used to recover pressure energy from system level retentate 1100-R into system level feed 1100-F when exchanging these solutions by direct exchange method (FIG. 4F). High pressure retentate 100-R enters ERD 501 at high pressure inlet 501-1 transfers energy to low pressure feed 100-F that enters ERD 501 at low pressure inlet 501-3. 100-F is pressurized to operating pressure and exits ERD 501 from high pressure outlet 501-2 while 100-R is depressurized to sink reservoir pressure and exits ERD 501 from low pressure outlet 501-4. A booster pump 502 may be used in series with ERD 501 after high pressure outlet 501-2 to make up for irreversibilities encountered in energy recovery and during process solution flow through 100 and other system components.

The method of separation in both systems involves certain essential operations as follows. Towards the end of one pass and prior to the start of a next pass, a reservoir switchover sequence (FIG. 4E) is initiated whereby the connection 1.4 to source reservoir(s) and connection 1.3 to sink reservoir(s) are changed from the reservoirs corresponding to the last pass to the reservoirs of upcoming pass. Importantly during this switchover sequence, separation continues in 100 un-interrupted. Further the system design ensures minimal unintended mixing of solutions corresponding to different passes. Continuity between separation cycles is achieved by removing XXXXR from a previous batch or semi-batch and supplying XXXXF to an upcoming batch or semi-batch while achieving uninterrupted separation at 100 as follows. Parallel to a separation process, system level feed solution XXXXF corresponding to a subsequent separation is filled in parallel in the one or more reservoir(s). Towards the end of a batch or semi-batch separation, XXXXR may be removed either by a direct exchange method (FIG. 4F and FIG. 4H) or a by collection and exchange method (FIG. 4G and FIG. 4H). For all reservoirs, volume compensation (FIG. 4D) is continuously performed during a separation process to adapt to changing volumes of process solution contained in system components.

Further in the methods of separation in both systems 1000 and 1100, 100-P may either be removed as system level permeate solution XXXX-P or be collected in a feed side reservoir and used as 100-F to achieve further separation by transverse cascading method in the same batch until required system level permeate 1100-P is produced. Similarly 100-R may be removed as XXXX-R or collected in a reservoir and supplied as 100-F for a subsequent pass to achieve further separation by linear cascading method in the same batch until required system level retentate XXXX-R is produced. The subsequent pass may be the next pass or a non-consecutive pass. For instance, when 100-P is removed as XXXX-P without collection in a reservoir, 100-R collected in previous pass may be used as 100-F in next pass. Alternatively if 100P is collected in a reservoir and supplied as 100F in next pass, then 100R may be used in a subsequent pass.

Further depending on the ERD technology used in 1000 and 1100 (e.g. isobaric pressure exchanger) a high pressure pump 503-1 may optionally be used to pressurize that quantity of stream entering 501-3 which is in excess to the stream entering 501-1. This excess quantity is typically equal to the permeate solution removed in a pass, batch or semi-batch and in addition some lubrication or mixing flow experienced in 501. In some embodiments when hydraulic fluid 150 is used, a separate pressurizing unit may be used for 150 different from the unit used for 160. In addition a pressure reducing valve 530 may be used to depressurize process solution bypassing 501. These individual devices 501, 502 and 503-1 shown in FIG. 3B may be combined into fewer or even into a single device to deliver the intended performance. An example is an integrated pressure exchanger with high pressure pump in a single device supplied by certain vendors. In such a device 501 and 503-1 are be combined. Another example is a turbocharger which does not require a separate booster pump 502. For un-pressurized or low pressure systems, the components 501, 502 and 503 may not be required and may not be present in the system.

Table 1 depicts a general multi pass separation for a system with three reservoirs applicable to embodiments in FIG. 3A to FIG. 3J. These operations are performed for reservoirs on both sides for system 2700 in FIG. 3J. Prior to initiating batch separation, system level solutions are filled in reservoir 3. Pass 1 of batch 1 starts by using reservoir 3 as source reservoir to supply process solution to separation unit 100 and by using reservoir 1 as sink reservoir to receive process solution from 100. Towards the end of pass 1 reservoir switchover sequence is initiated, where the source reservoir changes from reservoir 3 to reservoir 1 and sink reservoir changes from reservoir 1 to reservoir 2. Pass 2 is operated by supplying process solution from source reservoir 1 to 100 and by collecting process solution from 100 in sink reservoir 2. Towards the end of pass 2, reservoir switchover sequence explained above is performed. Separation continues in further passes until pass N where batch end condition is met. Batch end condition may be defined by a variety of separation parameters such as total recovery, concentration of certain solution components, operating and osmotic pressures. In pass N (when N is odd) a source reservoir 2, supplies process solution to 100 while process solution from 100 is removed from the system as system level solution without the use of a sink reservoir by direct exchange method. Switchover sequence is executed between every pass and between every batch or semi-batch. Different methods of purposing reservoirs may be used for performing separation and for parallel filling of system level solutions XXXXF and XXXXD_{I}. In a first method of operation, one or more reservoir 3 may be used to receive system level solution(s) for a subsequent batch while other reservoirs are used in a batch. In the subsequent batch reservoir 3 shall be used as source reservoir in first pass and supply pass level solutions for the first pass. The reservoir 3 shall continue to be used in further passes in that batch while simultaneously another reservoir 2 is filled with system level solutions for subsequent batch. In a second method of operation, reservoir 3 shall be used as source reservoir of first pass only. Subsequently it shall be disconnected from separation unit 100 and get filled with system level solution(s) for subsequent batch while other reservoirs shall be used as reservoirs beyond the first pass. At all times reservoir 3 shall continuously receive system level solution(s) when operating as source reservoir for first pass as well as when isolated from separation unit 100. Thus in the second method one reservoir is dedicated to receiving system level solution(s) and operating as supply reservoir for the first pass only while the other reservoirs are used as source and sink reservoirs in subsequent passes. Since the process solution volume decreases from first to last pass of a batch, the capacities of three reservoirs shall correspond to process solution volumes of corresponding pass. Thus the second method makes efficient use of reservoir capacities and is the preferred method. The operations shown for one batch or semi-batch may be repeated for any number of further separation cycles to accomplish continuous batch and semi-batch separations. In certain variations of the method, it may be desirable to include automated cleaning steps during which separation of process solution is not performed, time duration of which shall contribute to non-productive duration of the system. However they may be useful to maintain the system performance in certain applications. Linear cascading on first side of 104 has been followed in this example. Alternatively, the method may be modified to follow transverse cascading or both types of cascading between passes. Parallel filling of system level solutions for next batch is accomplished such that system level solution quantity required for next batch is filled before its requirement in next batch.

TABLE 1
Exemplary illustration of continuous batch or semi-batch separation achieved in passes.

| | | On first side | | | On second side | | |
|---|---|---|---|---|---|---|---|
| | Process | Reservoir | Reservoir | Reservoir | Reservoir | Reservoir | Reservoir |
| Step | description | 1 | 2 | 3 | 1 | 2 | 3 |
| | System | Empty | Empty | XXXXF | Empty | Empty | XXXXD_{I} |
| | start | | | for | | | for |
| | | | | batch 1 | | | batch 1 |
| | Batch or | | | | | | |
| | semi-batch | | | | | | |
| | 1 | | | | | | |
| 1 | Pass 1 | Receiving | Empty | Supplying | Receiving | Empty | Supplying |
| | processing | pass | | XXXXF | pass 1 | | XXXXD_{I} |
| | | 1 100R | | as pass | 100Dₒ | | as pass 1 |
| | | | | 1 100F | | | 100D_{I} |
| 2 | Switchover | | | | | | |
| | sequence | | | | | | |
| 3 | Pass 2 | Supplying | Receiving | Receiving | Supplying | Receiving | Receiving |
| | processing | pass | pass 2 | XXXXF | pass 1 | pass 2 | XXXXD_{I} |
| | | 1 100R | 100R | | 100Dₒ as | 100Dₒ | |
| | | as pass | | | pass 2 | | |
| | | 2 100F | | | 100D_{I} | | |
| 4 | Switchover | | | | | | |
| | sequence | | | | | | |
| X-4 | Switchover | | | | | | |
| | sequence | | | | | | |
| X-3 | Pass N-1 | Supplying | Receiving | Receiving | Supplying | Receiving | Receiving |
| | processing | pass | pass N- | XXXXF | pass N-2 | pass | XXXXD_{I} |
| | | N-2 | 1 100R | | 100Dₒ as | N-1 | |
| | | 100R as | | | pass N-1 | 100Dₒ | |
| | | pass N- | | | 100D_{I} | | |
| | | 1 100F | | | | | |
| X-2 | Switchover | | | | | | |
| | sequence | | | | | | |
| X-1 | Pass N | Empty | Supplying | Receiving | Empty | Supplying | Receiving |
| | processing | | pass N- | XXXXF | | pass | XXXXD_{I} |
| | | | 1 100R | | | N-1 | |
| | | | as pass | | | 100Dₒ | |
| | | | N 100F | | | as pass | |
| | | | | | | N 100D_{I} | |
| X | Switchover | | | | | | |
| | sequence | | | | | | |

For general embodiments in figures, FIG. 3A and FIG. 3B and the individual embodiments from FIG. 3C to FIG. 3J, conduits in hydraulic circuit on first and second sides of systems are segmented as detailed in Table 2. In the following embodiments. 1.6 and 2.6 refer to the junction between discharge branch conduits of reservoir(s) and supply header on the first and second sides of a system respectively. 1.5 and 2.5 refer to the junction between return branch conduits of reservoir(s) and return header on the first and second sides of a system respectively. The labels 1.6 and 1.5 on first side and 2.6 and 2.5 on second side represent one junction between a header conduit and corresponding inlet or discharge conduit for one reservoir. When plurality of reservoirs is used, plurality of such junctions will exist and these labels represent each of those junction points for every reservoir. Their multiple labeling in the corresponding figures indicates those points. Similarly labels 1.4 and 1.3 and labels 2.4 and 2.3 for reservoirs on first and second sides respectively may be used multiple times to indicate discharge and inlet connections for every reservoir.

TABLE 2
Conduit segments in hydraulic circuit of systems in embodiments.

| | On first side | | On second side | | |
|---|---|---|---|---|---|
| | From | To | From | To | Segment |
| Conduit segment | label | label | label | label | label |
| Discharge branch conduits | 1.4 | 1.6 | 2.4 | 2.6 | Not |
| of reservoirs on the first | | | | | labeled |
| and second sides. | | | | | |
| First and second stream | 1.6 | 1.1 | 2.6 | 2.1 | Not |
| supply header conduits | | | | | labeled |
| First and second stream | 1.2 | 1.5 | 2.2 | 2.5 | Not |
| return header conduits | | | | | labeled |
| Return branch conduits of | 1.5 | 1.3 | 2.5 | 2.3 | Not |
| reservoirs on the first and | | | | | labeled |
| second sides. | | | | | |
| Hydraulic fluid re- | 1.4 of | 1.3 of | N/A | N/A | 201 |
| distribution header | hydraulic | hydraulic | | | |
| | fluid | fluid | | | |
| | reservoirs | reservoirs | | | |
| Pass level feed supply | 1.6 | 1.1 | N/A | N/A | 202 |
| header | | | | | |
| Pass level retentate return | 1.2 | 1.5 | N/A | N/A | 203 |
| header | | | | | |
| System level pressurized | 503-1 | 1.3 | N/A | N/A | 204 |
| feed header | | | | | |
| System level un- | Origin of | 1.3 | N/A | N/A | 205 |
| pressurized feed supply | XXXXF | | | | |
| header | | | | | |
| System level | 1.4 | Removal of | N/A | N/A | 206 |
| unpressurized retentate | | XXXXR | | | |
| header | | | | | |
| Hydraulic fluid | 503-2 | 1.3 | N/A | N/A | 207 |
| pressurized inlet header | | | | | |
| Hydraulic fluid | Origin of | 1.3 | N/A | N/A | 208 |
| unpressurized inlet header | hydraulic | | | | |
| | fluid | | | | |
| Hydraulic fluid | 1.4 of | Removal of | N/A | N/A | 209 |
| unpressurized inlet and | hydraulic | hydraulic | | | |
| outlet header | fluid | fluid | | | |
| | reservoirs | | | | |
| Pass level draw supply | N/A | N/A | 2.6 | 2.1 | 212 |
| header | | | | | |
| Pass level draw return | N/A | N/A | 2.2 | 2.5 | 213 |
| header | | | | | |
| System level un- | N/A | N/A | Origin of | 2.3 | 215 |
| pressurized draw supply | | | XXXXD_{I} | | |
| header | | | | | |

In the following embodiments, different segments of hydraulic fluid have the following connections with reservoirs and purposes. Every reservoir containing hydraulic fluid is connected to 201 for distribution of hydraulic fluid 150 between reservoirs, 207 for receiving 150 at system operating pressure, 208 for receiving 150 at near ambient pressures and to 209 for addition and removal of 150 at near ambient pressures required by collection and exchange method. Every reservoir on first side containing process solution is connected to 202 for supplying 100F to 100, to 203 for receiving 100R from 100, 204 for receiving XXXXF at system operating pressure, 205 for receiving XXXXF at near ambient pressure and 206 for removal of XXXXR at near ambient pressures in collection and exchange method. Every reservoir on second side containing process solution for separation is connected to 212 for supplying 100D_{I}, to 213 for supplying 100D_{O}, and 215 for supplying XXXXD_{I}

FIG. 3C represents a system 2000 for performing batch and semi-batch pressure driven separation according to an embodiment of the present invention. Any liquid container in FIG. 2A-2P may be used as an unpressurized reservoir in 2000. It consists of three liquid containers, 101-1 with one reservoir, 101-2 with one reservoir and 101-3 with two reservoir 120-1 and 120-2. Further reservoir in 101-1 is open to surroundings while reservoirs in 101-2 and 101-3 are closed. However the pressure inside all reservoirs is equilibrated with surrounding pressure. Feed solution 100F may be transported from a source reservoir on feed side to first stream inlet 1.1 of separation unit 100. Retentate solution 100R may be discharged from first stream outlet 1.2 of 100 to a feed side sink reservoir. The feed stream 100 F is circulated using circulation pump 504. Energy recovery device (ERD) 501 is used to recover energy from retentate 100 R to pressurize feed stream 100 F as described earlier. When certain ERD technologies are used high pressure pump 503 may not be required.

An exemplary separation process in non-recirculation method is depicted in Table 1 as explained earlier. For the system 2000 shown in FIG. 3C, reservoir 1, reservoir 2 and reservoir 3 may be assumed to be represented by chamber 120-2 of liquid container 101-3, the single chamber in 101-2 and the single chamber in 101-1 respectively.

FIG. 3D represents system 2100 consists of three pressurized reservoirs 101-1, 101-2 and 101-3. The reservoirs are pressurized by fully filling them with process solution and by continuous feed addition during operation. The system is operated in recirculation mode wherein source and sink reservoirs are the same. The system operating pressure is regulated by feed addition through high pressure pump 503-1. 2100-F corresponding to a subsequent batch is filled at near ambient pressures in an empty reservoir in parallel during the operation of a batch. Once the desired process end condition is met, the reservoir in service can be isolated from 100 while another reservoir with feed solution for next batch is connected to 100. System 2100 continues separation while the disconnected reservoir is emptied of system level retentate 2100 R of previous batch and refilled with 2100 F for new batch at near ambient pressure. For continuous separation in recirculation mode of operation, two reservoirs are sufficient to achieve continuous semi-batch separation.

FIG. 3E represents system 2200 with the capability to use indirect hydraulic fluid pressurized, piston pressurized with hydraulic fluid assistance and direct hydraulic fluid pressurized liquid containers of FIG. 2A-2P. The system configuration and operation using liquid containers in FIGS. 2E, 2F and 2M to 2P is very similar to systems using reservoirs 2D, 2G and 2H. When using reservoirs 2E, 2F and 2M to 2P the outer boundaries are rigid. In order to compensate for change in process solution volume, internal distribution of hydraulic fluid 150/160 between reservoirs and addition of external hydraulic fluid to the reservoirs may be used. Volume compensation 1 and 2 are performed depending on the type of liquid containers used. In an exemplary scenario below, system 2200 using reservoirs 2G and 2H with moving piston 130 are used. The same process can be extended to reservoir 2D with piston 130 and reservoirs 2E, 2F and 2M to 2P without piston 130 by following corresponding volume compensation methods (FIG. 4D and Table 3).

An exemplary separation process in non-recirculation method is depicted in Table 1 as explained earlier. For the system 2200 shown in FIG. 3E, reservoir 1, reservoir 2 and reservoir 3 may be assumed to be represented by reservoirs 120-2 of 101-1, 120-2 of 101-2 and 120-2 of 101-3 respectively. A pass may be operated using reservoirs in 101-1 and 101-3 as follows. At the start of the pass, 120-1 of 101-1 may be empty while 120-2 of 101-1 may contain process solution and 120-1 of 101-3 may contain hydraulic fluid 150 while 120-2 of 101-3 may be empty. The pass may be operated using 120-2 of 101-1 as source reservoir and 120-2 of 101-3 as sink reservoir. During separation at separation unit 100, 100 F is supplied from 120-2 of 101-1 and 100 R is collected at 120-2 of 101-3. To compensate for change in volume of process solution in 101-1 and 101-3, 150 needs to be filled in 120-1 of 101-1 while 150 needs to be removed from 120-1 of 101-3. This may be accomplished by establishing hydraulic connection through hydraulic fluid re-distribution header 201 between chambers 120-1 of 101-1 and 120-1 of 101-3. Such connection permits the displacement of hydraulic solution from 120-1 of 101-3 equal in volume to retentate 100 R as 100 R fills 120-2 of 101-3 to 120-1 of 101-1 as 100 F vacates 120-2 of 101-1. However during separation process the evacuation of 100 F from 120-2 of 101-1 is not equivalent in volume to addition of 100 R to 120-2 of 101-3. The process solution volume decreases from 100 F to 100 R due to removal of 100 P at 100. The volume of process solution filling 120-2 of 101-3 will be less than the volume of process solution leaving 120-2 of 101-1. To compensate for this volume difference piston 130 of 101-3 is moved downward thereby shrinking the boundary of combined fluid volume pressurized by it.

System 2200 may be operated by using process solution 160 as hydraulic fluid 150 in both chambers. This is explained in the following exemplary scenario. The two chambers 120-1 and 120-2 of liquid container 101-2 may be used as the source and sink reservoirs respectively for a pass. At the start of the pass, 120-1 contains process solution while 120-2 is empty. During separation at 100, 100 F is supplied from 120-1 and 100 R is collected at 120-2. In this configuration, the same piston pressurizes source reservoir 120-1 and sink reservoir 120-2. As a result volume compensation 1 is not required. To compensate for change in volume due to removal of 100P, piston 130 moves downward, to reduce combined volume of process solution in 120-1 and 120-2. The separation process may be converted into semi-batch by addition of system level feed 2200 F to process solution undergoing separation in the system with the use of high pressure pump 503-1.

Addition of 2200F and removal of system level retentate 2200R may be achieved in parallel to the operation of another batch or semi-batch by collection and exchange method as follows. 120-2 of 101-1 may contain 2200R of a previous batch and 120-1 of 101-1 shall contain hydraulic solution present at the end of previous batch. 101-2 and 101-3 may be in use in the current batch. 101-1 is first isolated from the system and then depressurized to atmospheric pressure. 2200 R is then removed at near ambient pressures from 120-2 of 101-1. Subsequently 2200 F is added at near ambient pressures to 120-2 of 101-1. This process is performed in parallel to operation of another batch, similar to parallel filling of liquid container 3 in Table 1. For direct exchange method, an energy recovery device 501 (shown in FIG. 3B) may be used. The system shall be operated with just two reservoirs for process solution. In such a configuration, 2200F for next batch may not be filled in parallel as explained above. Instead entire 2200F for a batch has to be filled in the last pass when 100 R is removed as 2200R. ERD may be used to recover pressure energy from exiting 2200R into incoming 2200F thereby maintaining continuity between batches for batch separations. Configuration of system 2200 shown in FIG. 3D is based on the assumption that 150 is stored in top chamber 120-1 in the liquid containers while 160 is stored in bottom chamber 120-2 in the liquid containers. It may be desirable to store inversely such that 120-1 contains process solution while 120-2 contains hydraulic fluid. When using liquid containers with more number of reservoirs, any arrangement of process solution and hydraulic fluids may be used. Connections to reservoirs may be modified to achieve operations described above.

FIG. 3F represents system 2300 using direct hydraulically pressurized liquid containers of FIG. 2A-2P as pressurized reservoirs for process solution. This system operates identical to system 2200 in FIG. 3E. Major distinction from system 2200, is the absence of moving piston 130. This system uses liquid container with rigid boundaries and the volume compensation may be achieved by internal distribution of hydraulic fluid and addition of external hydraulic fluid. The liquid containers are divided into two regions based on the distribution of hydraulic fluid and process solution. Top region consists of hydraulic fluid 150 while bottom region consists of process solution 160. Configuration in the liquid containers assumes that hydraulic fluid has lower specific gravity than process solution and that the interface between hydraulic fluid and process solution is perpendicular to direction of gravity. As a result 150 and 160 occupy top and bottom portions of the liquid containers respectively. If the specific gravity of hydraulic fluid is higher, then 150 and 160 will occupy bottom and top portions of the liquid containers respectively. Accordingly process connections to the reservoirs shall change. It is also possible for change in order of relative specific gravities to occur during separation. In such instances, the regions may invert during a process and system may be configured to provide additional connections to the reservoirs to perform continuous separation. Hydraulic solution compatible with process solution and acceptable for the application may be used. System level retentate 2300 R may be removed either by direct exchange or by collection and exchange methods (FIGS. 4F and 4G). When removing directly in the last pass, ERD 501 and booster pump 502 (shown for system 1100) may be used to recover energy from 2300 R into incoming system level feed 2300 F. For removing the retentate by collection and discharge, hydraulic fluid 2300 HI is filled in hydraulic fluid region at near ambient pressures to displace the retentate out of the system. After emptying the reservoir of 2300 R, 2300 F for a new batch may be filled in at near ambient pressures while displacing excess hydraulic fluid 2300 HO.

FIG. 3G represents system 2400 using indirect hydraulically pressurized liquid containers of FIG. 2A-2P as pressurized reservoirs for process solution. This system operates identical to system 2300 in FIG. 3F. These liquid containers have rigid boundaries and perform volume compensation through internal distribution of hydraulic fluid 150, by addition and removal of external hydraulic fluid. Major distinction is the substitution of hydraulic fluid with permeate solution 100P produced from separation unit 100 and using a movable partition or a bladder to separate it from other process solutions (feed and retentate). Using 100P makes the system 2400 self-reliant for its operations and does not require a dedicated hydraulic system to operate. The liquid containers contain two reservoirs separated by a movable partition 140 or a bladder 180. It is possible to use more than one movable partition 140 or bladder 180 to divide the liquid containers into more than 2 reservoirs. The method described below is suitable for configurations with one or more 140 and 180. In FIG. 3F, the system consists of one movable partition in liquid containers 101-1 and 101-3. Bottom chambers 120-2 in the liquid containers may be filled with process solution. Top chamber 120-1 in the liquid containers may be filled with permeate solution produced from separation unit 100. An exemplary separation process in non-recirculation method is depicted in Table 1 as explained earlier. For the system 2400 shown in FIG. 3G, reservoir 1, reservoir 2 and reservoir 3 may be assumed to be represented by reservoirs 120-2 of 101-1, 120-2 of 101-2 and 120-2 of 101-3 respectively. In an exemplary scenario, a pass may be operated using reservoirs 120-2 in liquid containers 101-1 and 101-3 as source and sink reservoirs as follows. At the start of the pass, 120-1 of 101-1 may be empty while 120-2 of 101-1 may contain process solution and 120-1 of 101-3 may contain permeate solution while 120-2 of 101-3 may be empty. The pass may be operated using 120-2 of 101-1 as source reservoir and 120-2 of 101-3 as sink reservoir. During separation at 100, 100 F originates from 120-2 of 101-1 and 100 R is collected at 120-2 of 101-3. To compensate for change in volume of process solution in 101-1 and 101-3, 100P is filled in 120-1 of 101-1 while 100P is removed from 120-1 of 101-3. This may be accomplished by establishing hydraulic connection through 201 between 120-1 of 101-1 and 120-1 of 101-3. Such connection permits displacement of 100P from 120-1 of 101-3 as 100R fills 120-2 of 101-3 to 120-1 of 101-1 as 100F vacates 120-2 of 101-1. However during separation process, the evacuation of 100F from 120-2 of 101-1 is not the same as addition of 100R to 120-2 of 101-3. The process solution volume decreases from 100 F to 100 R due to removal of 100 P at 100. As a result volume of 100R filling 120-2 of 101-3 will be less than the volume of 100F leaving 120-2 of 101-1. To compensate for this volume change, 100 P removed at 100 is filled in 120-1 of 101-1 using high pressure pump 503-2 which brings 100 P to system operating pressure. For collection and exchange method, during operation of batch 1 described above, system level feed 2400 F for batch 2 may be filled in 120-2 of 101-2. Towards the end of batch 1, 120-1 and 120-2 of one liquid container shall contain permeate and shall be empty respectively, while 120-1 and 120-2 in the other liquid container shall be empty and shall contain system level retentate 2400 R respectively. During switchover sequence between batch 1 and batch 2, the liquid container containing 2400 R may be isolated from the system and depressurized while the empty reservoir 120-2 of other liquid container without process solution may be used as sink reservoir in the first pass of batch 2. 2400 R is removed from 120-2 of the liquid container containing it by filling 100P or 2400P at near ambient pressures in the corresponding reservoir 120-1. Subsequently 2400 F for the next batch may be filled in 120-2 of the same liquid container thereby displacing system level permeate solution 2400 P.

When removing by direct exchange method, ERD 501 and booster pump 502 (shown for system 1100 in FIG. 3B) may be used to recover pressure energy from exiting 2400 R into incoming 2400 F in the last pass. The pressurized 2400 F is added to an empty reservoir 120-2 of a liquid container whose reservoir 120-1 contains permeate solution that is at system operating pressure and in fluid communication with 120-1 of other liquid containers in operation. Addition of 2400 F displaces permeate solution from 120-1 of this liquid container to 120-1 of the liquid container comprising source reservoir 120-2 for last pass. The permeate inlet 208 and outlet 209 header may be shared. Since either one of them occurs at a time. Alternatively separate conduits may be used.

FIG. 3H represents system 2500 using indirect hydraulically pressurized liquid containers of FIG. 2A-2P as pressurized reservoirs for process solution. This system operates identical to system 2300 in FIG. 3F. These liquid containers have rigid boundaries and perform volume compensation through internal distribution of hydraulic fluid and by addition of external hydraulic fluid. Major distinction is the use of system level feed solution 2500-F as hydraulic fluid and using movable partition 140 to separate it from other process solutions (feed and retentate) undergoing separation at 100. Using feed solution makes the system 2500 self-reliant for its operations and does not require a dedicated hydraulic system to operate. Further this has the advantage to minimizing the mixing effects between hydraulic fluid and process solution on either sides of 140 that would be more pronounced when these fluids have very different compositions. The liquid containers contain two reservoirs separated by 140. It is possible to use more than one 140 to divide the liquid containers into more than 2 reservoirs. The method described below is suitable for configurations with one or more movable partitions 140. An exemplary separation process in non-recirculation method is depicted in Table 1 as explained earlier. For the system 2500 shown in FIG. 3H, reservoir 1, reservoir 2 and reservoir 3 may be assumed to be represented by reservoirs 120-2 of 101-1, 120-2 of 101-2 and 120-2 of 101-3 respectively. In an exemplary scenario, top 120-1 and bottom 120-2 reservoirs in liquid containers 101-1 and 101-3 may be filled with system level feed 2500-F. A pass may be operated using 120-2 in liquid containers 101-1 and 101-3 as source and sink reservoirs respectively as follows. At the start of the pass, reservoir 120-1 of 101-1 may be empty while reservoir 120-2 of 101-1 may contain 2500F and reservoir 120-1 of 101-3 may contain 2500F while reservoir 120-2 of 101-3 may be empty. The pass may be operated using reservoir 120-2 of 101-1 as source reservoir and reservoir 120-2 of 101-3 as sink reservoir. During separation at 100, 100F is supplied from 120-2 of 101-1 and 100 R is collected at 120-2 of 101-3. To compensate for change in volume of process solution in 101-1 and 101-3, feed solution 2500-F is filled in chamber 120-1 of 101-1 while feed solution 2500-F is removed from chamber 120-1 of 101-3. This may be accomplished by establishing hydraulic connection through 201 between reservoirs 120-1 of 101-1 and 120-1 of 101-3. Such connection permits displacement of feed solution 2500-F from 120-1 of 101-3 as 100R fills 120-2 of 101-3 to 120-1 of 101-1 as 100F vacates 120-2 of 101-1. However during separation process, the evacuation of 100F from 120-2 of 101-1 is not the same as addition of 100R to 120-2 of 101-3. The process solution volume decreases from 100 F to 100 R due to removal of 100 P at 100. As a result volume of process solution filling 120-2 of 101-3 will be less than the volume of process solution leaving 120-2 of 101-1. To compensate for this volume change 2500-F is filled into 120-1 of 101-1 using high pressure pump 503-1 which brings the 2500-F to system operating pressure. During operation of batch 1 described above, 2500 F for batch 2 may be filled in 120-2 of 101-2. Towards the end of batch 1, reservoirs 120-1 and 120-2 of one liquid container shall contain 2500 F and shall be empty respectively, while reservoirs 120-1 and 120-2 in the other liquid container shall be empty and shall contain batch retentate 2500 R respectively. The empty reservoir 120-2 of other liquid container used in batch 1 may be used as sink reservoir in the first pass of batch 2 while 120-2 of 101-2 earlier filled with 2500 F for batch 2 may be used as source reservoir in the first pass of batch 2. System level retentate 2500 R may be removed either by direct exchange method or by collection and exchange method during the last pass. When removing by collection and exchange method the liquid container containing 2500 R may be isolated from the system and depressurized to near ambient pressures. 2500 R is removed from 120-2 of the liquid container containing it by filling 2500 F in the adjoining hydraulically linked reservoir 120-1 at ambient pressures. Subsequently 2500 F for the next batch may be filled in 120-2 of the same liquid container thereby displacing excess 2500 F that was earlier filled in 120-1 for removing 2500 R. Alternatively, 120-1 of liquid container from which 2500 R was earlier removed may be used for supplying 2500 F as 100F for first pass of a batch while 120-2 of the same liquid container may be used as sink reservoir in first pass of a subsequent batch. In this alternate method, 120-1 and 120-2 of a liquid container are used as source and sink reservoirs of a batch.

When removing by direct exchange method in the last pass, ERD 501 (shown for system 1100 in FIG. 3B) may be used to recover pressure energy from exiting 2500 R into incoming system level feed 2500 F. The pressurized 2500 F is added to an empty reservoir 120-2 of a liquid container whose reservoir 120-1 contains 2500 F that is at system operating pressure and in fluid communication with 120-1 of other liquid containers in operation. Addition of 2500 F displaces 2500 F from 120-1 of this liquid container to 120-1 of the liquid container comprising source reservoir 120-2 for last pass. Thus continuous batch and semi-batch separation is achieved by the use of indirect hydraulically pressurized liquid containers using XXXXF as hydraulic fluid.

FIG. 3I represents system 2600 using indirect hydraulically pressurized liquid container of FIG. 2A-2P as pressurized reservoirs for process solution. This system operates identical to system 2300 in FIG. 3F. These liquid containers have rigid boundaries and perform volume compensation through internal distribution of hydraulic fluid and by addition of external hydraulic fluid. Permeate solution 100P may be used as hydraulic fluid. Using 100P or other process solutions makes the system 2500 self-reliant for its operations and does not require a dedicated hydraulic system to operate. The liquid containers are divided into chambers by one or more bladders 180. Typically multiple bladders are used in a single liquid container, wherein chamber inside each bladder and the surrounding chamber may be used as a reservoir. The method described below is suitable for configurations with one or more bladders 180. In FIG. 3I, the system consists of two bladders 180 in each liquid container. 120-1 and 120-2 may be filled with feed or retentate solutions. In this exemplary method the reservoir outside the bladders 120-3 may be filled with permeate solution 100-P produced from separation unit 100 and used as hydraulic fluid 150. When transverse cascading method is followed, 100P of each pass must be stored separately. In such cases another process solution say 2600F may be used as 150 in 120-3. An exemplary separation process in non-recirculation method is depicted in Table 1 as explained earlier. For the system 2600 shown in FIG. 3I, reservoir 1, reservoir 2 and reservoir 3 may be assumed to be represented by reservoirs 120-1 and 120-2 of 101-1, 120-1 and 120-2 of 101-2 and 120-1 and 120-2 of 101-3 respectively. In an exemplary scenario, a pass may be operated using chambers 120-1 and 120-2 in liquid containers 101-1 and 101-3 as follows. At the start of the pass, 120-1 and 120-2 of 101-1 may be empty while 120-1 and 120-2 of 101-3 may contain process solution and 120-3 in both 101-1 and 101-3 may contain 100P. 120-1 and 120-2 of 101-2 may be filled with system level feed solution 2600 F for subsequent batch in parallel to operation of current batch. First pass may be operated using 120-1 and 120-2 of 101-3 as source reservoirs and 120-1 and 120-2 of 101-1 as sink reservoirs. 100F originates from 120-1 and 120-2 of 101-3 and 100R is collected at 120-1 and 120-2 of 101-1. To compensate for change in volume of process solution, 100P in 120-3 of 101-1 may be displaced to 120-3 of 101-3. This may be accomplished by establishing hydraulic connection between 120-3 of 101-1 and 120-3 of 101-3 through 201. Such connection permits displacement of 100P from 120-3 of 101-1 as 100R fills 120-1 and 120-2 of 101-1 to 120-3 of 101-3 as 100F vacates 120-1 and 120-2 of 101-3. However during separation process, the quantity of process solution evacuated from 120-1 and 120-2 of 101-3 is not the same as the quantity of process solution added to 120-1 and 120-2 of 101-1. The process solution volume decreases from 100 F to 100 R due to removal of 100 P at 100. As a result volume of 100 R filling 120-1 and 120-2 of 101-1 will be less than the volume of 100 F leaving 120-1 and 120-2 of 101-3. To compensate for this volume change 100P removed at 100 is filled into the chamber 120-3 of 101-3 using high pressure pump 503-2 which brings 100P to system operating pressure. Towards the end of pass 1 reservoir switchover sequence (FIGS. 4E-1 and 4E-2) is followed. Towards the end of batch 1, 120-1 and 120-2 of one liquid container shall contain system level retentate 2500 R while 120-1 and 120-2 in the other liquid container shall be empty. System level permeate solution 2500 P will be distributed in chambers 120-3 of both 101-1 and 101-3.

2500 R may be removed either by direct exchange method or by collection and exchange method. When removing directly in the last pass, ERD (shown in system 1100 in FIG. 3B) may be used to recover pressure energy from exiting 2500 R into incoming 2500 F. The pressurized 2500 F is added to empty chambers 120-1 and 120-2 of a liquid container that contains permeate solution in chamber 120-3 which is hydraulically connected to chamber 120-3 of the source liquid container(s) containing source reservoir(s) of last pass and is at system operating pressure. Addition of 2500 F displaces permeate solution from 120-3 of this liquid container to chamber 120-3 of the source liquid container(s) for last pass. Further permeate solution 100 P of the last pass is also added to 120-3 of source liquid container(s) of the pass.

When removing system level retentate 2500 R by collection and exchange method, 100 R produced in the last pass of a batch is collected in chambers 120-1 and 120-2 of one liquid container which is isolated from system 2500 after completion of last pass and depressurized. Subsequently external permeate solution at near ambient pressures is added to the permeate chamber 120-3 of same liquid container containing 100R of last pass in 120-1 and 120-2 thereby displacing 100R as 2500R of previous batch. Subsequently 2500 F for a new batch is added at near ambient pressures to the same 120-1 and 120-2 of the same liquid container. This displaces external permeate solution that was added to displace 2500 R and 2500P of previous batch while simultaneously filling 2500 F for subsequent batch.

Another preferred method of removing 2500 R from 120-1 and 120-2 of the liquid container containing the retentate 2500 R is by filling 2500 F in 120-1 and 120-2 at near ambient pressure via connection on one end, displacing 2500 R via connection on the other end and further displacing 2500 P from 120-3 of the same liquid container simultaneously. Bladders and their multiple connections in liquid container type FIG. 2P specifically enable this method. Liquid container with bladders having additional connections can be used. Thus continuous batch and semi-batch separation is achieved by the use of indirect hydraulically pressurized liquid containers 2M-2P using permeate solution as hydraulic fluid.

The liquid containers FIG. 2M-2P may also be used as unpressurized reservoirs for pressure drive separations and for osmotically driven separations.

FIG. 4A, illustrates the general method of operating a pass in batch and semi-batch pressure driven osmotic and non-osmotic separations wherein process solution is transported across a first side of semi-permeable membrane 104. Examples of pressure driven separations referred here include reverse osmosis and ultrafiltration. In step 5, when collecting process solutions, they may be collected in reservoir(s) already containing another process solution of agreeable properties (such as same osmotic pressure, compositions) and mixed with that process solution. When shutting down the system, the process solution in system components is preferably flushed with a non-fouling solution such as high purity water.

FIG. 4F illustrates the direct exchange method of removing XXXX R and filling XXXX F for systems operating with pressurized reservoirs. The method may be modified to accommodate different ERD technologies as explained earlier.

FIG. 4G illustrates the collection and exchange method of removing system level retentate XXXX R and filling system level feed XXXX F for systems operating with pressurized reservoirs. Removal of XXXX R and filling of XXXX F is performed at ambient pressures. This method minimizes energy loss and lowers capital expense of pressurizing unit compared to direct exchange method since ERD 501 is eliminated by this method.

FIG. 4H illustrates direct exchange method and collection and exchange method of removing system level retentate XXXX R and filling system level feed XXXX F for systems operating with unpressurized reservoirs. This method applies to systems with process solution flow across the first side of 104 using unpressurized reservoirs for performing high-pressure separations.

For systems performing low pressure driven separation with process solution flow across the first side of 104 and for systems performing osmotically driven separation with process solution flow across the first and second sides of 104, these methods may be simplified as follows. System level feed XXXX F on feed side and system level draw XXXX D_{I} on draw side of a subsequent batch may be filled in parallel to the operation of a batch in corresponding empty reservoir(s) at near ambient pressures. In direct exchange method, pass level retentate 100 R and pass level diluate draw 100 D_{O} may be removed from first stream outlet 1.2 and second stream outlet 2.2 of separation unit 100 respectively. In the collection and exchange method 100 R and 100 D_{O} may be collected in empty reservoirs on corresponding sides and subsequently replaced with XXXX F on feed side and XXXX D_{I} on draw side in parallel to operation of another separation cycle.

For a separation system 100 liquid containers capable of holding liquid under the operating conditions may be used as reservoirs. The types of liquid containers that may be used are shown in FIG. 2A-2O. For systems performing pressure driven separations using these liquid containers, the means for regulation of system pressure vary between the liquid containers. Likewise mechanism of volume compensations differ between the reservoir types. For all pressurized reservoirs using hydraulic fluid 150 excepting reservoirs where hydraulic fluid 150 is in direct contact with process solution 160, process solution 160 may also be used as hydraulic fluid 150. In reservoirs with movable partition 140 separating the chambers, the partition might be a solid material or another fluid, gel, fibrous or matrix material or any other material immiscible with the fluids in both the chambers.

All pressurized liquid containers may also be operated without exerting pressure in unpressurized systems. All liquid containers 101 and all chambers 120 in them (for liquid containers with partition and bladders) are designed to permit filling them completely with hydraulic fluid 150 or process solution 160. Further the design is such that fluid in all liquid containers and all chambers in them may be emptied completely leaving minimal to no residual solution. This is an essential feature of the invention and especially important for minimizing entropy generation due to mixing of process solutions at different concentrations in the reservoir(s). For pressure driven separations, unpressurized and pressurized reservoirs in FIG. 1 may be used. For osmotically driven separation that do not require high operating pressures, any of the reservoirs in FIG. 1 may be used although reservoirs in FIG. 2A to FIG. 2C and in FIG. 2M to FIG. 2P are preferred.

Essential features of methods and systems in invention: For achieving batch and semi-batch separation certain key operations are essential. These include (a) Volume compensation (b) Regulation of driving force for separation (c) Recuperation of driving force (d) supplying and removing system level process solutions to achieve continuity between batches (e) Reservoir(s) switchover sequence.

Volume compensation techniques: Volume compensation refers to system adjustments corresponding to changes in volume of process solution in a reservoir due to removal or addition of process solution for performing separation at unit 100. Volume changes can be segregated to facilitate understanding. Volume changes can occur due to removal of pass level output solutions (retentate or diluate draw or permeate) from reservoir(s) and addition of pass level input solutions (feed or draw) to reservoir(s). The means by which system adjusts to these volume changes may be referred to as volume compensation 1. Volume changes can also occur due to permeate removal from first stream, permeate addition into second stream and due to changes in density of process solution during separation. The means by which system adjusts to these volume changes may be referred to as volume compensation 2. The means of volume compensations depends on the reservoir. Table 3 below summarizes the means of achieving volume compensation 1 and 2 for different types of reservoirs. In Table 3, reservoirs are grouped based on the outermost fluid boundary. This is outermost physical boundary of liquid containers that is contacted by the fluids inside. For single reservoir liquid containers, the total volume of fluid in reservoir defines this boundary. For liquid containers with multiple reservoirs, this boundary is defined by total volume enclosed by the outermost physical boundary contacted by the fluids inside. When a reservoir is operated in re-circulation mode or the source and sink reservoirs of a pass are contained in the same liquid container, the pass level retentate corresponding to the pass level feed is returned to the same reservoir or liquid container, volume compensation 1 is not required for the portion of pass level retentate returned to the liquid container. FIG. 4D illustrates the general method of performing volume compensation for pressurized and unpressurized reservoirs for all separations. This method assumes that when a reservoir is operated in recirculation mode, all pass level retentate corresponding to the pass level feed supplied to 100 is returned to the same reservoir. For partial return of pass level retentate, which may be performed when operating with multiple source and sink reservoirs, volume compensation 1 will be required for portion of retentate not returned.

TABLE 3
Summary of volume compensation for different types of reservoirs.

| | Type of reservoir | | | |
|---|---|---|---|---|
| | | Fixed fluid | | Variable fluid |
| | Fixed fluid | boundary with | Variable fluid | boundary with |
| Description | boundary | inner chambers | boundary | inner chambers |
| Applicable | FIG. 2I, | FIG. 1-2E, 2F, | FIG. | FIG. 2C, 2G |
| reservoirs | FIG. 2K | 2J, | 2A, 2B, 2D, 2H | |
| | | 2M, 2N, 2O, 2P | | |
| Volume | For reservoir, | For reservoir, | For reservoir, | For reservoir, |
| compensation | (FIG. 2I) | (FIG. 2E) | (FIG. 2A) | (2C) |
| 1 mechanism | Hydraulic | Hydraulic fluid | Equilibration | Equilibration |
| | fluid re- | re-distribution. | with ambient | with ambient |
| | distribution. | (FIG. 2F) | pressure. | pressure |
| | (FIG. 2K) | Hydraulic fluid | (FIG. 2B) | (2G) Hydraulic |
| | Process | re-distribution. | Equilibration | fluid re- |
| | solution | (FIG. 2J) | with ambient | distribution. |
| | addition or | Hydraulic fluid | pressure. | |
| | removal. | re-distribution. | (FIG. 2D) Piston | |
| | | (FIG. 2M) to | movement. | |
| | | (FIG. 2P) | (FIG. 2H) | |
| | | Hydraulic fluid | Hydraulic fluid | |
| | | re-distribution. | re-distribution. | |
| Volume | For reservoir, | For reservoir, | For reservoir, | For reservoir, |
| compensation | (FIG. 2I) - | (FIG. 2E) | (FIG. 2A) | (FIG. 2C) |
| 2 mechanism | Hydraulic | Hydraulic fluid | Equilibration | Equilibration |
| | fluid addition | addition or | with ambient | with ambient |
| | or removal. | removal. | pressure. | pressure |
| | (FIG. 2K) | (FIG. 2F) | (FIG. 2B) | (FIG. 2G) Piston |
| | Process | Hydraulic fluid | Equilibration | movement. |
| | solution | addition or | with ambient | |
| | addition or | removal. | pressure. | |
| | removal with | (FIG. 2J) | (FIG. 2D) Piston | |
| | complete | Hydraulic fluid | movement. | |
| | flooding of | addition or | (FIG. 2H) Piston | |
| | reservoir. | removal. | movement. | |
| | | (FIG. 2M) to | | |
| | | (FIG. 2P) | | |
| | | Hydraulic fluid | | |
| | | addition or | | |
| | | removal. | | |

Regulation of driving force: Regulation of driving force during separation is essential to realize potential gains in energy efficiency resulting from equipartitioning of driving force at the required performance. For pressure driven separations operating pressure may be applied by high pressure pumps either directly on process solution or on hydraulic fluids that in turn transmit the pressure to process solution. Alternatively, piston movement can be used to apply pressure directly on either process solution or on hydraulic fluids that in turn transmit the pressure to process solution. Yet another method is to apply pressure pneumatically on process solution, for example using compressed air supply. For osmotically driven separations, the difference between osmotic pressure of process solution on feed side and osmotic pressure of process solution on draw side of 104 is regulated in order to achieve efficient separation using the total available difference between the osmotic pressures of system level feed and draw solutions. This regulation may be achieved by a variety of means. This includes controlling the rate of transport of process solutions on the two sides of 104, varying the number of passes of the batch or semi-batch, use of appropriate flow arrangement, flow conditions and turbulence inducers.

Recuperation of driving force: For pressure driven separations energy recovery is required during operation, towards the start or end of a pass, a batch or semi-batch, to recover energy from process solution or hydraulic fluid exiting the pressurized region of the system that might otherwise be wasted. For pressure driven separations, pressure exchanger or energy recovery turbine or other ERDs may be used. When using unpressurized reservoirs, energy recovery during a separation cycle is performed between pass level retentate and pass level feed during every pass using ERDs. ERDs have operational in-efficiencies and capital costs associated with them. In certain system configurations energy recovery devices may be minimized or eliminated. When using pressurized reservoirs, energy is recovered between passes by collecting the retentate at the operating pressures. Pressurized reservoirs are capable of collecting and storing process solution from separation unit 100 at or near system operating pressures. The pressurized region extends to include the feed side reservoirs. Energy loss associated with circulation of pass level process solution through the system components is compensated by energy supplied by circulation pump 504 on feed side and 505 on draw side. For osmotically driven separations, osmotic energy available in pass level diluate draw solution is reused in a subsequent pass.

Supply of system level input and removal of system level output solutions: For all types of separations, system level output solutions are required to be removed and system level input solutions are required to be added between one batch or semi-batch and the next. This removal and addition is performed while achieving uninterrupted separation between separation cycles and minimizing energy loss due to depressurization of high pressure stream and pressurization of low pressure stream. For pressure driven separations operating at high pressures, system level retentate XXXXR may be removed by direct exchange method wherein energy is recovered from XXXXR and supplied to system level feed XXXXF. The retentate from last pass 100 R of a batch is XXXXR and it may be directly removed through ERD 501 in the pressurizing unit. Further for systems operating with unpressurized reservoirs, XXXXF corresponding to first pass of next batch is added to the source reservoir(s) of that pass at near ambient pressures prior to its transport through ERD for direct exchange of XXXXR. This addition may be done during operation of a batch as shown in Table 1. For systems operating with pressurized reservoirs, XXXXF corresponding to first pass of next batch is added through ERD 501 and pressurizing unit components during direct exchange of XXXXR in the last pass of previous batch. FIG. 4H describes direct exchange method when using unpressurized reservoirs and FIG. 4F describes direct exchange method when using pressurized reservoirs. For pressure driven separations operating at low pressures and for osmotically driven separations, retentate and diluate solutions may be removed during the last pass directly from corresponding outlets 1.2 and 2.2 of separation unit 100.

System level output solutions may be removed by collection and discharge method. For pressurized reservoirs, system level retentate XXXXR is collected in reservoir(s) at system operating pressures. Subsequently all hydraulic connections between the reservoir(s) containing XXXXR and separation unit 100 are disconnected and the reservoir(s) is depressurized to ambient or near atmospheric pressures. Further removal of system level retentate XXXXR and filling of system level feed XXXXF occurs at ambient or near atmospheric pressures. This may be accomplished either by a sequential process or a simultaneous process. In the sequential process, XXXXR is removed first which is then followed by filling of XXXXF in the same reservoir. In the simultaneous process, XXXXF is filled in the same reservoir while XXXXR is simultaneously removed by displacement. XXXXF may be filled in opposite end to the end from where XXXXR is removed, filled in an adjoining reservoir or filled in another reservoir in fluidic communication with the reservoir containing XXXXR. Subsequently the system level feed solution XXXXF added to the reservoir is pressurized to bring it to required operating pressure. The change in volume with pressure for most of the liquids is practically negligible and for such incompressible fluids, the work done in pressurizing and the energy lost in depressurizing is negligible and do not affect overall process efficiency. Later all hydraulic connections of the reservoir containing system level feed) XXXXF with separation unit 100 is re-established. FIG. 4G illustrates the collection and exchange method for pressurized reservoirs. For unpressurised feed side and draw side reservoirs used in osmotically driven separations (i.e. where ERD, HPP and BP may not be present) the method followed for unpressurised reservoirs in pressure driven separations above may be adopted for reservoirs on both sides. Method described in FIG. 4H with changes to steps 1, 2 and 3 may be used. In these steps of modified method, ERD 501 may not be used for removal or supply of pass level solutions.

In the direct exchange method the last pass would only have a source reservoir but not a sink reservoir. On contrary, in collection and exchange method, the last pass would have source and sink reservoir(s). Further in systems using pressurized reservoirs, the rate of filling of XXXX-F in direct exchange method will be higher compared to collection and exchange methods. This is because in direct filling entire quantity of XXXX-F has to be added in the last pass of previous batch while in collection and exchange methods XXXX-F can be added parallel.

The disclosed systems can be used to achieve batch separation using pressure driven and osmotically driven separations. Some examples of these separation systems is given in Table 4 below,

TABLE 4
Example of different separation technologies

| Sl. No. | Separation type | Separation technologies |
|---|---|---|
| 1 | Pressure driven | Membrane filtration, reverse osmosis |
| | separations | |
| 2 | Separations driven by | Forward osmosis using electrolytic draw |
| | difference in osmotic | solutions, thermolytic draw solutions, draw |
| | pressures on the two sides | solutions with switchable polarity and |
| | of membrane 104 | switchable ionic strength. |

Switchover sequence is followed between every consecutive passes in cascading methods to achieve continuous separation between passes, batches and semi-batches. It enables precise replacement of process solution in various system components from the process solution corresponding to a previous pass with the process solution of next pass with minimal or no mixing of process solutions at different concentrations. The switchover sequence is designed to replace the entire hold up volume of process solution corresponding to a previous pass in the system components with process solutions of the upcoming pass. Importantly during this switchover sequence, separation continues in the separation unit 100 un-interrupted. FIG. 4E illustrates the general method of performing reservoir switchover sequence. For systems with process solution circulation on one side of 104, it is desirable to use a dedicated header for collecting 100P from 2.2 in feed side reservoirs separate from header used for collecting 100R from 1.2. The method is performed systematically and accurately to replace different hydraulic segments of system components in such a way to minimize mixing of process solutions belonging to different pass or having different compositions.

### Osmotically Driven Separations:

Osmotically driven separations are accomplished by exploiting difference in osmotic pressure of process solutions on two side of membrane 104. FIG. 1E illustrate the conceptual operation of osmotically driven separations with process solution flow on both sides. System 2700 in FIG. 3J may be used for performing osmotically driven separations. An exemplary separation process in non-recirculation method is depicted in Table 1 as explained earlier. For the system 2700 shown in FIG. 3J, reservoir 1, reservoir 2 and reservoir 3 mentioned in Table 1 on feed side may be represented by reservoirs 101-1, 101-2 and 120-2 of 101-3 respectively. While reservoir 1, reservoir 2 and reservoir 3 on draw side may be represented by reservoirs 110-1, 110-2 and 120-2 of 110-3. Process solutions are transported across the first side of 104 also referred to as feed side and across the second side of 104 also referred to as the draw side. Concentration of draw side process solution decreases from system level draw solution XXXXD_{I} to system level diluate draw solution XXXXD_{O} while the concentration of feed side process solution increases from system level feed solution XXXXF to system level retentate solution XXXXR. This change in concentrations is achieved by extraction of permeate solution from feed side process solution to draw side process solution by the draw side process solution. An exemplary pass may be performed using 101-1 and 101-2 as source and sink reservoirs on feed side respectively and using 110-1 and 110-2 as source and sink reservoirs on draw side respectively. Process solution on feed side is transported from 101-1 to first side of 104 and then to 101-2 using pump 504. The process solution flows from 1.4 of 101-1 through 1.6 to first stream inlet 1.1 of 100 and emerges from first stream outlet 1.2 of 100 and flows through 1.5 to 1.3 of 101-2. Simultaneously process solution on draw side is transported from 110-1 to second side of 104 and then to 110-2 using pump 505. The process solution flows from 2.4 of 110-1 through 2.6 to second stream inlet 2.1 of 100 and emerges from second stream outlet 2.2 of 100 and flows through 2.5 to 2.3 of 110-2. Osmotic difference between process solutions on the two sides of 104 leads to extraction of permeate solution 100-P from the first side to the second side. Process solution concentration changes from 1.1 to 1.2 on first side and from 2.1 to 2.2 on the second side. On the first side, process solution prior to 1.1 is the pass level feed solution 100F, process solution subsequent to 1.2 is the pass level retentate solution 100R. On the second side, process solution prior to 2.1 is the pass level draw solution 100D_{I}, process solution subsequent to 2.2 is the pass level diluate draw solution 100D_{O}. Osmotically driven separations may be performed to achieve a co-current or counter current relative change in concentrations of process solutions. In osmotically driven separations with co-current changes in concentration of process solutions, the concentration of process solutions on feed and draw sides approach each other with progress in passes or process time. As a result, concentration of system level diluate draw solution and concentration of system level retentate solution approach each other. Comparison of key characteristics between co-current concentration change and counter current concentration change are presented in Table 5 below. The method with counter current concentration change is more efficient than method with co-current concentration change and can achieve larger separations for a given difference in osmotic pressures between system level feed and system level draw solutions.

For co-current concentration change osmotic separations, process as shown in Table 1 may be performed and concentrations of final system level process solutions approach each other. For an exemplary scenario, an aqueous salt solution of sodium chloride is considered as process solution on both sides. Process solution concentration is expressed in grams of salt per liter (gpl) of solution. FIG. 5G illustrates the change in concentration of process solutions with passes. Pass 1 begins with the use of system level feed solution XXXXF at 80 gpl as pass level feed solution 100F on the first side of 104 and system level draw solution XXXXDI at 180 gpl as pass level draw solution 100D_{I} on the second side of 104. Pass level retentate solution 100R at 90 gpl generated on the first side of 104 in pass 1 is collected in at least one feed side reservoir and pass level diluate draw solution 100DO at 170 gpl generated on the second side of 104 in pass 1 is collected in at least one draw side reservoir. 100R at 90 gpl and 100DO at 170 gpl from pass 1 are supplied as 100F on first side of 104 and 100DI on second side of 104 respectively in pass 2. 100R at 100 gpl generated on the first side of 104 in pass 2 is collected in at least one feed side reservoir and 100DO at 160 gpl generated on the second side of 104 in pass 2 is collected in at least one draw side reservoir. 100R at 100 gpl and 100D_{O} at 160 gpl from pass 2 are supplied as 100F on first side of 104 and 100D_{I} on second side of 104 respectively in pass 3. 100R at 110 gpl generated on the first side of 104 in pass 3 is collected in at least one feed side reservoir and 100D_{O} at 150 gpl generated on the second side of 104 is collected in at least one draw side reservoir. 100R at 110 gpl and 100DO at 150 gpl from pass 3 are supplied as 100F on first side of 104 and 100D_{I} on second side of 104 respectively in last pass 4. 100R at 120 gpl generated on the first side of 104 in pass 4 is removed as system level retentate XXXX R and 100DO at 140 gpl generated on the second side of 104 is removed as system level diluate draw XXXX DO.

TABLE 5
Comparison between osmotically driven separations with co-current
concentration change and counter current concentration change.

| No. | Co-current concentration change | Counter current concentration change |
|---|---|---|
| 1 | Concentrations of system level | Concentrations of system level diluate |
| | diluate draw solution and system | draw solution and system level feed |
| | level retentate solution approach | solution approach each other, while |
| | each other. | concentrations of system level retentate |
| | | solution and system level draw solution |
| | | approach each other. |
| 2 | Combined change in concentration | Combined change in concentration of |
| | of process solutions on both sides is | process solutions on both sides can be |
| | less than the difference in | greater than the difference in |
| | concentration of initial system level | concentration of initial system level |
| | draw solution and system level feed | draw solution and system level feed |
| | solution. | solution. |
| 3 | No requirement for stocking | Stocking of intermediate pass level |
| | intermediate pass level process | process solutions is required for |
| | solutions and hence there is no | continuous batch and semi-batch |
| | requirement for preparatory | separations. This mandates preparatory |
| | sequence and corresponding | sequence and use of dedicated reservoirs |
| | reservoirs. | for stocking intermediate pass level |
| | | process solutions. |
| 4 | Difference between osmotic | Difference between osmotic pressure of |
| | pressure of process solution on | process solution on draw side and |
| | draw side and osmotic pressure of | osmotic pressure of process solution on |
| | process solution on feed side | feed side can be varied or maintained |
| | necessarily varies during | constant during separation. |
| | separation. | |

For continuous batch and semi-batch osmotically driven separations performed with counter current changes in concentration of process solutions on feed side and draw side, intermediate pass level process solutions are required on one side of the separation system. These intermediate pass level process solutions must be available prior to initiating continuous batch and semi-batch separations. The intermediate pass level process solutions may be generated from system level process solutions in a preparatory sequence. The side of the system that contains pre-synthesized intermediate pass level process solutions may be referred to as stocked side. The other side of the system may be referred as the un-stocked side.

Preparatory sequence is initiated using system level feed and system level draw solutions to prepare and stock intermediate pass level process solutions on the stocked side for use in batch and semi-batch separations. For the stocked side, system level solution is supplied corresponding to each intermediate pass level solution generated. System level process solution on other side is used correspondingly to prepare intermediate stock solutions. Any intermediate process solution on the un-stocked side may be discarded back to the source of system level feed solution. This preparatory sequence is described for an exemplary process solution for a separation with an exemplary number of passes. The methods can be used for any other process solution for separation with any number of passes.

An exemplary preparation cycle is schematically illustrated in FIG. 5A and FIG. 5B. In this system, a simple aqueous salt solution of sodium chloride is considered as process solution on both sides. Process solution concentration is expressed in grams of salt per liter (gpl) of solution. In this preparatory sequence, stocked intermediate pass level solution for both sides may be prepared. Initially the system reservoirs are empty. In step 1, system level draw solution at 180 gpl and system level feed solution at 80 gpl are supplied to the separation system. In step 2, these solutions are supplied to the separation unit as pass level solutions on corresponding sides of 104 to produce pass level diluate draw solution at 160 gpl on draw side and pass level retentate solution at 100 gpl on feed side respectively. In step 3, process solution at 160 gpl on draw side and process solution at 100 gpl on feed side are supplied to second and first sides of 104 respectively as pass level draw solution and pass level feed solution to generate pass level diluate draw solution at 140 gpl and pass level retentate at 120 gpl respectively. Simultaneously system level feed solution at 80 gpl is supplied to at least one feed side reservoir. Now it is not optimal to supply the generated intermediate pass level process solutions on either sides to the separation unit as their concentrations will approach each other thereby causing the difference between their osmotic pressures to approach zero. This incapacitates the ability of draw solution to effect further separation. In step 4, newly supplied system level feed solution at 80 gpl is supplied as pass level feed solution to the first side of 104 while process solution at 140 gpl on draw side is supplied as pass level draw solution to the second side of 104 to generate pass level retentate at 100 gpl and pass level diluate draw solution at 120 gpl respectively. Similar to step 3 earlier, it is not optimal to supply the generated intermediate pass level process solutions on either sides to the separation unit. Simultaneously system level draw solution at 180 gpl is supplied to at least one draw side reservoir during step 4. In step 5, system level draw solution at 180 gpl on draw side and the earlier generated intermediate process solution at 120 gpl on feed side are supplied as pass level draw solution to second side of 104 and as pass level feed solution to first side of 104 respectively to generate pass level diluate draw solution at 160 gpl on draw side and pass level retentate at 140 gpl on feed side. For preparing intermediate pass level process solutions on draw side, steps 6.1 and 7.1 may be followed. In step 6.1, process solution at 160 gpl on draw side and process solution at 100 gpl on feed side are supplied as pass level draw solution to second side of 104 and pass level feed solution to first side of 104 respectively to generate pass level diluate draw solution at 140 gpl and pass level retentate solution at 120 gpl respectively. Simultaneously system level draw solution at 180 gpl is supplied to at least one draw side reservoir. In step 7.1, process solution at 180 gpl on draw side and process solution at 140 gpl on feed side are supplied as pass level draw solution to second side of 104 and pass level feed solution to first side of 104 respectively to generate pass level diluate draw solution at 160 gpl and pass level retentate solution at 160 gpl that is removed from the system as system level retentate solution. Further the process solution at 120 gpl on feed side is removed from the system and may be sent to the source of system level feed solution. At this stage the system is considered ready with intermediate pass level draw solutions stocked in draw side reservoirs to begin continuous batch and semi-batch separations. Stocked process solutions at concentrations of 120 gpl, 140 gpl and 160 gpl are used as pass level draw solutions 100D_{I} in pass 1, 2 and 3 respectively of a four pass continuous batch and semi-batch separations.

For preparing intermediate pass level process solutions on draw side, steps 6.2 and 7.2 may be followed. In step 6.2, process solution at 160 gpl on draw side and process solution at 100 gpl on feed side are supplied as pass level draw solution to second side of 104 and pass level feed solution to first side of 104 respectively to generate pass level diluate draw solution at 140 gpl and pass level retentate solution at 120 gpl respectively. Simultaneously system level feed solution at 80 gpl is supplied to at least one feed side reservoir. In step 7.2, process solution at 120 gpl on draw side and process solution at 80 gpl on feed side are supplied as pass level draw solution to second side of 104 and pass level feed solution to first side of 104 respectively to generate pass level diluate draw solution at 100 gpl that is removed from the system as system level diluate draw solution and pass level retentate solution at 100 gpl. Further the process solution at 140 gpl on draw side is removed from the system and may be sent to the source of system level draw solution. At this stage the system is considered ready with intermediate pass level feed solutions stocked in feed side reservoirs to begin continuous batch and semi-batch separations. Stocked process solutions at concentrations of 140 gpl, 120 gpl and 100 gpl are used as pass level feed solutions 100F in pass 1, 2 and 3 respectively of a four pass continuous batch and semi-batch separations.

For counter current concentration change, the progression of passes will follow the change in concentration of process solution on the un-stocked side. The concentrations of final system level process solutions used on each side of 104 approach the concentrations of initial system level process solutions on the other side. This may be explained further considering an exemplary four pass counter-current concentration change osmotic separation in FIG. 5E performed using system 2700 of FIG. 3J. This example continues from the example of preparatory sequence and uses the intermediate solutions prepared by the same. The same method may be performed with different process solutions and with any number of passes. Further the difference in osmotic pressure may be larger or smaller than in the exemplary scenario and may remain constant or vary between passes.

When draw side is the stocked side progression of passes follow changes in the concentration of process solutions on feed side (the un-stocked side) with progress of process time as shown in FIG. 5F. Pass 1 is performed by supplying system level feed solution XXXXF at 80 gpl as pass level feed solution 100F on the first side of 104 and by supplying a stocked intermediate pass level draw solution 100D_{I} at 120 gpl on the second side of 104. Pass level diluate draw solution 100D_{O} at 100 gpl is generated on the draw side and removed from the system as system level diluate draw solution XXXXD_{O}. Pass level retentate solution 100R at 100 gpl generated in pass 1 is collected in at least one feed side reservoir and used as 100F in pass 2. Pass 2 is performed by supplying 100R at 100 gpl generated in pass 1 and stored in feed reservoir as 100F to first side of 104 and by supplying a stocked intermediate pass level draw solution 100D_{I} at 140 gpl to second side of 104. Pass level retentate solution 100R at 120 gpl is generated on the first side of 104 and is collected in a feed side reservoir and used as 100F in pass 3. 100D_{O} at 120 gpl generated on the second side of 104 is stocked in a draw side reservoir and supplied as 100D_{I} in pass 1 of next or a subsequent batch. Pass 3 is performed by supplying 100R at 120 gpl generated in pass 2 and stored in feed reservoir, as 100F to first side of 104 and by supplying a stocked intermediate pass level draw solution 100D_{I} at 160 gpl to second side of 104. 100R at 140 gpl is generated on the first side of 104 and is collected in a feed side reservoir and used as 100F in pass 4. 100D_{O} at 140 gpl generated on the second side of 104 is stocked in a draw side reservoir and supplied as 100D_{I} in pass 2 of next or a subsequent batch. The last pass 4 begins with the use of system level draw solution XXXXD_{I} at 180 gpl as pass level draw solution 100D_{I} on the second side of 104. 100R at 140 gpl generated in pass 3 and stored in feed reservoir, is supplied as 100F to first side of 104. Pass level retentate solution 100R at 160 gpl is generated on the first side of 104 and removed from the system as system level retentate solution XXXXR. 100D_{O} at 160 gpl generated on the second side of 104 is stocked in a draw side reservoir and supplied as 100D_{I} in pass 3 of next or a subsequent batch. This completes one batch. During the batch, system level draw solution is converted to pass level diluate draw solution on draw side in pass 4 that is used as pass level draw solution in pass 3 of next batch. Pass level draw solution in pass 1 is converted to system level diluate draw solution on draw side that is removed from the system. The stocked intermediate pass level draw solutions are used in one pass of the batch to produce corresponding pass level diluate draw solutions that are stocked in at least one draw side reservoir and used as pass level draw solutions in earlier passes of further batches.

When feed side is the stocked side progression of passes follow changes in the concentration of process solutions on draw side (the un-stocked side) with progress of process time is as shown in FIG. 5E. Pass 1 begins with the use of system level draw solution XXXXD_{I} at 180 gpl as pass level draw solution 100D_{I} on the second side of 104 and a stocked intermediate pass level feed solution 100F at 140 gpl on the first side of 104. Pass level retentate solution 100R at 160 gpl is generated on the first side and removed from the system as system level retentate solution XXXXR. Pass level diluate draw solution 100D_{O} at 160 gpl generated in pass 1 is collected in at least one draw side reservoir and used as 100D_{I} in pass 2. Pass 2 is performed by supplying a stocked intermediate pass level feed solution 100F at 120 gpl to first side of 104 and by supplying 100D_{O} at 160 gpl generated in pass 1 and stored in feed reservoir as 100D_{I} to second side of 104. 100D_{O} at 140 gpl is generated on the second side of 104 and is collected in a draw side reservoir and supplied as 100D_{I} in pass 3. 100R at 140 gpl generated on the first side of 104 is stocked in a feed side reservoir and supplied as 100F in pass 1 of next or a subsequent batch. Pass 3 is performed by supplying 100D_{O} at 140 gpl generated in pass 2 and stored in draw side reservoir, as 100D_{I} to second side of 104 and by supplying a stocked intermediate pass level feed solution 100F at 100 gpl to first side of 104. 100R at 120 gpl is generated on the first side of 104 and is collected in a feed side reservoir and used as 100F in pass 2 of next or a subsequent batch. 100D_{O} at 120 gpl generated on the second side of 104 is collected in a draw side reservoir and supplied as 100D_{I} in last pass 4. The last pass 4 begins with the use of system level feed solution XXXXF at 80 gpl as pass level feed solution 100F on the first side of 104. 100D_{O} at 120 gpl generated in pass 3 and stored in draw side reservoir, is supplied as 100D_{I} to second side of 104. 100R at 100 gpl generated on the first side of 104 is stocked in a feed side reservoir and supplied as 100F in pass 3 of next or a subsequent batch. 100D_{O} at 100 gpl is generated on the second side of 104 and removed from the system as system level diluate draw solution XXXXD_{O}. This completes one batch. During the batch, system level feed solution is converted to pass level retentate solution on feed side in pass 4 that is used as pass level feed solution in pass 3 of next batch. Pass level feed solution in pass 1 is converted to system level retentate solution on feed side that is removed from the system. The stocked intermediate pass level feed solutions are used in one pass of the batch to produce corresponding pass level retentate solutions that are stocked in at least one feed side reservoir and used as pass level feed solutions in earlier passes of further batches.

When shutting down the system, the stocked intermediate pass level solutions can be stored in the corresponding reservoirs for use in further batches upon system start up. This way preparatory sequence may be eliminated between consecutive systems shut down and start up.

FIG. 4B, illustrates the general method of performing batch and semi-batch osmotically driven separations with process solution flow across a first side and a second side of semi-permeable membrane 104 such that counter current change in concentrations of process solutions is accomplished. The method is further classified based on the side of the system where intermediate pass level process solutions are stocked. The corresponding processes are graphically illustrated in FIG. 5A, FIG. 5B, FIG. 5C, FIG. 5D and FIG. 5E. The intermediate pass level solutions on the stocked side, are used as pass level input solution to 100 in one pass of a batch to produce pass level output solution that are stored in the reservoir(s) and supplied as pass level input solution to 100 in an earlier pass of a next batch. This method accomplishes change in concentration of process solutions on both sides such that they change countercurrent to each other with increase in passes or process time.

FIG. 4C, illustrates the general method of performing batch and semi-batch osmotically driven separations with process solution flow across a first side and a second side of semi-permeable membrane 104 such that co current change in concentration of process solutions is accomplished. The corresponding process is graphically illustrated in FIG. 5F.

In the above methods in FIG. 4B to FIG. 4C, when shutting down the system, the process solution in system components is preferably flushed with a non-fouling solution such as high purity water.

### EXAMPLES

### Example 1: Multi Pass Operation of Batch Reverse Osmosis

Application of the invention is exemplified in an industrial scale system similar to embodiment shown in FIG. 3C. The exemplary system is an industrial scale system with a processing capacity of 100 m3/day of system level feed solution. Reverse osmosis is performed using commercially available spiral wound membrane elements. It comprises three single chamber unpressurized reservoirs equilibrated with atmospheric pressure (i.e. 1 bar). The method described in Table 1 is followed for a batch volume of 7.5 m3 of system level feed solution processed in an hour. The process solution refers to a treated industrial aqueous effluent from textile production that contains greater than 90% of dissolved solids as sodium chloride salt. The separation unit 100 comprises of 4 pressure vessels in parallel arrangement with 4 numbers 8 inch spiral wound membrane elements in each vessel with a total of 16 elements. Isobaric pressure exchanger is used as 501 along with a booster pump 502 and a high pressure pump 503-1. The reservoirs 3, 2 and 1 are designed to hold 5 m3, 4.5 m3 and 3.5 m3 volumes of process solution. A batch with 4 pass level separations is performed as shown in Table 6 below.

TABLE 6
Results of batch separation achieved using 4 pass level separations

| | Pass level feed | | Pass level retentate | | Pass level permeate | | | | |
|---|---|---|---|---|---|---|---|---|---|
| | [100F] (m³) | | [100R] (m³) | | [100P] (m³) | | | | |
| | | Total | | Total | | Total | Applied | | |
| | | dissolved | | dissolved | | dissolved | pressure | | |
| | Volume | solids | Volume | solids | Volume | solids | (P_{F}) | Work done (kJ) | |
| Pass | (m³) | (g/L) | (m³) | (g/L) | (m³) | (g/L) | (bar) | Batch | Continuous |
| Pass 1 | 5 | 20 | 3.86 | 25.5 | 1.1 | <1 | 45 | 7749 | |
| Pass 2 | 3.9 | 26 | 2.98 | 32.5 | 0.9 | <1 | 55 | 7317 | 36667 |
| Pass 3 | 3 | 33.3 | 2.31 | 41.4 | 0.7 | <1 | 60 | 6167 | |
| Pass 4 | 2.3 | 42.8 | 1.78 | 52.8 | 0.5 | <1 | 65 | 5162 | 3979 |

| | | |
|---|---|---|
| Total work done (kJ) | 26396 | 40646 |
| Total specific energy | 2.3 | 3.5 |
| (kWh/m3 permeate) | | |
| Energy savings (%) | 35% | |

A state of the art continuous reverse osmosis system is used for comparison. It consists of two stages in series with an inter-stage booster pump with the same processing capacity of 7.5 m3/hr of system level feed and a total of 16 elements (10 in stage 1 and 6 in stage 2). Both systems are operated with same flux of 9 LMH. The continuous system recovers 40% in stage 1 and 40% in stage 2. Both systems achieve the same total permeate recovery of 64%. The total dissolved solids (TDS) reduction of greater than 95% from 100F to 100P indicates substantial removal of sodium chloride responsible for osmotic pressure of process solution. Work done for a pass level separation is calculated based on applied pressure (P_{F}) on 100F for a pass, quantity of 100R and 100P, efficiencies of high pressure pump 503-1 η₅₀₃₋₁, energy recovery device 501 η₅₀₁ and booster pump 502 η₅₀₂ as follows,

$$Work done per pass = \frac{volume of 100 P \times {P}_{F}}{{η}_{503 - 1}} + \frac{volume of 100 R \times {P}_{F} \times ( 1 - {η}_{501} )}{{η}_{502}}$$

Work done for continuous separation is calculated based on feed quantity to stage 1 (i.e. system level feed V_{F1}), feed quantity to stage 2 (i.e. system level feed V_{F2}), applied pressure in stage 1 (P_{F1}), applied pressure in stage 2 (P_{F2}), efficiencies of high pressure pump 503-1 and inter-stage booster pump 502 as follows,

$$Work done in first stage = \frac{{V}_{F 1} \times {P}_{F 1}}{{η}_{503 - 1}}$$

$$Work done in second stage = \frac{{V}_{F 2} \times ( {P}_{F 2} - {P}_{F 2} )}{{η}_{502}}$$

Efficiency of ERD 501 is taken as 96%, that is typical of isobaric pressure exchangers used in the system of the invention while efficiencies of all high pressure pump 503-1 and booster pump 502 are taken as 75%. Efficiency of ERD corresponds to its energy recovery process while that of 503-1 and 502 corresponds to efficiency of conversion from electrical power input to the motor to work performed by the pumps.

As seen in Table 6 above, total specific work done per unit of permeate recovered by the method of the invention is 2.3 kwh/m3 while for a 2 stage continuous separation is 3.5 kWh/m3. An energy savings of 35% is achievable by a 4 pass batch separation over a 2 stage continuous separation. Both systems can be optimized to achieve higher efficiencies. In particular the efficiency of continuous separation can be improved by increasing the number of stages at the cost of increased investment. However even when the separation is achieved using 4 stage continuous separation, the specific energy decreases to about 3.34 kWh/m3 which is still 32% higher than specific energy consumption for the method and system of the invention. This difference is attributable to high efficiency of 501 compared to 503-1 the components of pressurizing units responsible for major work done in the system of the invention and a continuous separation system respectively.

Further Table 6 indicates the concentrations of 100R of a pass and 100F of next pass. It can be seen that the difference in TDS due to mixing in switchover sequence in less than 5% in all passes. Thus continuous separation between passes is accomplished with minimal mixing of process solutions corresponding to different passes.

### Example 2: Batch Separation of Solutions with High Fouling Potential

A standard dead end stirred cell set-up is used to hold the membrane and the feed solution under pressurized conditions. Feed solutions used correspond to untreated industrial washing cycles effluents from textile production and weak black liquor effluent resulting from pulp production from hard wood and bagasse. The feed solution is contained in a closed cylindrical compartment and pneumatically connected to a source of compressed nitrogen gas. Pressure was applied to feed solution using compressed nitrogen gas. Turbulence was induced near the membrane on feed side using magnetic stirrer from IKA to simulate turbulent flow conditions on the feed side in order to limit feed side concentration polarization near the membrane. Applied pressure on feed solution varied from 1 bar to 70 bar. The membrane is placed on a sintered porous disc which facilitates in collection of permeate solution. Commercially available seawater reverse osmosis membrane from Dow is used as the semi-permeable membrane. Geometric membrane area in hydraulic contact with feed side solution is approximately 14.5 cm². Flux and recovery were calculated from change in mass of permeate solution measured. Parameters of feed solutions used are shown in Table 7 below. It may be observed that the levels of hardness, alkalinity and organic pollutants exceed acceptable levels by RO membrane suppliers for continuous separation. 10 separation batches with the same system level feed solutions were performed. Table 8 compares the performance between batch 1 and batch 10 without any cleaning cycles performed in between. Cleaning cycles are typically performed to maintain designed performance in membrane separation systems. Flux and applied pressures during initial and final part of batch separations may be used to infer change in performance. It is evident from Table 8 that there is marginal decline (<10%) in performance of the membrane between the two batches. This demonstrates the fouling tolerance of batch separations as per the invention.

TABLE 7
Process solution chemical parameters.

| Parameter | UOM | Paper-WBL | Textile-WW |
|---|---|---|---|
| pH | | 6.58 | 6.2 |
| Total dissolved solids (Fixed or | mg/L | 5,070.00 | 24280 |
| Inorganic) | | | |
| Chemical oxygen demand | mg/L | 2,092.00 | 2000 |
| Biochemical oxygen demand (3 | mg/L | 589.00 | — |
| days) | | | |
| Total organic carbon | mg/L | 783.50 | 585.4 |
| Color | Hazen | 1,500 | |
| Total Hardness (as CaCO₃) | mg/L | 762.10 | 700 |
| Total Alkalinity (as CaCO₃) | mg/L | 693.20 | 540 |
| Total Silica as SiO₂ | mg/L | 99.21 | 36.64 |
| Reactive silica as SiO2 | mg/L | 74.49 | 36.38 |

TABLE 8
Repetitive desalination experiments performed on
process solution with high fouling potential.

| | Description | | | | |
|---|---|---|---|---|---|
| | | Values | | | |
| | | Feed solution | | | |
| | | Paper-WBL | | Textile-WW | |
| Batch no | UOM | 1 | 10 | 1 | 20 |
| Feed volume | (g) | 250 | 250 | 250 | 250 |
| Permeate | (g) | 218.991 | 221.718 | 180.184 | 174.66 |
| recovered | | | | | |
| Batch recovery | % | 88% | 89% | 72% | 70% |
| Initial flux | kg/m2/hr | 20.5 | 20.5 | 18.0 | 17.6 |
| System level feed | mg/L | 4455 | 4445 | 23184 | 23418 |
| TDS | | | | | |
| Applied pressure at | bar | 10 | 10 | 40 | 40 |
| initial flux | | | | | |
| System level | mg/L | 14757 | 15033 | 48843 | 50097 |
| retentate TDS | | | | | |
| Final flux | kg/m2/hr | 21 | 19.7 | 9.5 | 9.5 |
| Applied pressure at | bar | 22 | 24 | 69 | 69 |
| final flux | | | | | |

1. A method of performing batch and semi batch separations in a separation system, the method comprising:
a. receiving, by at least one reservoir, a system level feed solution from an external source to initiate a first pass of a batch separation, wherein the batch separation includes one or more pass level separations;
b. supplying, by the at least one reservoir, at least one of the system level feed solution and a pass level retentate solution as a pass level feed solution to a first side of a semi-permeable membrane of a separation unit;
c. exerting, by a pressurizing unit, a pressure on the pass level feed solution in fluid communication with the first side of the semipermeable membrane such that a pass level permeate solution from the pass level feed solution passes from the first side of the semipermeable membrane to a second side of the semipermeable membrane of the separation unit,
wherein the pressurizing unit includes at least one of an energy recovery device (ERD) device, a high-pressure pump, a booster pump, a piston, an hydraulic fluid and pneumatic fluid;
d. discharging, by the separation unit, a pass level retentate solution from the first side of the semi-permeable membrane, on passing the pass level permeate solution from the first side of the semipermeable membrane to the second side of the semipermeable membrane, wherein the discharged pass level retentate solution is stored in one of the at least one reservoir and supplied as the pass level feed solution to any of its subsequent pass until a system level retentate solution is generated, wherein the pass level permeate solution is removed as a system level permeate solution from the separation system; and
e. removing, by the separation unit in fluid communication with the at least one reservoir and the pressurizing unit, the generated system level retentate solution from the separation system.

2. The method as claimed in claim 1, wherein the method further comprises repeating, by the separation system, steps (a-e) to continue with one or more subsequent batch separations and semi batch separations.

3. The method as claimed in claim 1, wherein the method further comprises filling in parallel one of the at least one reservoir with a system level feed solution for the one or more subsequent separation cycles to achieve at least one of the batch separation and the semi batch separation.

4. The method as claimed in claim 1, wherein a reservoir switchover sequence is used to enable the separation system to switch connections to supply at least one of the pass level retentate solution and the pass level permeate solution stored in one of the at least one reservoir as the pass level feed solution to any of its subsequent pass, the reservoir switchover sequence comprises:
enabling different hydraulic segments of the separation system to replace the pass level feed solution, the pass level permeate solution and the pass level retentate solution corresponding to an earlier pass with a pass level feed solution, a pass level permeate solution and a pass level retentate solution of a next pass.

5. The method as claimed in claim 1, wherein the pressure exerted on the pass level feed solution in fluid communication with the first side of the semipermeable membrane is maintained by at least one of varying pressurized boundaries of a liquid container enclosing the at least one reservoir, displacing a hydraulic fluid between the at least one reservoir, adding hydraulic fluid to the at least one reservoir, transporting the pass level retentate solution and the pass level feed solution through the pressurizing unit to recover a portion of energy released by reducing the pressure of the pass level retentate solution and utilizing the recovered energy to pressurize the pass level feed solution.

6. The method as claimed in claim 5, wherein a process solution acts as the hydraulic fluid to maintain the pressure exerted on the pass level feed solution in fluid communication with first side of the semipermeable membrane, wherein the process solution includes at least one of the system level feed solution, the system level permeate solution, the system level retentate solution, the pass level feed solution, the pass level permeate solution and the pass level retentate solution.

7. The method as claimed in claim 1, wherein removing, by the separation system, the generated system level retentate solution comprises:
discharging the system level retentate solution to one of the at least one reservoir;
isolating one of the at least one reservoir from the separation unit;
depressurizing one of the at least one reservoir to an ambient pressure; and
removing the generated system level retentate solution from and filling the system level feed solution in one of the at least one reservoir by at least one of a sequential process or by a simultaneous process.

8. The method as claimed in claim 1, wherein removing, by the separation system, the generated system level retentate solution includes:
passing the generated system level retentate solution and the system level feed solution partially or completely of the subsequent batch separations and the semi batch separations through the ERD to recover a portion of energy released upon reducing a pressure in the generated system level retentate solution and utilizing the recovered energy to pressurize the system level feed solution, wherein the pressurized system level feed solution from the ERD is collected in one of the at least one reservoir; and
removing the system level retentate solution from the ERD on transferring the recovered energy to the system level feed solution.

9. The method as claimed in claim 1, wherein discharging the pass level retentate solution from the first side of the semi-permeable membrane, comprises:
exerting, by the pressurizing unit, the pressure on the pass level feed solution on the first side of the semipermeable membrane to discharge the pass level retentate solution from the first side of the semi-permeable membrane and the pass level permeate solution from the second side of the semipermeable membrane; and
recovering, by the pressurizing unit, a portion of energy released upon depressurizing the pass level retentate solution and utilizing the recovered energy to pressurize the pass level feed solution.

10. The method as claimed in claim 1, wherein the at least one reservoir comprises at least one of:
an unpressurized liquid container;
a piston pressurized liquid container;
a piston pressurized liquid container with at least two chambers separated by at least one movable partition, wherein the at least two chambers acts as two different reservoirs;
an indirect hydraulically pressurized liquid container with at least two chambers separated by at least one movable partition, wherein the at least two chambers acts as two different reservoirs;
a direct hydraulically pressurized liquid container with the hydraulic fluid, wherein the hydraulic fluid is in direct fluid communication with the process solution in the reservoir;
a direct feed pressurized reservoir;
an unpressurized liquid container with at least two chambers separated by at least one movable partition, wherein the at least two chambers acts as two different reservoirs;
an unpressurized liquid container with at least one chamber enclosed by a bladder, wherein the at least one chamber acts as a reservoir and includes one or more connections for supplying and receiving the process solutions; and
a pressurized liquid container with at least one chamber enclosed by a bladder, wherein the at least one chamber acts as a reservoir and includes one or more connections for supplying and receiving the process solutions.

11. The method as claimed in claim 1, wherein the semipermeable membrane used is at least one of a reverse osmosis membrane, a nanofiltration membrane and an ultrafiltration membrane.

12. A separation system for performing batch and semi batch separations, the separation system comprising:
at least one reservoir configured to:
a. receive a system level feed solution from an external source to initiate a first pass of a batch separation, wherein the batch separation includes one or more pass level separations;
b. supply at least one of the system level feed solution and a pass level retentate solution as a pass level feed solution to a first side of a semipermeable membrane of a separation unit.
a pressurizing unit configured to:
c. exert a pressure on the pass level feed solution in fluid communication with the first side of the semipermeable membrane such that a pass level permeate solution from the pass level feed solution passes from the first side of the semipermeable membrane to a second side of the semipermeable membrane of the separation unit,
wherein the pressurizing unit includes at least one of an energy recovery device (ERD) device, a high-pressure pump, a booster pump, a piston, an hydraulic fluid and pneumatic fluid;
the separation unit configured to:
d. discharge a pass level retentate solution from the first side of the semipermeable membrane, on passing the pass level permeate solution to the second side of the semipermeable membrane, wherein the discharged pass level retentate solution is stored in one of the at least one reservoir and supplied as the pass level feed solution to any of its subsequent pass until a system level retentate solution is generated, wherein the pass level permeate solution is removed as a system level permeate solution; and
the separation unit in fluid communication with the at least one reservoir and the pressurizing unit configured to:
e. remove the generated system level retentate solution.

13. The separation system as claimed in claim 12, wherein the separation system configured to repeat the steps (a-e) to continue with one or more subsequent batch separations and semi batch separations.

14. The separation system as claimed in claim 12, wherein the separation system configured for parallel filling of one of the at least one reservoir with a system level feed solution for the one or more subsequent separation cycles to achieve at least one of the batch separation and the semi batch separation.

15. The separation system as claimed in claim 12, wherein the separation system configured to enable a reservoir switchover sequence to switch connections to supply at least one of the pass level retentate solution and the pass level permeate solution stored in one of the at least one reservoir as the pass level feed solution to any of its subsequent pass by:
enabling different hydraulic segments of the separation system to replace the pass level feed solution, the pass level permeate solution and the pass level retentate solution corresponding to an earlier pass with a pass level feed solution, a pass level permeate solution and a pass level retentate solution of a next pass.

16. The separation system as claimed in claim 12, wherein the pressure exerted on the pass level feed solution in fluid communication with the first side of the semipermeable
membrane is maintained by at least one of varying pressurized boundaries of a liquid container enclosing the at least one reservoir, displacing a hydraulic fluid between the at least one reservoir, adding hydraulic fluid to the at least one reservoir, transporting the pass level retentate solution and the pass level feed solution through the pressurizing unit to recover a portion of energy released by reducing the pressure of the pass level retentate solution and utilizing the recovered energy to pressurize the pass level feed solution.

17. The separation system as claimed in claim 16, wherein a process solution acts as the hydraulic fluid to maintain the pressure exerted on the pass level feed solution in fluid communication with first side of the semipermeable membrane, wherein the process solution includes at least one of the system level feed solution, the system level permeate solution, the system level retentate solution, the pass level feed solution, the pass level permeate solution and the pass level retentate solution.

18. The separation system as claimed in claim 12, wherein the separation system configured to remove the generated system level retentate solution by:
discharging the system level retentate solution to one of the at least one reservoir;
isolating the at least one reservoir from the separation unit;
depressurizing one of the at least one reservoir to an ambient pressure; and
removing the generated system level retentate solution from and filling the system level feed solution in one of the at least one reservoir by at least one of a sequential process or by a simultaneous process.

19. The separation system as claimed in claim 12, wherein the separation system configured to remove the generated system level retentate solution by:
passing the generated system level retentate solution and the system level feed solution partially or completely of the subsequent batch separations and the semi batch separations through the ERD to recover a portion of energy released upon reducing a pressure in the generated system level retentate solution and utilizing the recovered energy to pressurize the system level feed solution, wherein the pressurized system level feed solution from the ERD is collected in one of the at least one reservoir; and
removing the system level retentate solution from the ERD on transferring the recovered energy to the system level feed solution.

20. The separation system as claimed in claim 12, wherein the separation unit configured to discharge a pass level retentate solution from the first side of the semipermeable membrane by:
configuring the pressurizing unit to exert a pressure on the pass level feed solution on the first side of the semipermeable membrane to discharge the pass level retentate solution from the first side of the semi-permeable membrane and a pass level permeate solution from the second side of the semipermeable membrane; and
configuring the pressurizing unit to recover a portion of energy released upon depressurizing the pass level retentate solution and utilizing the recovered energy to pressurize the pass level feed solution.

21. The separation system as claimed in claim 12, wherein the at least one reservoir comprises at least one of:
an unpressurized liquid container;
a piston pressurized liquid container;
a piston pressurized liquid container with at least two chambers separated by at least one movable partition, wherein the at least two chambers acts as two different reservoirs;
an indirect hydraulically pressurized liquid container with at least two chambers separated by at least one movable partition;
a direct hydraulically pressurized liquid container with the hydraulic fluid in direct fluid communication with the process solution in the reservoir;
a direct feed pressurized reservoir;
an unpressurized liquid container with at least two chambers separated by at least one movable partition, wherein the at least two chambers acts as two different reservoirs;
an unpressurized liquid container with at least one chamber enclosed by a bladder, wherein the at least one chamber acts as a reservoir and includes one or more connections for supplying and receiving the process solutions; and
a pressurized liquid container with at least one chamber enclosed by a bladder, wherein the at least one chamber acts as a reservoir and includes one or more connections for supplying and receiving the process solutions.

22. The separation system as claimed in claim 12, wherein the semipermeable membrane used is at least one of a reverse osmosis membrane, a nanofiltration membrane and an ultrafiltration membrane.

23. A method of performing batch and semi batch separations in a separation system, the method comprising:
a. receiving, by a at least one feed side reservoir, a system level feed solution and supplying as a pass level feed solution to the first side of the semi permeable membrane for a first pass of a first batch; and
b. supplying, by the at least one draw side reservoir, a pass level draw solution having a higher osmotic pressure than an osmotic pressure of the pass level feed solution corresponding to the first pass to the second side of the semi permeable membrane;
c. discharging, by the separation unit, a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane,
wherein the discharged pass level retentate solution is stored in one of the at least one feed side reservoir and supplied as the pass level feed solution to any of its subsequent pass,
wherein the discharged pass level diluate draw solution is removed as a system level diluate draw solution;
d. supplying, by the at least one feed side reservoir, a pass level retentate produced in the first pass as a pass level feed solution to the first side of the semi permeable membrane for a second pass;
e. supplying by the at least one draw side reservoir, a pass level draw solution corresponding to the second pass, to the second side of the semi permeable membrane, wherein the pass level draw solution having a higher osmotic pressure than an osmotic pressure of the pass level feed solution;
f. discharging, by the separation unit, a pass level retentate solution from the first side of the semi-permeable membrane and the pass level diluate draw solution from the second side of the semi permeable membrane corresponding to the second pass, on extracting a pass level permeate solution having a lower osmotic pressure than the osmotic pressure of pass level draw solution by the pass level draw solution from the first side of the semipermeable membrane to the second side of the semipermeable membrane,
wherein the discharged pass level retentate solution is stored in one of the at least one feed side reservoir and supplied as the pass level feed solution to a third pass,
wherein the discharged pass level diluate draw solution is stored in one of the at least one draw side reservoir and supplied as the pass level draw solution to a first pass of a second batch;
g. repeating steps (d-f) for further passes till pass n−1 of the first batch to produce a pass level retentate of pass n−1, wherein the discharged pass level diluate draw solution of every pass of the first batch is stored in one of the at least one draw side reservoir and supplied as the pass level draw solution to an earlier pass of a second batch;
h. supplying the pass level retentate of pass n−1 as a pass level feed solution to the first side of the semi permeable membrane for a pass n; and
i. receiving and supplying, by the at least one draw side reservoir, a system level draw solution having a higher osmotic pressure than the osmotic pressure of the pass level feed solution of the pass n in step h as a pass level draw solution to the second side of the semi permeable membrane;
j. discharging, by the separation unit, a pass level retentate solution from the first side of the semi-permeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane,
wherein the discharged pass level retentate solution is removed as system level retentate solution,
wherein the discharged pass level diluate draw solution is stored in one of the at least one draw side reservoir and supplied as pass level draw solution to n−1 pass of the second batch;
k. repeating the steps, a-j for further batches, wherein the system level feed solution and system level draw solution are converted to corresponding system level retentate solution and a system level diluate draw solution.

24. The method as claimed in claim 23, wherein the method comprise receiving and supplying by the at least one draw side reservoir a system level draw solution as a pass level draw solution corresponding to the second pass, to the to second side of the semi permeable membrane and removing the discharged pass level retentate solution corresponding to the second pass, from the first side of the semi-permeable membrane as a system level retentate when a batch consists of maximum of two passes, wherein the pass level draw solution having a higher osmotic pressure than an osmotic pressure of the pass level feed solution.

25. The method as claimed in claim 23, wherein the method further comprises filling in parallel the at least one feed side reservoir with a system level feed solution and the at least one draw side reservoir with a system level draw solution for the one or more subsequent separation cycles to achieve at least one of the batch separation and the semi batch separation.

26. The method as claimed in claim 23, wherein a reservoir switchover sequence is used to enable the separation system to switch connections to supply one of the system level feed solution and the pass level retentate solution stored in one of the at least one feed side reservoir and one of the system level draw solution and the pass level diluate draw solution stored in one of the at least one draw side reservoir as the pass level feed solution and the pass level draw solution respectively having a higher osmotic pressure than an osmotic pressure of pass level feed solution to any of its subsequent pass, the reservoir switchover sequence comprises:
enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass.

27. The method as claimed in claim 23, wherein the flow of feed solution on the first side of the semipermeable membrane and the flow of draw solution on the second side of the semipermeable membrane are one of counter current, co-current and cross-current to each other.

28. A separation system for performing batch and semi batch separations, the separation system comprising:
at least one feed side reservoir configured to:
a. receive a system level feed solution and supplying as a pass level feed solution to the first side of the semi-permeable membrane for a first pass of a first batch; and
at least one draw side reservoir configured to:
b. supply a pass level draw solution having a higher osmotic pressure than an osmotic pressure of pass level feed solution corresponding to the first pass to the second side of the semi-permeable membrane;
a separation unit configured to:
c. discharge a pass level retentate solution from the first side of the semipermeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane,
wherein the discharged pass level retentate solution is stored in one of the at least one feed side reservoir and supplied as the pass level feed solution to any of its subsequent pass,
wherein the discharged pass level diluate draw solution is removed as a system level diluate draw solution.
the at least one feed side reservoir configured to:
d. supply a pass level retentate produced in the first pass as a pass level feed solution to the first side of the semi-permeable membrane for a second pass;
the at least one draw side reservoir configured to:
e. supply a pass level draw solution corresponding to the second pass, to the second side of the semi permeable membrane, wherein the pass level draw solution having a higher osmotic pressure than an osmotic pressure of pass level feed solution;
the separation unit configured to:
f. discharge a pass level retentate solution from the first side of the semipermeable membrane and the pass level diluate draw solution from the second side of the semi permeable membrane corresponding to the second pass, on extracting a pass level permeate solution having a lower osmotic pressure than the osmotic pressure of pass level draw solution by the pass level draw solution from the first side of the semipermeable membrane to the second side of the semipermeable membrane,
wherein the discharged pass level retentate solution is stored in one of the at least one feed side reservoir and supplied as the pass level feed solution to a third pass,
wherein the discharged pass level diluate draw solution is stored in one of the at least one draw side reservoir and supplied as the pass level draw solution to a first pass of a second batch;
g. repeating steps (d-f) for further passes till pass n−1 of the first batch to produce a pass level retentate of pass n−1, wherein the discharged pass level diluate draw solution of every pass of the first batch is stored in one of the at least one draw side reservoir and supplied as the pass level draw solution to an earlier pass of a second batch;
the at least one feed side reservoir configured to:
h. supply the pass level retentate of pass n−1 as a pass level feed solution to the first side of the semi permeable membrane for a pass n; and
the at least one draw side reservoir configured to:
i. receive and supply a system level draw solution as a pass level draw solution having a higher osmotic pressure than an osmotic pressure of pass level feed solution of the pass n in step h as a pass level draw solution to the second side of the semi permeable membrane;
the separation unit configured to:
j. discharge a pass level retentate solution from the first side of the semipermeable membrane and the pass level diluate draw solution from the second side of the semi permeable membrane, on extracting a pass level permeate solution having a lower osmotic pressure than the osmotic pressure of pass level draw solution by the pass level draw solution from the first side of the semipermeable membrane to the second side of the semipermeable membrane,
wherein the discharged pass level retentate solution is removed as system level retentate solution,
wherein the discharged pass level diluate draw solution is stored in one of the at least one draw side reservoir and supplied as pass level draw solution to n−1 pass of the second batch;
k. repeat the steps a-j for further batches, wherein the system level feed solution and system level draw solution are converted to corresponding system level retentate solution and a system level diluate draw solution.

29. The separation system as claimed in claim 28, wherein the at least one draw side reservoir configured to receive and supply the system level draw solution as the pass level draw solution corresponding to the second pass, to the second side of the semi permeable membrane and remove the discharged pass level retentate solution corresponding to the second pass, from the first side of the semi-permeable membrane as a system level retentate when a batch consists of maximum of two passes, wherein the pass level draw solution having a higher osmotic pressure than an osmotic of the pass level feed solution.

30. The separation system as claimed in claim 28, wherein the separation system further configured for parallel filling the at least one feed side reservoir with a system level feed solution and the at least one draw side reservoir with a system level draw solution for the one or more subsequent separation cycles to achieve at least one of the batch separation and the semi batch separation.

31. The separation system as claimed in claim 28, wherein the separation system further configured to enable a reservoir switchover sequence to switch connections to supply one of the system level feed solution and the pass level retentate solution stored in one of the at least one feed side reservoir and one of the system level draw solution and the pass level diluate draw solution stored in one of the at least one draw side reservoir as the pass level feed solution and the pass level draw solution having a higher osmotic pressure than an osmotic pressure of pass level feed solution to any of its subsequent pass by:
enabling different hydraulic segments of the separation system to replace the pass level feed solution, the pass level draw solution, the pass level retentate solution and the pass level diluate draw solution corresponding to an earlier pass with a pass level feed solution, a pass level draw solution, a pass level retentate solution and a pass level diluate draw solution of a next pass.

32. The separation system as claimed in claim 28, wherein the flow of feed solution on the first side of the semipermeable membrane and the flow of draw solution on the
second side of the semipermeable membrane are one of counter current, co-current and cross-current to each other.
